(19) United States
(12) Patent Application Publication
(10) Pub. No.: US 2024/0334537 A1
(43) Pub. Date: Oct. 3, 2024

(54) COMMUNICATION IN A NON-ACTIVE TIME FOR A CELL

(71) Applicant: QUALCOMM Incorporated, San Diego, CA (US)

(72) Inventors: Hung Dinh LY, San Diego, CA (US); Navid ABEDINI, Basking Ridge, NJ (US)

(21) Appl. No.: 18/619,861

(22) Filed: Mar. 28, 2024

Related U.S. Application Data
(60) Provisional application No. 63/493,957, filed on Apr. 3, 2023.

(51) Int. Cl. H04W 76/28; H04L 5/00; H04W 72/1268

(52) U.S. Cl. CPC H04W 76/28; H04L 5/0051; H04W 72/1268

(57) ABSTRACT

Various aspects of the present disclosure generally relate to wireless communication. In some aspects, a user equipment (UE) may receive configuration information that indicates a non-active time for cell discontinuous reception and that indicates a quantity of repetitions for one of a physical uplink channel or signal. The UE may transmit one or more repetitions of the one of the physical uplink channel or signal in one or more transmission occasions outside of the non-active time. The UE may drop transmission of one or more repetitions of the one of the physical uplink channel or signal in one or more transmission occasions in the non-active time. Numerous other aspects are described.

### CROSS-REFERENCE TO RELATED APPLICATION

This patent application claims priority to U.S. Provisional Patent Application No. 63/493,957, filed on Apr. 3, 2023, entitled “COMMUNICATION IN A NON-ACTIVE TIME FOR A CELL,” and assigned to the assignee hereof. The disclosure of the prior application is considered part of and is incorporated by reference into this patent application.

### INTRODUCTION

Aspects of the present disclosure generally relate to wireless communication and to techniques and apparatuses for cell discontinuous transmission and reception.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at an apparatus of a user equipment (UE). The method may include receiving configuration information that indicates a non-active time for cell discontinuous reception (DRX) and that indicates a quantity of repetitions for one of a physical uplink channel or signal. The method may include dropping transmission of one or more repetitions of the one of the physical uplink channel or signal in one or more transmission occasions in the non-active time.

Some aspects described herein relate to a method of wireless communication performed at an apparatus of a network node. The method may include transmitting configuration information that indicates a non-active time for cell DRX and that indicates a quantity of repetitions for one of a physical uplink channel or signal. The method may include dropping reception of one or more repetitions of the one of the physical uplink channel or signal in one or more occasions in the non-active time.

Some aspects described herein relate to an apparatus for wireless communication at a UE. The apparatus may include a memory and one or more processors coupled to the memory. The one or more processors may be configured to receive configuration information that indicates a non-active time for cell DRX and that indicates a quantity of repetitions for one of a physical uplink channel or signal. The one or more processors may be configured to drop transmission of one or more repetitions of the one of the physical uplink channel or signal in one or more transmission occasions in the non-active time.

Some aspects described herein relate to an apparatus for wireless communication at a network node. The apparatus may include a memory and one or more processors coupled to the memory. The one or more processors may be configured to transmit configuration information that indicates a non-active time for cell DRX and that indicates a quantity of repetitions for one of a physical uplink channel or signal. The one or more processors may be configured to drop reception of one or more repetitions of the one of the physical uplink channel or signal in one or more occasions in the non-active time.

Some aspects described herein relate to a non-transitory computer-readable medium that stores a set of instructions for wireless communication by a UE. The set of instructions, when executed by one or more processors of the UE, may cause the UE to receive configuration information that indicates a non-active time for cell DRX and that indicates a quantity of repetitions for one of a physical uplink channel or signal. The set of instructions, when executed by one or more processors of the UE, may cause the UE to drop transmission of one or more repetitions of the one of the physical uplink channel or signal in one or more transmission occasions in the non-active time.

Some aspects described herein relate to a non-transitory computer-readable medium that stores a set of instructions for wireless communication by a network node. The set of instructions, when executed by one or more processors of the network node, may cause the network node to transmit configuration information that indicates a non-active time for cell DRX and that indicates a quantity of repetitions for one of a physical uplink channel or signal. The set of instructions, when executed by one or more processors of the network node, may cause the network node to drop reception of one or more repetitions of the one of the physical uplink channel or signal in one or more occasions in the non-active time.

Some aspects described herein relate to an apparatus for wireless communication. The apparatus may include means for receiving configuration information that indicates a non-active time for cell DRX and that indicates a quantity of repetitions for one of a physical uplink channel or signal. The apparatus may include means for dropping transmission of one or more repetitions of the one of the physical uplink channel or signal in one or more transmission occasions in the non-active time.

Some aspects described herein relate to an apparatus for wireless communication. The apparatus may include means for transmitting configuration information that indicates a non-active time for cell DRX and that indicates a quantity of repetitions for one of a physical uplink channel or signal. The apparatus may include means for dropping reception of one or more repetitions of the one of the physical uplink channel or signal in one or more occasions in the non-active time.

Some aspects described herein relate to a method of wireless communication performed at an apparatus of a UE. The method may include receiving configuration information that indicates a non-active time for cell DRX and that indicates a quantity of repetitions for one of a physical uplink channel or signal. The method may include transmitting one or more repetitions of the one of the physical uplink channel or signal in one or more transmission occasions outside of the non-active time.

Some aspects described herein relate to a method of wireless communication performed at an apparatus of a network node. The method may include transmitting configuration information that indicates a non-active time for cell DRX and that indicates a quantity of repetitions for one of a physical uplink channel or signal. The method may include receiving one or more repetitions of the one of the physical uplink channel or signal in one or more occasions outside of the non-active time.

Some aspects described herein relate to an apparatus for wireless communication at a UE. The apparatus may include a memory and one or more processors coupled to the memory. The one or more processors may be configured to receive configuration information that indicates a non-active time for cell DRX and that indicates a quantity of repetitions for one of a physical uplink channel or signal. The one or more processors may be configured to transmit one or more repetitions of the one of the physical uplink channel or signal in one or more transmission occasions outside of the non-active time.

Some aspects described herein relate to an apparatus for wireless communication at a network node. The apparatus may include a memory and one or more processors coupled to the memory. The one or more processors may be configured to transmit configuration information that indicates a non-active time for cell DRX and that indicates a quantity of repetitions for one of a physical uplink channel or signal. The one or more processors may be configured to receive one or more repetitions of the one of the physical uplink channel or signal in one or more occasions outside of the non-active time.

Some aspects described herein relate to a non-transitory computer-readable medium that stores a set of instructions for wireless communication by a UE. The set of instructions, when executed by one or more processors of the UE, may cause the UE to receive configuration information that indicates a non-active time for cell DRX and that indicates a quantity of repetitions for one of a physical uplink channel or signal. The set of instructions, when executed by one or more processors of the UE, may cause the UE to transmit one or more repetitions of the one of the physical uplink channel or signal in one or more transmission occasions outside of the non-active time.

Some aspects described herein relate to a non-transitory computer-readable medium that stores a set of instructions for wireless communication by a network node. The set of instructions, when executed by one or more processors of the network node, may cause the network node to transmit configuration information that indicates a non-active time for cell DRX and that indicates a quantity of repetitions for one of a physical uplink channel or signal. The set of instructions, when executed by one or more processors of the network node, may cause the network node to receive one or more repetitions of the one of the physical uplink channel or signal in one or more occasions outside of the non-active time.

Some aspects described herein relate to an apparatus for wireless communication. The apparatus may include means for receiving configuration information that indicates a non-active time for cell DRX and that indicates a quantity of repetitions for one of a physical uplink channel or signal. The apparatus may include means for transmitting one or more repetitions of the one of the physical uplink channel or signal in one or more transmission occasions outside of the non-active time.

Some aspects described herein relate to an apparatus for wireless communication. The apparatus may include means for transmitting configuration information that indicates a non-active time for cell DRX and that indicates a quantity of repetitions for one of a physical uplink channel or signal. The apparatus may include means for receiving one or more repetitions of the one of the physical uplink channel or signal in one or more occasions outside of the non-active time.

Some aspects described herein relate to a method of wireless communication performed at an apparatus of a UE. The method may include receiving configuration information that indicates a non-active time for cell DRX and that indicates a quantity of repetitions for one of a physical uplink channel or signal. The method may include transmitting one or more repetitions of the one of the physical uplink channel or signal in one or more transmission occasions outside of the non-active time. The method may include dropping transmission of one or more repetitions of the one of the physical uplink channel or signal in one or more transmission occasions in the non-active time.

Some aspects described herein relate to a method of wireless communication performed at an apparatus of a network node. The method may include transmitting configuration information that indicates a non-active time for cell DRX and that indicates a quantity of repetitions for one of a physical uplink channel or signal. The method may include receiving one or more repetitions of the one of the physical uplink channel or signal in one or more occasions outside of the non-active time. The method may include dropping reception of one or more repetitions of the one of the physical uplink channel or signal in one or more occasions in the non-active time.

Some aspects described herein relate to an apparatus for wireless communication at a UE. The apparatus may include a memory and one or more processors coupled to the memory. The one or more processors may be configured to receive configuration information that indicates a non-active time for cell DRX and that indicates a quantity of repetitions for one of a physical uplink channel or signal. The one or more processors may be configured to transmit one or more repetitions of the one of the physical uplink channel or signal in one or more transmission occasions outside of the non-active time. The one or more processors may be configured to drop transmission of one or more repetitions of the one of the physical uplink channel or signal in one or more transmission occasions in the non-active time.

Some aspects described herein relate to an apparatus for wireless communication at a network node. The apparatus may include a memory and one or more processors coupled to the memory. The one or more processors may be configured to transmit configuration information that indicates a non-active time for cell DRX and that indicates a quantity of repetitions for one of a physical uplink channel or signal. The one or more processors may be configured to receive one or more repetitions of the one of the physical uplink channel or signal in one or more occasions outside of the non-active time. The one or more processors may be configured to drop reception of one or more repetitions of the one of the physical uplink channel or signal in one or more occasions in the non-active time.

Some aspects described herein relate to a non-transitory computer-readable medium that stores a set of instructions for wireless communication by a UE. The set of instructions, when executed by one or more processors of the UE, may cause the UE to receive configuration information that indicates a non-active time for cell DRX and that indicates a quantity of repetitions for one of a physical uplink channel or signal. The set of instructions, when executed by one or more processors of the UE, may cause the UE to transmit one or more repetitions of the one of the physical uplink channel or signal in one or more transmission occasions outside of the non-active time. The set of instructions, when executed by one or more processors of the UE, may cause the UE to drop transmission of one or more repetitions of the one of the physical uplink channel or signal in one or more transmission occasions in the non-active time.

Some aspects described herein relate to a non-transitory computer-readable medium that stores a set of instructions for wireless communication by a network node. The set of instructions, when executed by one or more processors of the network node, may cause the network node to transmit configuration information that indicates a non-active time for cell DRX and that indicates a quantity of repetitions for one of a physical uplink channel or signal. The set of instructions, when executed by one or more processors of the network node, may cause the network node to receive one or more repetitions of the one of the physical uplink channel or signal in one or more occasions outside of the non-active time. The set of instructions, when executed by one or more processors of the network node, may cause the network node to drop reception of one or more repetitions of the one of the physical uplink channel or signal in one or more occasions in the non-active time.

Some aspects described herein relate to an apparatus for wireless communication. The apparatus may include means for receiving configuration information that indicates a non-active time for cell DRX and that indicates a quantity of repetitions for one of a physical uplink channel or signal. The apparatus may include means for transmitting one or more repetitions of the one of the physical uplink channel or signal in one or more transmission occasions outside of the non-active time. The apparatus may include means for dropping transmission of one or more repetitions of the one of the physical uplink channel or signal in one or more transmission occasions in the non-active time.

Some aspects described herein relate to an apparatus for wireless communication. The apparatus may include means for transmitting configuration information that indicates a non-active time for cell DRX and that indicates a quantity of repetitions for one of a physical uplink channel or signal. The apparatus may include means for receiving one or more repetitions of the one of the physical uplink channel or signal in one or more occasions outside of the non-active time. The apparatus may include means for dropping reception of one or more repetitions of the one of the physical uplink channel or signal in one or more occasions in the non-active time.

Some aspects described herein relate to a method of wireless communication performed at an apparatus of a UE. The method may include receiving configuration information that indicates a non-active time for a cell, where the non-active time is for cell discontinuous transmission. The method may include skipping monitoring a physical downlink control channel (PDCCH) during a duration of a DRX active time of the UE that overlaps in time with the non-active time.

Some aspects described herein relate to a method of wireless communication performed at an apparatus of a network node. The method may include transmitting configuration information that indicates a non-active time for a cell, where the non-active time is for cell discontinuous transmission. The method may include skipping transmitting a PDCCH communication for a UE during a duration of a DRX active time of the UE that overlaps in time with the non-active time.

Some aspects described herein relate to an apparatus for wireless communication at a UE. The apparatus may include a memory and one or more processors coupled to the memory. The one or more processors may be configured to receive configuration information that indicates a non-active time for a cell, where the non-active time is for cell discontinuous transmission. The one or more processors may be configured to skip monitoring a PDCCH during a duration of a DRX active time of the UE that overlaps in time with the non-active time.

Some aspects described herein relate to an apparatus for wireless communication at a network node. The apparatus may include a memory and one or more processors coupled to the memory. The one or more processors may be configured to transmit configuration information that indicates a non-active time for a cell, where the non-active time is for cell discontinuous transmission. The one or more processors may be configured to skip transmitting a PDCCH communication for a UE during a duration of a DRX active time of the UE that overlaps in time with the non-active time.

Some aspects described herein relate to a non-transitory computer-readable medium that stores a set of instructions for wireless communication by a UE. The set of instructions, when executed by one or more processors of the UE, may cause the UE to receive configuration information that indicates a non-active time for a cell, where the non-active time is for cell discontinuous transmission. The set of instructions, when executed by one or more processors of the UE, may cause the UE to skip monitoring a PDCCH during a duration of a DRX active time of the UE that overlaps in time with the non-active time.

Some aspects described herein relate to a non-transitory computer-readable medium that stores a set of instructions for wireless communication by a network node. The set of instructions, when executed by one or more processors of the network node, may cause the network node to transmit configuration information that indicates a non-active time for a cell, where the non-active time is for cell discontinuous transmission. The set of instructions, when executed by one or more processors of the network node, may cause the network node to skip transmitting a PDCCH communication for a UE during a duration of a DRX active time of the UE that overlaps in time with the non-active time.

Some aspects described herein relate to an apparatus for wireless communication. The apparatus may include means for receiving configuration information that indicates a non-active time for a cell, where the non-active time is for cell discontinuous transmission. The apparatus may include means for skipping monitoring a PDCCH during a duration of a DRX active time of the apparatus that overlaps in time with the non-active time.

Some aspects described herein relate to an apparatus for wireless communication. The apparatus may include means for transmitting configuration information that indicates a non-active time for a cell, where the non-active time is for cell discontinuous transmission. The apparatus may include means for skipping transmitting a PDCCH communication for a UE during a duration of a DRX active time of the UE that overlaps in time with the non-active time.

Some aspects described herein relate to a method of wireless communication performed at an apparatus of a UE. The method may include receiving configuration information indicating a non-active time for a cell. The method may include performing or skipping transmission of one or more physical uplink channels or signals, or reception of one or more physical downlink channels or signals, during the non-active time according to one or more conditions.

Some aspects described herein relate to a method of wireless communication performed at an apparatus of a UE. The method may include receiving configuration information indicating a non-active time for cell DRX and indicating a quantity of repetitions for a physical uplink channel or signal. The method may include transmitting one or more repetitions of the physical uplink channel or signal in one or more transmission occasions outside of the non-active time, and skipping one or more repetitions of the physical uplink channel or signal in one or more transmission occasions in the non-active time.

Some aspects described herein relate to a method of wireless communication performed at an apparatus of a network node. The method may include transmitting configuration information indicating a non-active time for a cell. The method may include performing or skipping transmission of one or more physical downlink channels or signals, or reception of one or more physical uplink channels or signals, during the non-active time according to one or more conditions.

Some aspects described herein relate to a method of wireless communication performed at an apparatus of a network node. The method may include transmitting configuration information indicating a non-active time for cell DRX and indicating a quantity of repetitions for a physical uplink channel or signal. The method may include receiving one or more repetitions of the physical uplink channel or signal in one or more occasions outside of the non-active time, and skipping one or more repetitions of the physical uplink channel or signal in one or more occasions in the non-active time.

Some aspects described herein relate to an apparatus for wireless communication at a UE. The apparatus may include a memory and one or more processors coupled to the memory. The one or more processors may be configured to receive configuration information indicating a non-active time for a cell. The one or more processors may be configured to perform or skip transmission of one or more physical uplink channels or signals, or reception of one or more physical downlink channels or signals, during the non-active time according to one or more conditions.

Some aspects described herein relate to an apparatus for wireless communication at a UE. The apparatus may include a memory and one or more processors coupled to the memory. The one or more processors may be configured to receive configuration information indicating a non-active time for cell DRX and indicating a quantity of repetitions for a physical uplink channel or signal. The one or more processors may be configured to transmit one or more repetitions of the physical uplink channel or signal in one or more transmission occasions outside of the non-active time, and skip one or more repetitions of the physical uplink channel or signal in one or more transmission occasions in the non-active time.

Some aspects described herein relate to an apparatus for wireless communication at a network node. The apparatus may include a memory and one or more processors coupled to the memory. The one or more processors may be configured to transmit configuration information indicating a non-active time for a cell. The one or more processors may be configured to perform or skip transmission of one or more physical downlink channels or signals, or reception of one or more physical uplink channels or signals, during the non-active time according to one or more conditions.

Some aspects described herein relate to an apparatus for wireless communication at a network node. The apparatus may include a memory and one or more processors coupled to the memory. The one or more processors may be configured to transmit configuration information indicating a non-active time for cell DRX and indicating a quantity of repetitions for a physical uplink channel or signal. The one or more processors may be configured to receive one or more repetitions of the physical uplink channel or signal in one or more occasions outside of the non-active time, and skip one or more repetitions of the physical uplink channel or signal in one or more occasions in the non-active time.

Some aspects described herein relate to a non-transitory computer-readable medium that stores a set of instructions for wireless communication by a UE. The set of instructions, when executed by one or more processors of the UE, may cause the UE to receive configuration information indicating a non-active time for a cell. The set of instructions, when executed by one or more processors of the UE, may cause the UE to perform or skip transmission of one or more physical uplink channels or signals, or reception of one or more physical downlink channels or signals, during the non-active time according to one or more conditions.

Some aspects described herein relate to a non-transitory computer-readable medium that stores a set of instructions for wireless communication by a UE. The set of instructions, when executed by one or more processors of the UE, may cause the UE to receive configuration information indicating a non-active time for cell DRX and indicating a quantity of repetitions for a physical uplink channel or signal. The set of instructions, when executed by one or more processors of the UE, may cause the UE to transmit one or more repetitions of the physical uplink channel or signal in one or more transmission occasions outside of the non-active time, and skip one or more repetitions of the physical uplink channel or signal in one or more transmission occasions in the non-active time.

Some aspects described herein relate to a non-transitory computer-readable medium that stores a set of instructions for wireless communication by a network node. The set of instructions, when executed by one or more processors of the network node, may cause the network node to transmit configuration information indicating a non-active time for a cell. The set of instructions, when executed by one or more processors of the network node, may cause the network node to perform or skip transmission of one or more physical downlink channels or signals, or reception of one or more physical uplink channels or signals, during the non-active time according to one or more conditions.

Some aspects described herein relate to a non-transitory computer-readable medium that stores a set of instructions for wireless communication by a network node. The set of instructions, when executed by one or more processors of the network node, may cause the network node to transmit configuration information indicating a non-active time for cell DRX and indicating a quantity of repetitions for a physical uplink channel or signal. The set of instructions, when executed by one or more processors of the network node, may cause the network node to receive one or more repetitions of the physical uplink channel or signal in one or more occasions outside of the non-active time, and skip one or more repetitions of the physical uplink channel or signal in one or more occasions in the non-active time.

Some aspects described herein relate to an apparatus for wireless communication. The apparatus may include means for receiving configuration information indicating a non-active time for a cell. The apparatus may include means for performing or skipping transmission of one or more physical uplink channels or signals, or reception of one or more physical downlink channels or signals, during the non-active time according to one or more conditions.

Some aspects described herein relate to an apparatus for wireless communication. The apparatus may include means for receiving configuration information indicating a non-active time for cell DRX and indicating a quantity of repetitions for a physical uplink channel or signal. The apparatus may include means for transmitting one or more repetitions of the physical uplink channel or signal in one or more transmission occasions outside of the non-active time, and skipping one or more repetitions of the physical uplink channel or signal in one or more transmission occasions in the non-active time.

Some aspects described herein relate to an apparatus for wireless communication. The apparatus may include means for transmitting configuration information indicating a non-active time for a cell. The apparatus may include means for performing or skipping transmission of one or more physical downlink channels or signals, or reception of one or more physical uplink channels or signals, during the non-active time according to one or more conditions.

Some aspects described herein relate to an apparatus for wireless communication. The apparatus may include means for transmitting configuration information indicating a non-active time for cell DRX and indicating a quantity of repetitions for a physical uplink channel or signal. The apparatus may include means for receiving one or more repetitions of the physical uplink channel or signal in one or more occasions outside of the non-active time, and skipping one or more repetitions of the physical uplink channel or signal in one or more occasions in the non-active time.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example of a discontinuous reception (DRX) configuration, in accordance with the present disclosure.

FIG. 6A is a diagram illustrating an example of physical channels and reference signals in a wireless network, in accordance with the present disclosure.

FIG. 6B is a diagram illustrating an example of physical channels and reference signals in a wireless network, in accordance with the present disclosure.

FIG. 7 is a diagram illustrating an example of cell discontinuous transmission (DTX) and/or DRX, in accordance with the present disclosure.

FIG. 8 is a diagram illustrating an example of cell DTX and/or DRX with UE DRX, in accordance with the present disclosure.

FIG. 9 is a diagram of an example associated with communication in a non-active time for a cell, in accordance with the present disclosure.

FIG. 10A is a diagram of an example associated with communication in a non-active time for a cell, in accordance with the present disclosure.

FIG. 10B is a diagram of an example associated with communication in a non-active time for a cell, in accordance with the present disclosure.

FIG. 11A is a diagram of an example associated with communication in a non-active time for a cell, in accordance with the present disclosure.

FIG. 11B is a diagram of an example associated with communication in a non-active time for a cell, in accordance with the present disclosure.

FIG. 12 is a diagram of an example associated with communication in a non-active time for a cell, in accordance with the present disclosure.

FIG. 13 is a diagram illustrating an example of uplink repetition, in accordance with the present disclosure.

FIG. 14 is a diagram of an example associated with communication in a non-active time for a cell, in accordance with the present disclosure.

FIG. 15 is a diagram of an example associated with communication in a non-active time for a cell, in accordance with the present disclosure.

FIG. 16 is a diagram illustrating an example process performed, for example, by a UE, in accordance with the present disclosure.

FIG. 17 is a diagram illustrating an example process performed, for example, by a UE, in accordance with the present disclosure.

FIG. 18 is a diagram illustrating an example process performed, for example, by a network node, in accordance with the present disclosure.

FIG. 19 is a diagram illustrating an example process performed, for example, by a network node, in accordance with the present disclosure.

FIG. 20 is a diagram of an example apparatus for wireless communication, in accordance with the present disclosure.

FIG. 21 is a diagram illustrating an example of a hardware implementation for an apparatus employing a processing system, in accordance with the present disclosure.

FIG. 22 is a diagram illustrating an example of an implementation of code and circuitry for an apparatus, in accordance with the present disclosure.

FIG. 23 is a diagram of an example apparatus for wireless communication, in accordance with the present disclosure.

FIG. 24 is a diagram illustrating an example of a hardware implementation for an apparatus employing a processing system, in accordance with the present disclosure.

FIG. 25 is a diagram illustrating an example of an implementation of code and circuitry for an apparatus, in accordance with the present disclosure.

FIG. 26 is a diagram illustrating an example process performed, for example, by a UE, in accordance with the present disclosure.

FIG. 27 is a diagram illustrating an example process performed, for example, by a network node, in accordance with the present disclosure.

FIG. 28 is a diagram illustrating an example process performed, for example, by a UE, in accordance with the present disclosure.

FIG. 29 is a diagram illustrating an example process performed, for example, by a network node, in accordance with the present disclosure.

FIG. 30 is a diagram illustrating an example process performed, for example, by a UE, in accordance with the present disclosure.

FIG. 31 is a diagram illustrating an example process performed, for example, by a UE, in accordance with the present disclosure.

FIG. 32 is a diagram illustrating an example process performed, for example, by a network node, in accordance with the present disclosure.

FIG. 33 is a diagram illustrating an example process performed, for example, by a UE, in accordance with the present disclosure.

### DETAILED DESCRIPTION

Cell discontinuous transmission (DTX) and/or cell discontinuous reception (DRX) enables a network node to conserve power. Cell DTX and/or DRX may be performed according to a cycle that repeats according to a periodicity. The cycle may include a non-active time (e.g., during which the network node may enter a sleep state) and an active time (e.g., during which the network node is awake or in an active state). During the active time, the network node may transmit and/or receive communications with a user equipment (UE) or multiple UEs in a cell served by the network node. “Cell” may refer to a coverage area of the network node. The non-active time may refer to a time duration during which the network node does not perform transmission and/or reception to conserve power. Thus, some physical channels or signals that are scheduled or configured during the non-active time may be dropped by the network node (e.g., in the case of downlink channels or signals) and/or dropped by a UE (e.g., in the case of uplink channels or signals). The term “drop” may be used interchangeably herein with the terms “skip” or “not transmit.” A physical channel or signal may refer to particular radio resources that are used to carry data on an air interface or a signal that is transmitted over the air interface and conveys information (e.g., amplitude, phase, and/or delay spread) about a communication channel (e.g., a reference signal), respectively.

From a network energy savings perspective, dropping all physical channels or signals during non-active time may be ideal. However, particular types of physical channels or signals may be transmitted during non-active time because dropping of these physical channels or signals may have an adverse effect on data rates, latency, cell coverage, and/or UE-network node synchronization, among other examples (these physical channels or signals may be referred to herein as “unrestricted physical channel or signals”). For example, the unrestricted physical channels or signals may include, in downlink, a channel state information (CSI) reference signal (CSI-RS), such as for tracking, positioning, beam management, and/or beam failure detection, and/or may include, in uplink, a sounding reference signal (SRS), such as for positioning, and/or a scheduling request, among other examples. Accordingly, the network node may sometimes be awake during non-active time to transmit and/or receive unrestricted physical channels or signals. As a result, network energy savings may be reduced when the network node is awake for transmission or reception during non-active time.

Some techniques and apparatuses described herein enable selective transmission or skipping (e.g., not transmitting) of unrestricted physical channels or signals during non-active time for a cell. In some aspects, transmissions associated with unrestricted physical channels or signals may be performed or skipped during non-active time according to one or more conditions (which can also be referred to as “dropping rules”).

In some aspects, a condition may relate to a duration and/or a periodicity of the non-active time, a periodicity and/or a quantity of repetitions of a physical channel or signal, a quality of service (QoS) requirement of a UE and/or of traffic of the UE, a mobility state of a UE, and/or a signal quality at a UE, among other examples. For example, according to a condition relating to a periodicity of a physical channel or signal, a transmission associated with a physical channel or signal that is transmitted frequently (e.g., a periodicity of the physical channel or signal is less than a threshold) may be skipped during non-active time, whereas a transmission associated with a physical channel or signal that is transmitted less frequently (e.g., a periodicity of the physical channel or signal equals or exceeds a threshold) may be performed during non-active time. In this way, the selective transmission or skipping of physical channels or signals during non-active time provides a balance among network energy savings and wireless network system performance. Accordingly, substantial network energy savings may be achieved while maintaining data rates, latency, cell coverage, and/or UE-network node synchronization at acceptable levels (e.g., at levels according to a QoS requirement and/or at levels that maintain a communication link between the UE and the network node).

In some examples, a UE may transmit repetitions of a physical uplink channel or signal to a network node to improve a time diversity and overall reliability of the physical uplink channel or signal. When repetitions are used, the UE may repeat transmission of a communication multiple times. For example, the UE may transmit an initial uplink communication and may repeat transmission of (e.g., may retransmit) that uplink communication one or more times. A “repetition” may refer to the initial communication and also refer to a repeated transmission of the initial communication. The repeated transmission by the UE, and reception by the network node, of an uplink communication may consume more power and computing resources of the UE and the network node than a single transmission of the uplink communication.

The UE may be configured by the network node to transmit a particular quantity of repetitions of a physical uplink channel or signal. Sometimes, one or more repetitions configured for the UE may be in transmission occasions outside of the non-active time for a cell, and one or more repetitions configured for the UE may be in transmission occasions in the non-active time. A “transmission occasion” may refer to time resources in which a repetition is to be transmitted.

In some aspects described herein, the UE may transmit the repetitions in the transmission occasions outside of the non-active time, and the UE may skip (e.g., not transmit) the repetitions in the transmission occasions in the non-active time. Transmitting repetitions in transmission occasions outside of the non-active time improves a reliability of the physical uplink channel or signal. Moreover, skipping repetitions in transmission occasions in the non-active time may enable the network node to sleep during the non-active time, thereby providing network energy savings and conserving computing resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

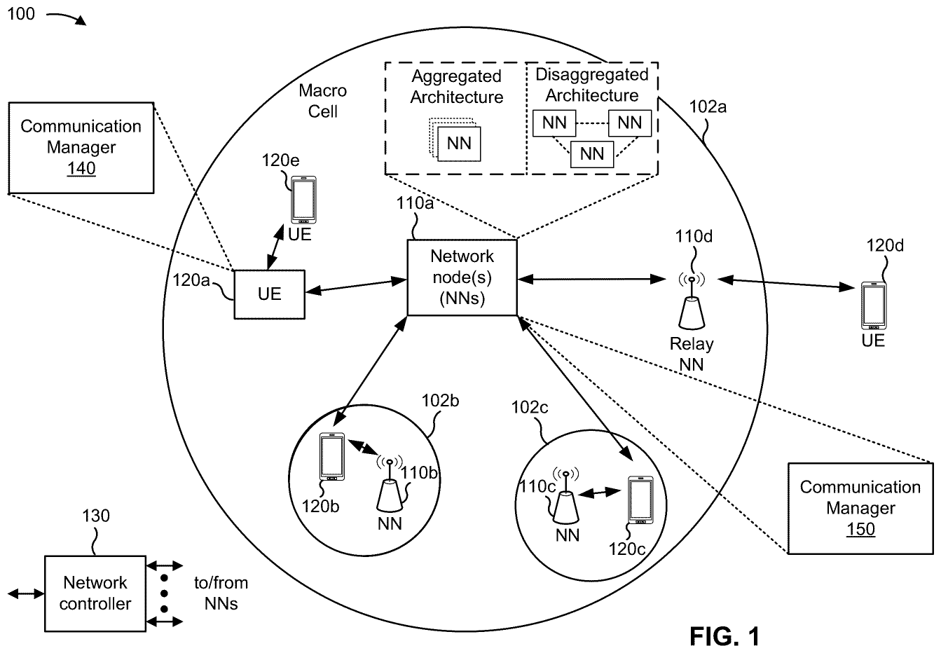

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

A cell to which a UE 120 has established a connection and that is currently serving the UE 120 for radio communications may be referred to as a “serving cell.” For example, in FIG. 1, network node 110a may implement a serving cell of UE 120a. A “neighboring cell” may refer to a cell that is within range of a UE 120 that is not currently serving the UE 120.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

As used herein, the network node 110 “outputting” or “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (e.g., from the UE 120 to the network node 110) or receiving the communication (or information derived from reception of the communication) via one or more other network nodes or devices.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating a non-active time for a cell; and perform or skip transmission of one or more physical uplink channels or signals, or reception of one or more physical downlink channels or signals, during the non-active time according to one or more conditions. As described in more detail elsewhere herein, the communication manager 140 may receive configuration information indicating a non-active time for cell DRX and indicating a quantity of repetitions for a physical uplink channel or signal; and transmit one or more repetitions of the physical uplink channel or signal in one or more transmission occasions outside of the non-active time, and skip one or more repetitions of the physical uplink channel or signal in one or more transmission occasions in the non-active time. As described in more detail elsewhere herein, the communication manager 140 may receive configuration information that indicates a non-active time for a cell, where the non-active time is for cell discontinuous transmission; and skip monitoring a physical downlink control channel (PDCCH) during a duration of a DRX active time of the UE that overlaps in time with the non-active time. As described in more detail elsewhere herein, the communication manager 140 may receive configuration information that indicates a non-active time for cell DRX and that indicates a quantity of repetitions for one of a physical uplink channel or signal; transmit one or more repetitions of the one of the physical uplink channel or signal in one or more transmission occasions outside of the non-active time; and/or drop transmission of one or more repetitions of the one of the physical uplink channel or signal in one or more transmission occasions in the non-active time. Additionally, or alternatively, the communication manager 140 may perform one or more other operations described herein.

In some aspects, the network node 110 may include a communication manager 150. As described in more detail elsewhere herein, the communication manager 150 may transmit configuration information indicating a non-active time for a cell; and perform or skip transmission of one or more physical downlink channels or signals, or reception of one or more physical uplink channels or signals, during the non-active time according to one or more conditions. As described in more detail elsewhere herein, the communication manager 150 may transmit configuration information indicating a non-active time for cell DRX and indicating a quantity of repetitions for a physical uplink channel or signal; and receive one or more repetitions of the physical uplink channel or signal in one or more occasions outside of the non-active time, and skip one or more repetitions of the physical uplink channel or signal in one or more occasions in the non-active time. As described in more detail elsewhere herein, the communication manager 150 may transmit configuration information that indicates a non-active time for a cell, where the non-active time is for cell discontinuous transmission; and skip transmitting a PDCCH communication for a UE during a duration of a DRX active time of the UE that overlaps in time with the non-active time. As described in more detail elsewhere herein, the communication manager 150 may transmit configuration information that indicates a non-active time for cell DRX and that indicates a quantity of repetitions for one of a physical uplink channel or signal; receive one or more repetitions of the one of the physical uplink channel or signal in one or more occasions outside of the non-active time; and/or drop reception of one or more repetitions of the one of the physical uplink channel or signal in one or more occasions in the non-active time. Additionally, or alternatively, the communication manager 150 may perform one or more other operations described herein.

As indicated above, FIG. 1 is provided as an example. Other examples may differ from what is described with regard to FIG. 1.

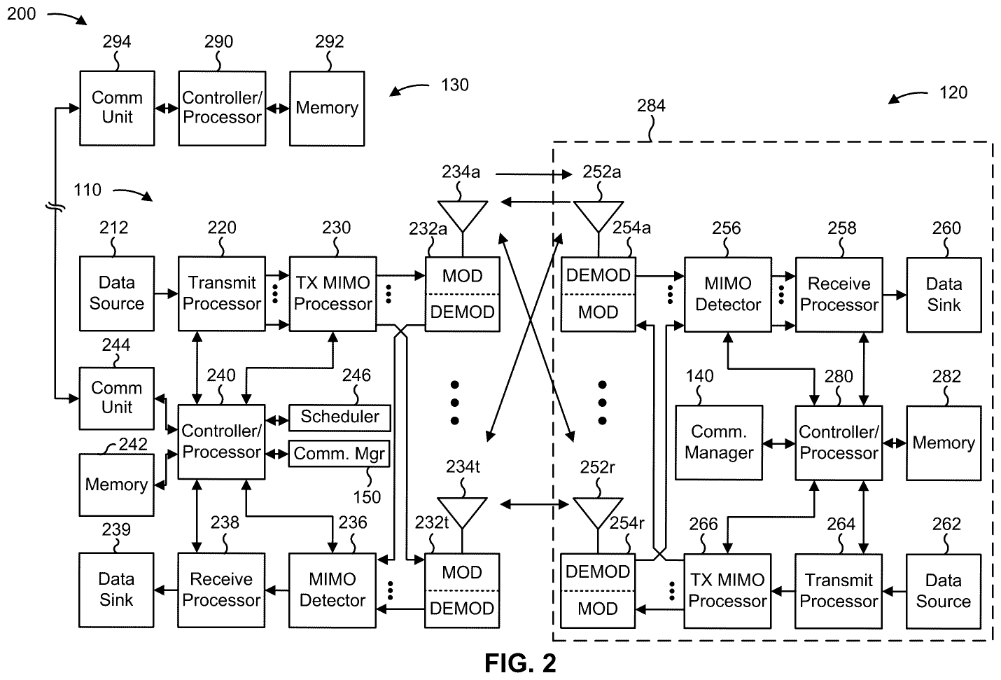

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

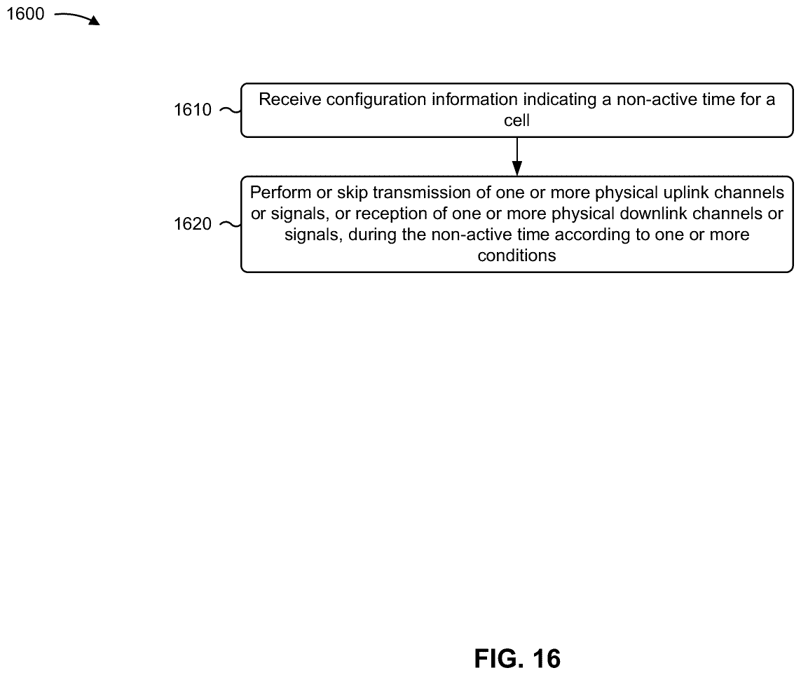

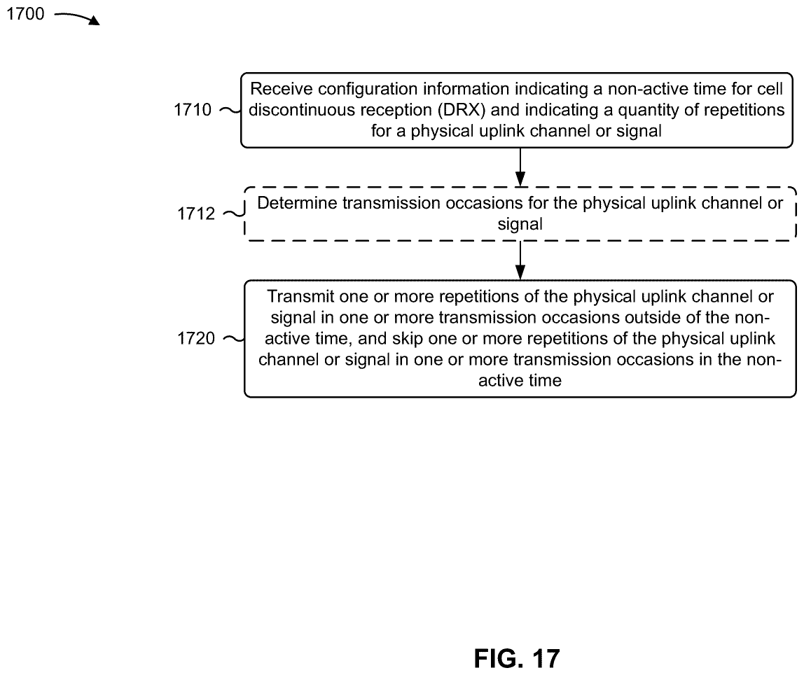

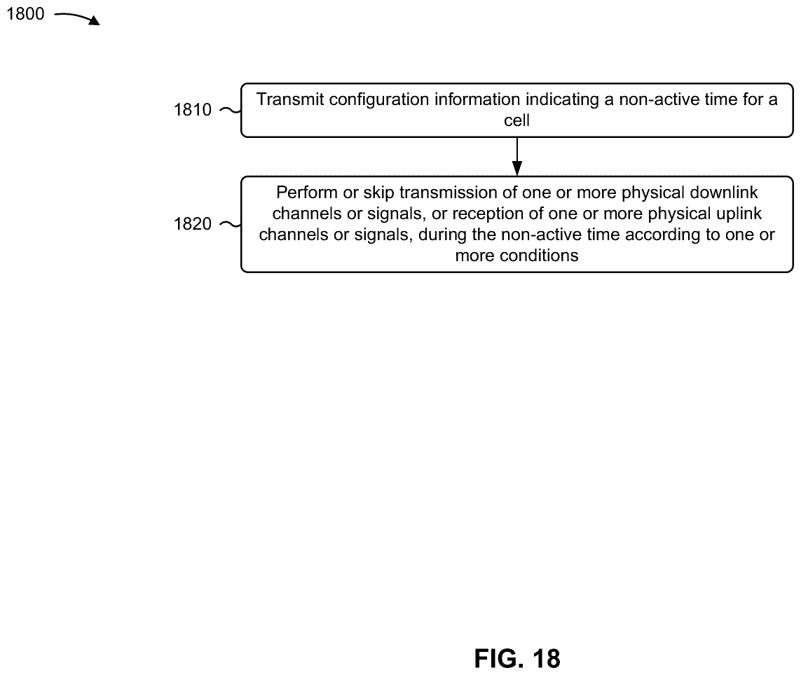

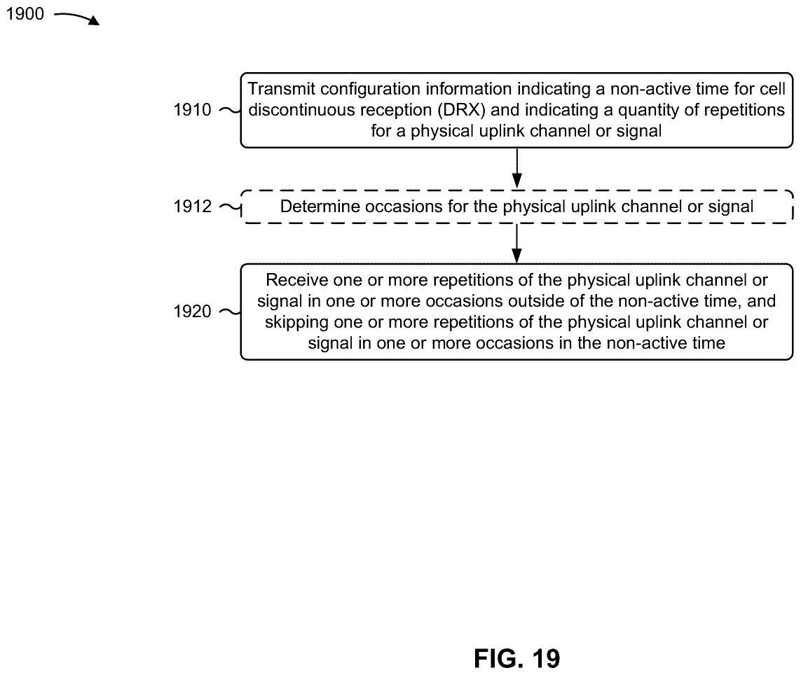

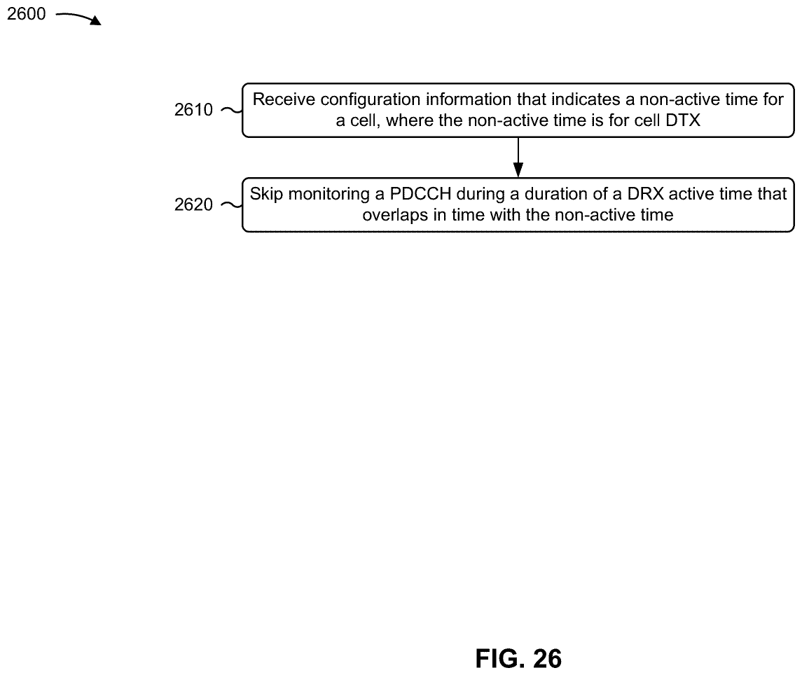

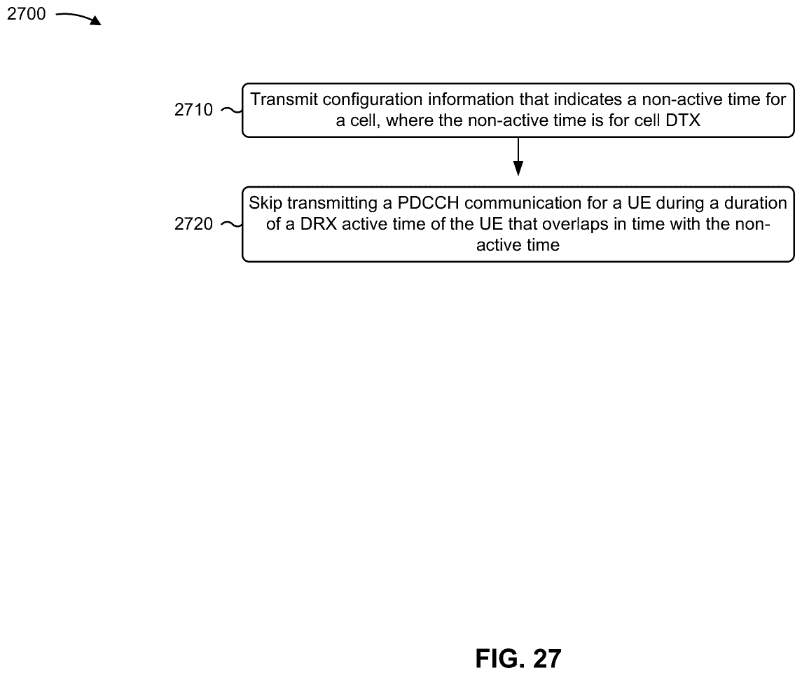

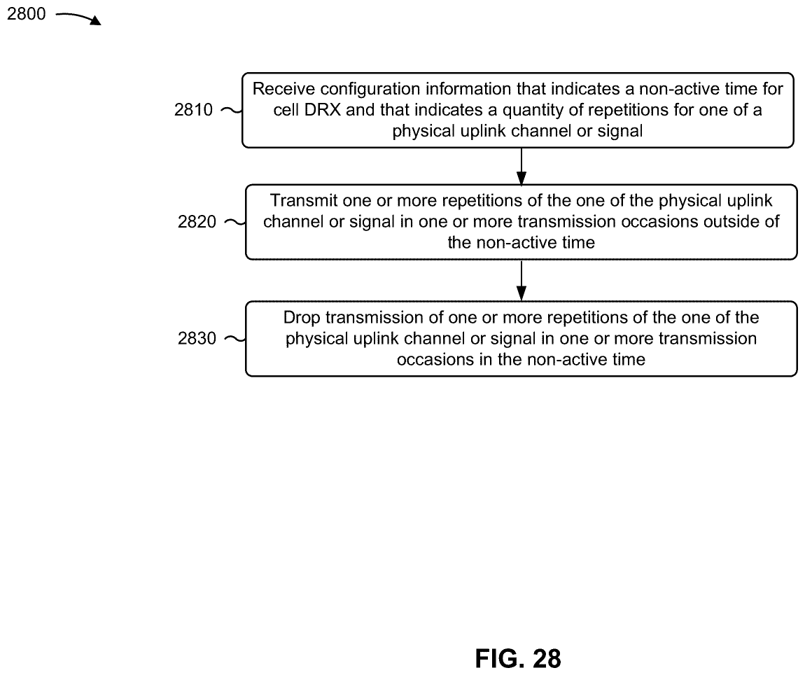

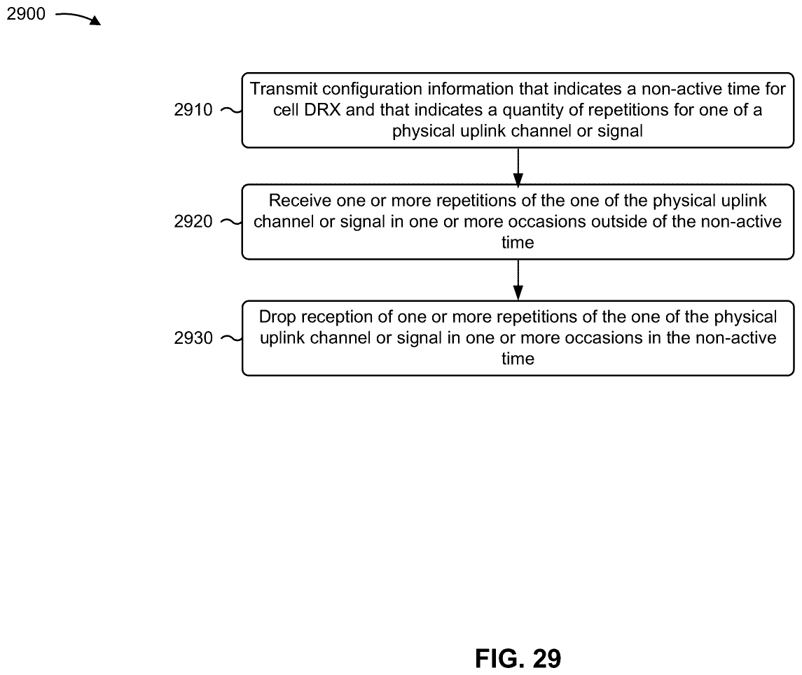

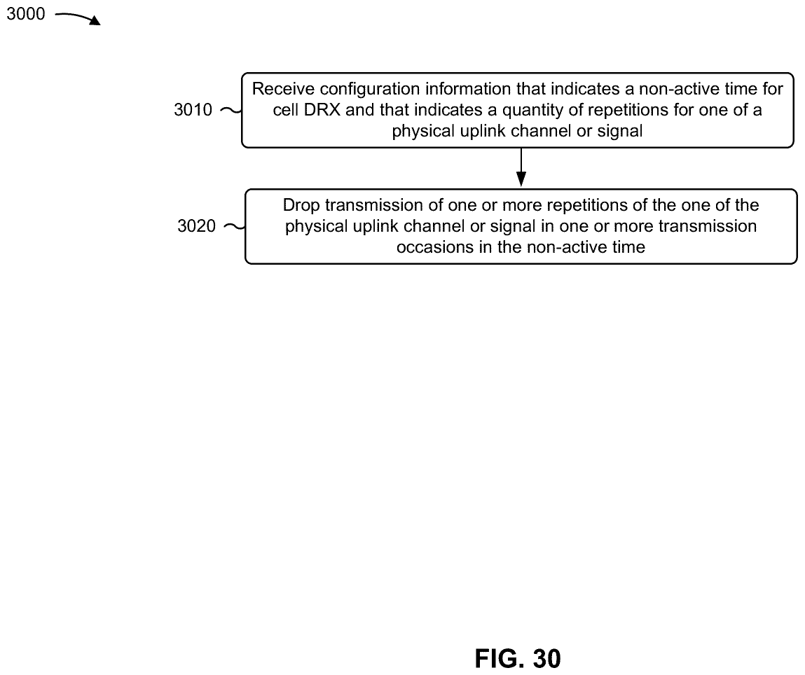

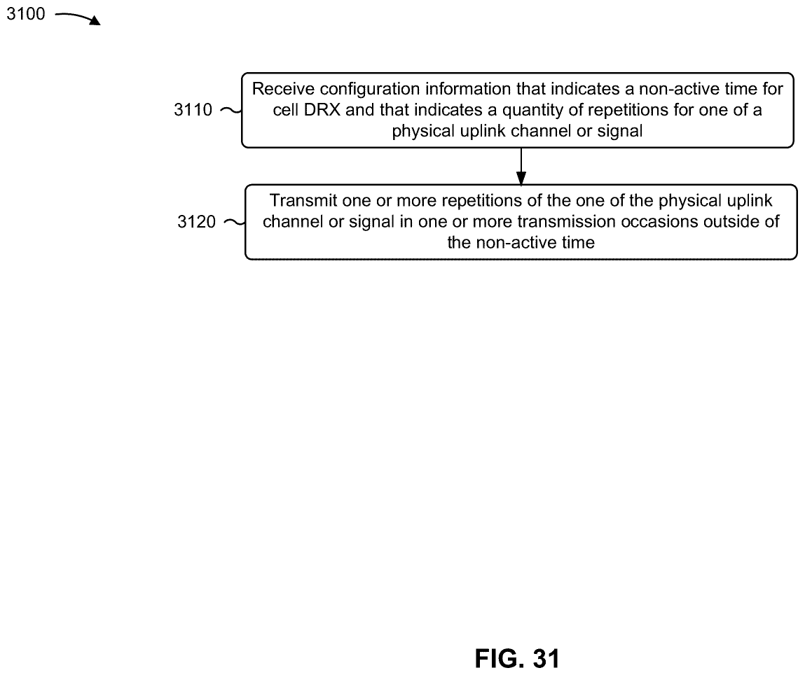

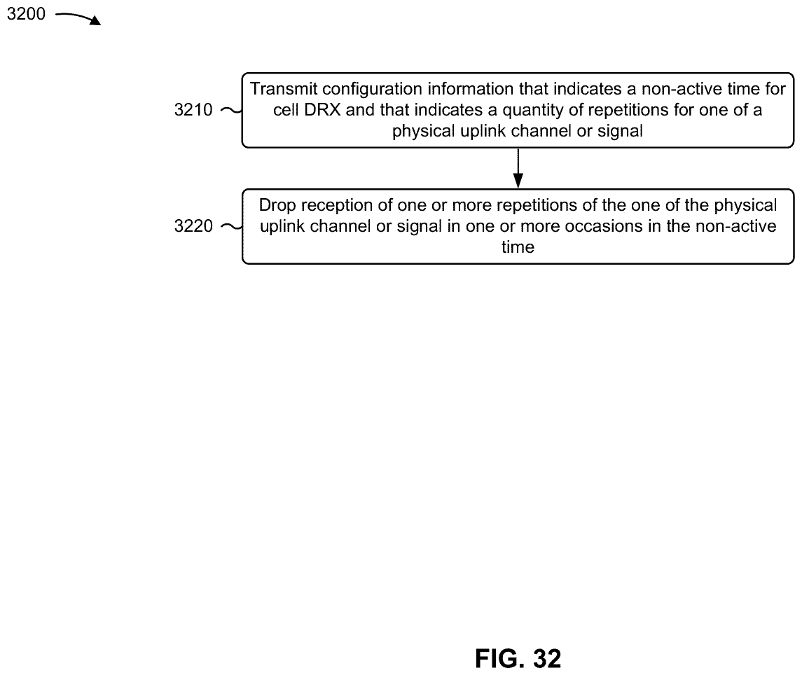

The controller/processor 240 of the network node 110, the controller/processor 280 of the UE 120, and/or any other component(s) of FIG. 2 may perform one or more techniques associated with communication in a non-active time for a cell, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, process 1800 of FIG. 18, process 1900 of FIG. 19, process 2600 of FIG. 26, process 2700 of FIG. 27, process 2800 of FIG. 28, process 2900 of FIG. 29, process 3000 of FIG. 30, process 3100 of FIG. 31, process 3200 of FIG. 32, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, process 1800 of FIG. 18, process 1900 of FIG. 19, process 2600 of FIG. 26, process 2700 of FIG. 27, process 2800 of FIG. 28, process 2900 of FIG. 29, process 3000 of FIG. 30, process 3100 of FIG. 31, process 3200 of FIG. 32, and/or other processes as described herein. In some examples, executing instructions may include running the instructions, converting the instructions, compiling the instructions, and/or interpreting the instructions, among other examples.

In some aspects, the UE 120 includes means for receiving configuration information indicating a non-active time for a cell; and/or means for performing or skipping transmission of one or more physical uplink channels or signals, or reception of one or more physical downlink channels or signals, during the non-active time according to one or more conditions. In some aspects, the UE 120 includes means for receiving configuration information indicating a non-active time for cell DRX and indicating a quantity of repetitions for a physical uplink channel or signal; and/or means for transmitting one or more repetitions of the physical uplink channel or signal in one or more transmission occasions outside of the non-active time, and skipping one or more repetitions of the physical uplink channel or signal in one or more transmission occasions in the non-active time. In some aspects, the UE 120 includes means for receiving configuration information that indicates a non-active time for a cell, where the non-active time is for cell discontinuous transmission; and/or means for skipping monitoring a PDCCH during a duration of a DRX active time of the UE that overlaps in time with the non-active time. In some aspects, the UE 120 includes means for receiving configuration information that indicates a non-active time for cell DRX and that indicates a quantity of repetitions for one of a physical uplink channel or signal; means for transmitting one or more repetitions of the one of the physical uplink channel or signal in one or more transmission occasions outside of the non-active time; and/or means for dropping transmission of one or more repetitions of the one of the physical uplink channel or signal in one or more transmission occasions in the non-active time. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information indicating a non-active time for a cell; and/or means for performing or skipping transmission of one or more physical downlink channels or signals, or reception of one or more physical uplink channels or signals, during the non-active time according to one or more conditions. In some aspects, the network node 110 includes means for transmitting configuration information indicating a non-active time for cell DRX and indicating a quantity of repetitions for a physical uplink channel or signal; and/or means for receiving one or more repetitions of the physical uplink channel or signal in one or more occasions outside of the non-active time, and skipping one or more repetitions of the physical uplink channel or signal in one or more occasions in the non-active time. In some aspects, the network node 110 includes means for transmitting configuration information that indicates a non-active time for a cell, where the non-active time is for cell discontinuous transmission; and/or means for skipping transmitting a PDCCH communication for a UE during a duration of a DRX active time of the UE that overlaps in time with the non-active time. In some aspects, the network node 110 includes means for transmitting configuration information that indicates a non-active time for cell DRX and that indicates a quantity of repetitions for one of a physical uplink channel or signal; means for receiving one or more repetitions of the one of the physical uplink channel or signal in one or more occasions outside of the non-active time; and/or means for dropping reception of one or more repetitions of the one of the physical uplink channel or signal in one or more occasions in the non-active time. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

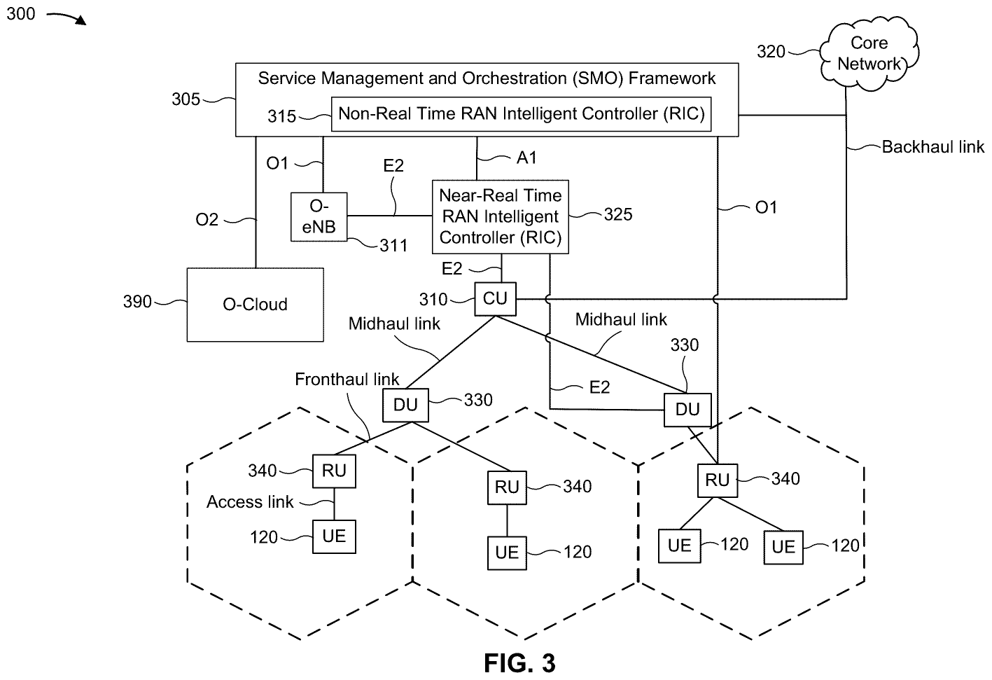

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

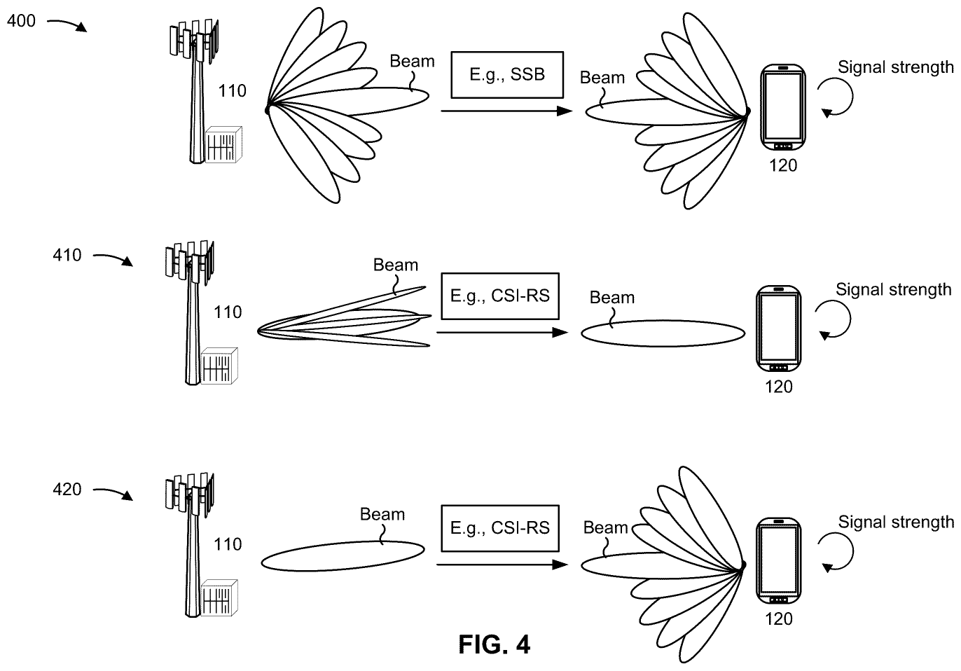

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some examples, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management. Example 400 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 4 and example 400, synchronization signal blocks (SSBs) or CSI-RSs may be transmitted from the network node 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the network node 110 performing beam sweeping over multiple transmit (Tx) beams. The network node 110 may transmit an SSB and/or a CSI-RS using each transmit beam for beam management. To enable the UE 120 to perform receive (Rx) beam sweeping, the network node may use a transmit beam to transmit (e.g., with repetitions) each SSB and/or CSI-RS at multiple times within the same reference signal resource set so that the UE 120 can sweep through receive beams in multiple transmission instances. For example, if the network node 110 has a set of N transmit beams and the UE 120 has a set of M receive beams, the SSB and/or the CSI-RS may be transmitted on each of the N transmit beams M times so that the UE 120 may receive M instances of the SSB and/or the CSI-RS per transmit beam. In other words, for each transmit beam of the network node 110, the UE 120 may perform beam sweeping through the receive beams of the UE 120. As a result, the first beam management procedure may enable the UE 120 to measure (e.g., a Layer 1 (L1) RSRP measurement) an SSB and/or a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120.

As shown in FIG. 4, example 410 may include a network node 110 and a UE 120 communicating to perform beam management. Example 410 depicts a second beam management procedure (e.g., P2 beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams (e.g., a smaller set of transmit beams as compared to the first beam management procedure). The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). For example, the UE 120 may measure each CSI-RS without sweeping through receive beams. The second beam management procedure may enable the network node 110 to select a best transmit beam based at least in part on measurements of the CSI-RSs (e.g., measured by the UE 120 using the single receive beam) reported by the UE 120. For example, the UE 120 may report an index (e.g., a CSI-RS resource indicator (CRI)) and a signal strength (e.g., L1 RSRP) for the strongest beam(s).

As shown in FIG. 4, example 420 depicts a third beam management procedure (e.g., P3 beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management procedure may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RSs at multiple times (e.g., in quick succession) within the same reference signal resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams). In some examples, the UE 120 may select the best receive beam without reporting measurement results to the network node 110. Although the first, second, and third beam management procedures are described herein with reference to an SSB and/or a CSI-RS, another type of reference signal may be used, such as a positioning reference signal. Moreover, a beam management procedure described herein as being performed using an SSB may be performed using a CSI-RS or another reference signal, and a beam management procedure described herein as being performed using a CSI-RS may be performed using an SSB or another reference signal.

In some examples, the UE 120 may perform measurement of reference signals in connection with time and frequency tracking, beam failure detection (BFD), and/or radio link monitoring (RLM). In time and frequency tracking, the UE 120 may monitor one or more reference signals to maintain time and frequency synchronization of the set of reference signals. In BFD, the network node 110 may transmit one or more BFD reference signals (e.g., SSBs and/or CSI-RSs) to the UE 120. The UE 120 may attempt to detect and measure the BFD reference signals. Based at least in part on the UE 120 failing to detect a threshold quantity of the BFD reference signals or measurements of a threshold quantity of the BFD reference signals satisfying a measurement threshold, the UE 120 may determine that beam failure has occurred. In RLM, the network node 110 may transmit one or more RLM reference signals (e.g., SSBs and/or CSI-RSs) to the UE 120. The UE 120 may perform measurement of the RLM reference signals to determine whether a radio link between the UE 120 and the network node 110 has failed. When the UE 120 determines that the radio link has failed (e.g., if estimated link qualities of all RLM reference signals fail to satisfy a threshold), the UE 120 may provide an indication to the network node 110.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

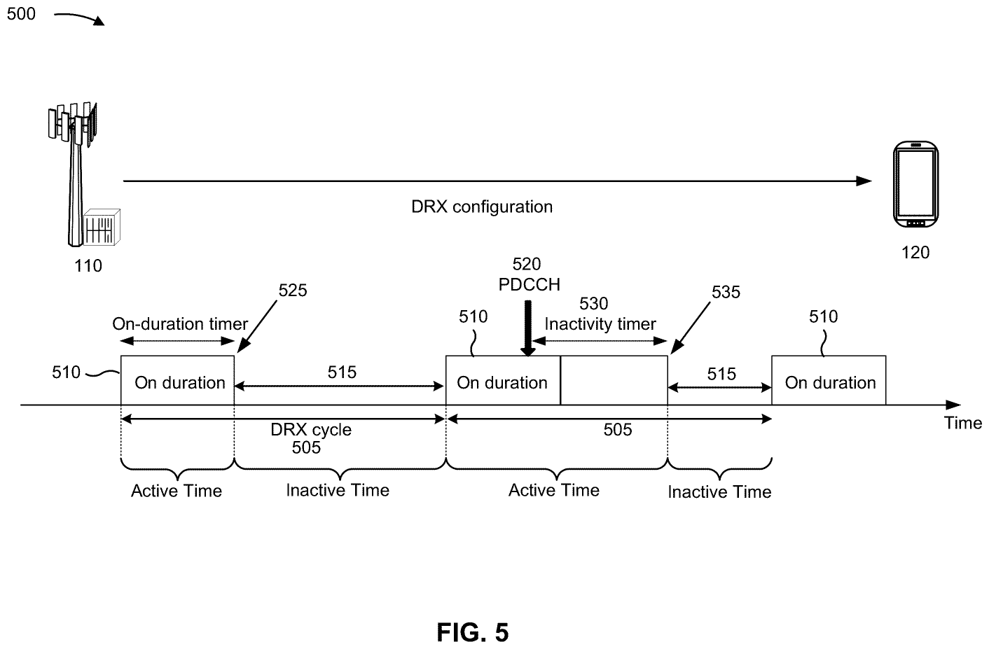

FIG. 5 is a diagram illustrating an example 500 of a DRX configuration, in accordance with the present disclosure. As shown in FIG. 5, example 500 includes a UE 120 in communication with a network node 110. In some examples, the UE 120 may be in a connected state (e.g., an RRC connected state) with the network node 110. For example, the DRX configuration may be for connected mode DRX (C-DRX).

As shown in FIG. 5, the network node 110 may transmit a DRX configuration to the UE 120 to configure a DRX cycle 505 for the UE 120. A DRX cycle 505 may include a DRX on duration 510 (e.g., during which the UE 120 is awake or in an active state) and a DRX off duration 515 (e.g., during which the UE 120 has an opportunity to enter a DRX sleep state).

During the DRX on duration 510, the UE 120 may be in an active state to monitor a downlink control channel (e.g., a PDCCH), as shown by reference number 520. For example, the UE 120 may monitor the PDCCH for DCI pertaining to the UE 120. If the UE 120 does not detect and/or successfully decode any PDCCH communications intended for the UE 120 during the DRX on duration 510, then the UE 120 may enter a sleep state at the end of the DRX on duration 510, during the DRX off duration 515, as shown by reference number 525. In the sleep state, the UE 120 may refrain from transmitting or receiving on an access link, may deactivate particular subcarriers or component carriers of the access link, and/or may deactivate one or more components of the UE 120. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in the active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter a sleep state (e.g., for a remainder of a DRX off duration 515), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state.

As described herein, a DRX active time of the UE 120 may be a time in which the UE 120 is in an active state, which may correspond to a DRX on duration 510 (e.g., if the UE 120 does not decode any PDCCH communications intended for the UE 120) or may correspond to a DRX on duration 510 and a portion of a DRX off duration 515 in which the DRX inactivity timer 530 is running (e.g., if the UE 120 does decode a PDCCH communication intended for the UE 120). A DRX inactive time of the UE 120 may be a remainder of a DRX cycle 505 after the DRX active time. For example, a DRX inactive time of the UE 120 may be a time in which the UE 120 is in a sleep state (e.g., an inactive state), which may correspond to a DRX off duration 515 (e.g., if the UE 120 does not decode any PDCCH communications intended for the UE 120) or may correspond to a portion of a DRX off duration 515 after expiration of the DRX inactivity timer 530 (e.g., if the UE 120 does decode a PDCCH communication intended for the UE 120).

In some examples, the UE 120 may transmit or receive communications outside of an active time for the UE 120. For example, outside of an active time, the UE 120 may receive system information, a radio resource management (RRM) reference signal, a beam management reference signal, a BFD reference signal, a PDSCH communication in accordance with semi-persistent scheduling (SPS), and/or a PDSCH communication scheduled by a dynamic grant of a PDCCH communication received in an active time (e.g., when a K0 value is larger than the DRX inactivity timer 530, where the K0 value represents a timing offset (e.g., in number of slots) between a slot containing the PDCCH communication with scheduling DCI (carrying a grant that schedules the PDSCH communication) and a slot containing the scheduled PDSCH communication (scheduled by the scheduling DCI)). As another example, outside of an active time, the UE 120 may transmit a scheduling request, a communication in accordance with a configured grant, a random access channel (RACH) communication (e.g., a PRACH-ResourceDedicatedBFR for beam failure recovery (BFR)), a PUSCH communication scheduled by a dynamic grant of a PDCCH communication received in an active time, and/or a physical uplink control channel (PUCCH) communication carrying hybrid automatic repeat request acknowledgment feedback (HARQ-ACK) for a PDSCH communication scheduled by a PDCCH communication received in an active time. Transmission or reception by the UE 120 outside of an active time may limit opportunities for the network node 110 to enter a deep sleep (e.g., a deeper sleep than a micro sleep having a symbol-level granularity).

As indicated above, FIG. 5 is provided as an example. Other examples may differ from what is described with respect to FIG. 5.

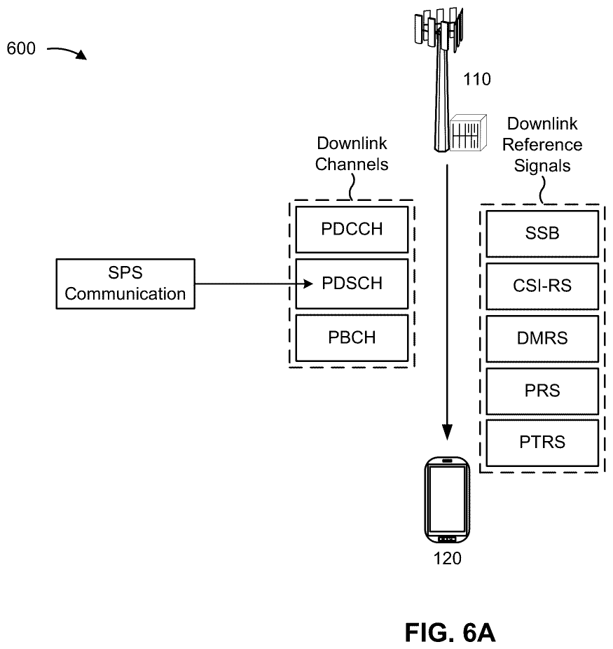

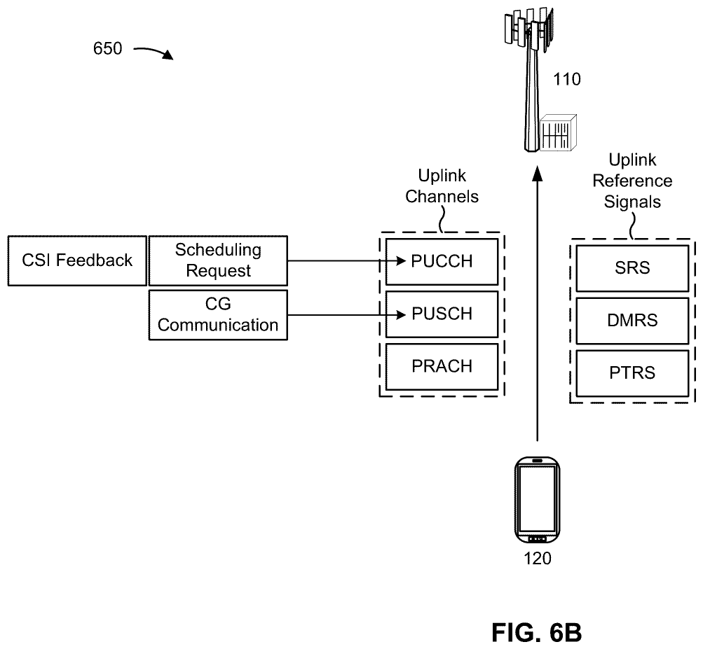

FIG. 6A is a diagram illustrating an example 600 of physical channels and reference signals in a wireless network, in accordance with the present disclosure. As shown in FIG. 6A, downlink channels and downlink reference signals may carry information from a network node 110 to a UE 120.

As shown, a downlink channel may include a PDCCH that carries DCI, a physical downlink shared channel (PDSCH) that carries downlink data, or a physical broadcast channel (PBCH) that carries system information, among other examples. In some examples, PDSCH communications may be scheduled by PDCCH communications. In some examples, an SPS communication may be communicated in a PDSCH (which may be referred to as an “SPS PDSCH”). SPS communications may include periodic downlink communications that are configured for the UE 120, such that the network node 110 does not need to transmit separate DCI to schedule each downlink communication, thereby conserving signaling overhead. As further shown, a downlink reference signal may include an SSB, a CSI-RS, a DMRS, a positioning reference signal (PRS), or a phase tracking reference signal (PTRS), among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CHI, a precoding matrix indicator (PMI), a CRI, a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples. In some examples, a CSI-RS may be used for time and frequency tracking (which may be referred to as a “tracking reference signal (TRS)”), as described above.

A DMRS may carry information used to estimate a radio channel for demodulation of an associated physical channel (e.g., PDCCH, PDSCH, or PBCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs may be used for downlink communications.

A PRS (e.g., a CSI-RS used for positioning) may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs may be used for downlink communications.

As indicated above, FIG. 6A is provided as an example. Other examples may differ from what is described with regard to FIG. 6A.

FIG. 6B is a diagram illustrating an example 650 of physical channels and reference signals in a wireless network, in accordance with the present disclosure. As shown in FIG. 6B, uplink channels and uplink reference signals may carry information from a UE 120 to a network node 110.

As shown, an uplink channel may include a PUCCH that carries uplink control information (UCI), a PUSCH that carries uplink data, or a PRACH used for initial network access, among other examples. In some examples, a scheduling request (SR) may be communicated in a PUCCH. A scheduling request is a message requesting the network node 110 to allocate uplink radio resources to be used by the UE 120 to transmit uplink data (e.g., if the UE 120 has uplink data to transmit, but there are no uplink resources allocated to the UE 120). In some examples, a configured grant (CG) communication may be communicated in a PUSCH (which may be referred to as a “CG PUSCH”). CG communications may include periodic uplink communications that are configured for the UE 120, such that the network node 110 does not need to transmit separate DCI to schedule each uplink communication, thereby conserving signaling overhead. In some examples, the UE 120 may transmit acknowledgement (ACK) or negative acknowledgement (NACK) feedback (e.g., ACK/NACK feedback or ACK/NACK information) in UCI on the PUCCH and/or the PUSCH. As further shown, an uplink reference signal may include an SRS, a DMRS, or a PTRS, among other examples.

As described above, a DMRS may carry information used to estimate a radio channel for demodulation of an associated physical channel (e.g., PUCCH or PUSCH). As shown, DMRSs may be used for uplink communications. As described above, a PTRS may carry information used to compensate for oscillator phase noise. As shown, PTRSs may be used for uplink communications (e.g., on the PUSCH).

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 6B is provided as an example. Other examples may differ from what is described with regard to FIG. 6B.

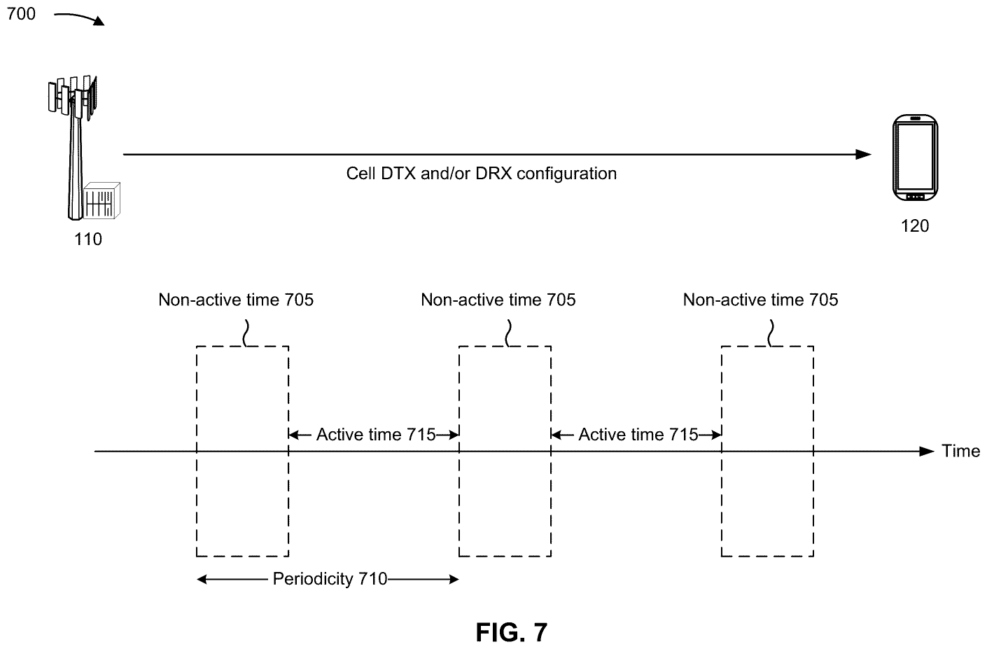

FIG. 7 is a diagram illustrating an example 700 of cell DTX and/or DRX, in accordance with the present disclosure. As shown in FIG. 7, example 700 includes a UE 120 in communication with a network node 110. In some examples, the UE 120 may be in a connected state (e.g., an RRC connected state) with the network node 110.

As shown, the network node 110 may transmit a cell DTX and/or DRX configuration to the UE 120 to configure a cell DTX and/or DRX cycle for the UE 120. For example, the configuration may be for cell DTX, cell DRX, or both cell DTX and cell DRX. The configuration may indicate a non-active time 705 (which may also be referred to as an “uplink and/or downlink channel restriction window”) for the cycle. The configuration may indicate a starting time of the non-active time 705 (e.g., a time offset), a duration of the non-active time 705, and/or a periodicity 710 of the non-active time 705, among other examples. One or more types of physical channels or signals may be restricted during the non-active time 705 (e.g., a restricted channel or signal that is scheduled or configured during the non-active time 705 may be dropped by the network node 110 and/or the UE 120). That is, the UE 120 may be expected to not transmit or receive particular channels or signals during the non-active time 705. In this way, the network node 110 may enter a sleep state during the non-active time 705. Downlink channels or signals restricted during the non-active time 705 may include periodic and/or semi-persistent CSI-RSs (e.g., including TRSs), PRSs, PDCCHs scrambled with a UE-specific radio network temporary identifier (RNTI), PDCCHs in a type-3 common search space (CSS) (e.g., a group-common PDCCH), and/or SPS PDSCHs, among other examples. Additionally, or alternatively, uplink channels or signals restricted during the non-active time 705 may include scheduling requests, periodic and/or semi-persistent CSI reports, periodic and/or semi-persistent SRSs, and/or CG PUSCHs, among other examples. As further shown, cell DTX and/or DRX may include active times 715 outside of (e.g., between) non-active times 705. Physical channel or signal restrictions applicable to the non-active time 705 may not be applicable to the active time 715.

In some examples, during the non-active time 705, the UE 120 may be expected to drop physical channels or signals associated with a minimal impact to UE implementation complexity or system performance. For example, in downlink, the UE 120 may drop reception of a PDCCH in a type-3 CSS, an SPS communication, a CSI-RS for generating CSI, and/or a CSI-RS for propagation delay compensation, among other examples. Additionally, or alternatively, in uplink, the UE 120 may drop transmission of a scheduling request, a CG communication, and/or CSI feedback, among other examples. However, during the non-active time 705, the UE 120 may not be expected to drop physical channels or signals associated with a high impact to UE implementation complexity or system performance. For example, in downlink, the UE 120 may receive a CSI-RS for tracking (e.g., a TRS), a CSI-RS for positioning, a CSI-RS for beam management, and/or a CSI-RS for beam failure detection, among other examples. Additionally, or alternatively, in uplink, the UE 120 may transmit an SRS for positioning and/or a scheduling request, among other examples.

Accordingly, the network node may sometimes be awake during non-active time to transmit and/or receive communications associated with the physical channels or signals that have significant impact on system and UE performance, thereby impacting network energy savings. For example, from a network energy savings perspective, dropping all types of channels or signals during the non-active time 705 may be ideal. However, doing so may have an adverse effect on system and UE performance.

Some techniques and apparatuses described herein enable selective transmission or skipping (e.g., not transmitting) of physical channels or signals during non-active time for a cell to provide a balance among network energy savings, UE complexity, and system performance. In some aspects, transmissions associated with one or more first types of physical channels or signals (e.g., that have little impact on system and UE performance) may be skipped during non-active time. For example, dropping of these physical channels or signals would not adversely affect data rates, latency, cell coverage, and/or UE-network node synchronization. In some aspects, transmissions associated with one or more second types of physical channels or signals (e.g., that have significant impact on system and UE performance) may be performed or skipped during non-active time according to one or more conditions. For example, dropping of these physical channels or signals (e.g., unrestricted physical channels or signals, described herein) would adversely affect data rates, latency, cell coverage, and/or UE-network node synchronization.

In some aspects, a condition may relate to a duration and/or a periodicity of the non-active time, a periodicity and/or a quantity of repetitions of a physical channel or signal, a QoS requirement of a UE and/or of traffic of the UE, a mobility state of a UE, and/or a signal quality at a UE, among other examples. For example, a transmission associated with a physical channel or signal that is transmitted frequently may be skipped during non-active time, whereas a transmission associated with a physical channel or signal that is transmitted less frequently may be performed during non-active time. In this way, substantial network energy savings may be achieved while maintaining data rates, latency, cell coverage, and/or UE-network node synchronization at acceptable levels (e.g., at levels according to a QoS requirement and/or at levels that maintain a communication link between the UE and the network node).

As indicated above, FIG. 7 is provided as an example. Other examples may differ from what is described with respect to FIG. 7.

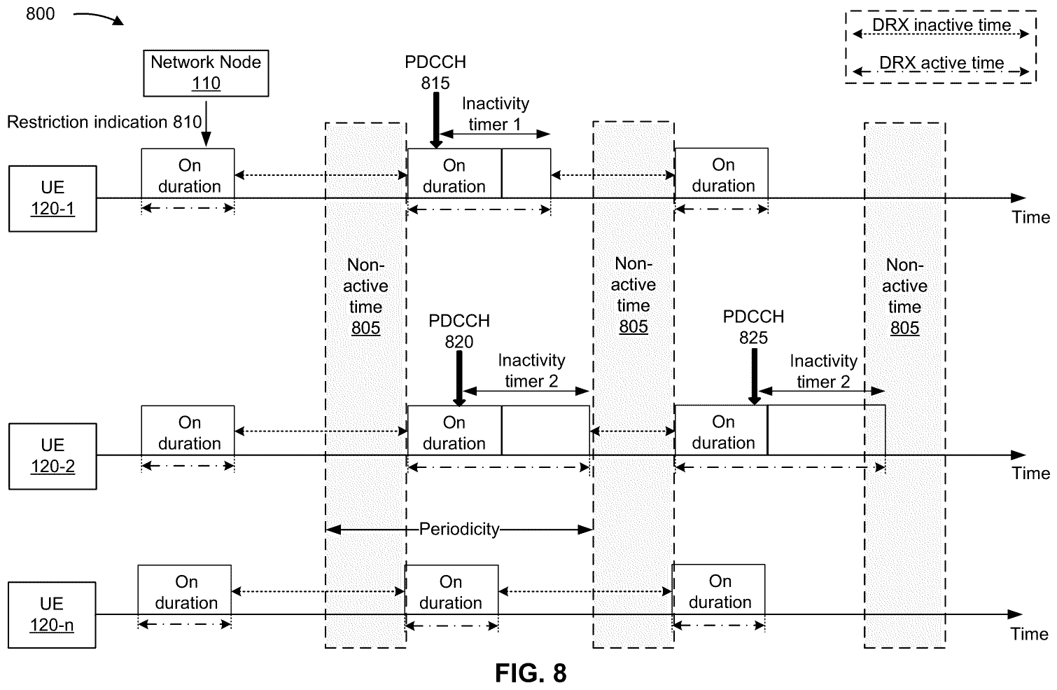

FIG. 8 is a diagram illustrating an example 800 of cell DTX and/or DRX with UE DRX, in accordance with the present disclosure. As shown in FIG. 8, example 800 includes multiple UEs 120 (shown as UE 120-1, UE 120-2, and UE 120-n) in a cell in communication with a network node 110. In some examples, the UEs 120 may be in a connected state (e.g., an RRC connected state) with the network node 110. The UEs 120 may operate in a DRX mode, as described herein. As shown, DRX cycles of the UEs 120 may be aligned (e.g., the on durations of the UEs 120 may coincide in time).

As shown, the UEs 120 may operate in a DRX mode with respective DRX active times (e.g., that do not fully overlap in time) due to the UEs 120 being configured with different DRX inactivity timer (e.g., drx-InactivityTimer) durations (shown as inactivity timer 1 and inactivity timer 2) and/or due to the UEs 120 starting respective DRX inactivity timers at different times in accordance with a timing of PDCCH reception at the UEs 120. Furthermore, a non-active time 805 for cell DTX and/or DRX may be configured for the UEs 120, as described herein. The non-active time 805 may occur according to a periodicity.

As shown, the UE 120-1 may receive an uplink and/or downlink restriction indication 810 from the network node 110, which may indicate that the UE 120-1 is to skip transmission and/or reception of particular physical channels or signals during the non-active time 805. Similar indications may be received by the UE 120-2 or the UE 120-n from the network node 110. The UE 120-1 may receive, from the network node 110, a PDCCH communication 815 intended for the UE 120-1 at a first time within a DRX on duration of a DRX cycle. The UE 120-2 may receive, from the network node 110, a PDCCH communication 820 intended for the UE 120-2 at a second time (e.g., later than the first time) within the DRX on duration of the DRX cycle.

The UE 120-1 may initiate a first DRX inactivity timer (inactivity timer 1) upon reception of the PDCCH communication 815. The UE 120-2 may initiate a second DRX inactivity timer (inactivity timer 2) upon reception of the PDCCH communication 820. Thus, the first DRX inactivity timer and the second DRX inactivity timer may be initiated at different times. Moreover, as shown, the second DRX inactivity timer may run for a longer time than the first DRX inactivity timer. In other words, the first DRX inactivity timer and the second DRX inactivity timer may terminate at different times. As a result, the UE 120-1 and the UE 120-2 may have different inactive times in the DRX cycle.

In some aspects, the non-active time 805 may correspond to a time overlap of DRX inactive times across all UEs 120 (e.g., operating in a connected mode) in the cell, rather than the individual inactive times of each UE 120. However, in some cases, a portion of the non-active time 805 may overlap with a DRX active time of a DRX cycle. For example, as shown, the UE 120-2 may receive, from the network node 110, a PDCCH communication 825 at a time late within a DRX on duration of a DRX cycle. The UE 120-2 may initiate the second DRX inactivity timer (inactivity timer 2) upon reception of the PDCCH communication 825, which may result in the DRX active time overlapping with the non-active time 805. In this portion of the non-active time 805, the UE 120-2 may transmit or receive a communication without applying an indication to skip transmission and/or reception of particular physical channels or signals during the non-active time 805.

As indicated above, FIG. 8 is provided as an example. Other examples may differ from what is described with respect to FIG. 8.

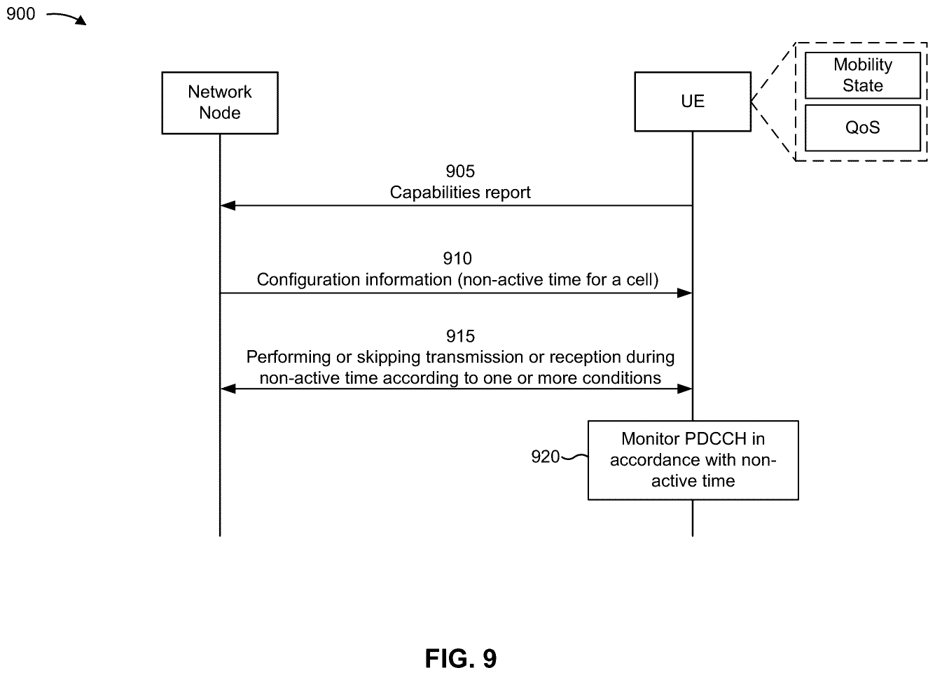

FIG. 9 is a diagram of an example 900 associated with communication in a non-active time for a cell, in accordance with the present disclosure. As shown in FIG. 9, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 9.

As shown by reference number 905, the UE may transmit, and the network node may receive, a capabilities report (e.g., UE capability information). In some aspects, the capabilities report may indicate UE support for cell DTX and/or DRX.

As shown by reference number 910, the network node may transmit, and the UE may receive, configuration information. In some aspects, the UE may receive the configuration information via one or more of RRC signaling, one or more MAC-CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples. The UE may receive the configuration information in one or more transmissions from the network node.

In some aspects, the configuration information may indicate a non-active time for a cell. The non-active time may be for cell DTX, may be for cell DRX, or may be for both cell DTX and cell DRX. In some aspects, the configuration information may indicate a starting time of the non-active time (e.g., a time offset), a duration of the non-active time, and/or a periodicity of the non-active time, among other examples. During the duration of the non-active time, one or more types of physical channels or signals may be dropped (e.g., are to be always dropped) and one or more types of physical channels or signals may be transmitted or dropped (e.g., are to be sometimes dropped or selectively dropped).

The types of physical channels or signals that may be dropped may be associated with a minimal impact on UE implementation complexity or system performance (e.g., dropping of these physical channels or signals would not adversely affect data rates, latency, cell coverage, and/or UE-network node synchronization), and may include a PDCCH in a type 3 common search space, an SPS communication, a CSI-RS for generating CSI, a CSI-RS for propagation delay compensation, a scheduling request, a CG communication, and/or CSI feedback, among other examples. The types of physical channels or signals that may be transmitted or dropped (e.g., unrestricted physical channels or signals, described herein) may be associated with a high impact on UE implementation complexity or system performance (e.g., dropping of these physical channels or signals would adversely affect data rates, latency, cell coverage, and/or UE-network node synchronization). For example, physical downlink channels or signals that may be transmitted or dropped may include a CSI-RS for tracking, a CSI-RS for positioning, a CSI-RS for beam management, and/or a CSI-RS for beam failure detection, among other examples. Additionally, or alternatively, physical uplink channels or signals that may be transmitted or dropped may include an SRS for positioning and/or a scheduling request, among other examples.

Whether the physical downlink channels or signals, and/or physical uplink channels or signals, are transmitted or dropped may be according to one or more conditions (which can also be referred to as “dropping rules”). In some aspects, the one or more conditions may be fixed or pre-defined. For example, the one or more conditions may be defined in a wireless communication standard, and the UE may be configured or preconfigured with information indicating the one or more conditions. In some aspects, the configuration information may further indicate the conditions (e.g., the conditions may be at least partially configurable). For example, the configuration information may indicate the criteria associated with the one or more conditions, such as one or more thresholds, one or more target values, or the like. In some aspects, the configuration information may further indicate at least one physical channel or signal to which the conditions apply (which can also be included as part of the dropping rules). For example, the configuration information may further indicate a list of physical channels or signals to which the conditions are applicable. As an example, physical channels or signals that are indicated by the list may be transmitted or dropped according to the one or more conditions, whereas physical channels or signals that are not on the list may be dropped (e.g., always dropped).

In some aspects, the UE may receive a configuration of the one or more conditions and/or the one or more physical channels or signals to which the conditions apply via broadcast RRC signaling, dedicated RRC signaling, a unicast MAC-CE, a multicast MAC-CE, unicast DCI, and/or group-common DCI, among other examples. In some aspects, the UE may receive, from the network node, one or more subsequent indications that overwrite or modify the one or more conditions and/or the one or more physical channels or signals to which the conditions apply (e.g., the indicated dropping rules may be assumed as default behavior, but can be overwritten by the network via new or later indications). In some aspects, the UE may suggest and/or negotiate the one or more conditions and/or the one or more physical channels or signals to which the conditions apply (e.g., the dropping rules) with the network node (e.g., as part of the UE's capabilities report or in one or more other messages).

In some aspects, the one or more conditions and/or the one or more physical channels or signals to which the conditions apply (e.g., the dropping rules) may be cell-specific (e.g., may be applicable to a single serving cell of the UE). In some aspects, the one or more conditions and/or the one or more physical channels or signals to which the conditions apply (e.g., the dropping rules) may be common to multiple serving cells (e.g., may be applicable to multiple serving cells of the UE). For example, the multiple serving cells, to which the one or more conditions and/or the one or more physical channels or signals to which the conditions apply are applicable, may be in the same cell group and/or in the same DRX group. In some aspects, the configuration information may further indicate one or more additional conditions and/or one or more physical channels or signals to which the additional conditions apply (additional dropping rules) associated with one or more neighboring cells (e.g., non-serving cells) of the UE. In some aspects, information relating to dropping rules (e.g., associated configurations and/or parameters) may be exchanged over network interfaces, such as between a CU and a DU (e.g., on an F1 interface), between CUs (e.g., on an Xn interface), and/or between a CU and the core network. For example, signaling between CUs may be used to request and/or suggest configurations for the UE and/or the dropping rules. In some aspects, the configuration information may further indicate whether a particular physical channel or signal (e.g., an SRS for positioning) is to be dropped during the non-active time.

The UE may configure itself based at least in part on the configuration information. In some aspects, the UE may be configured to perform one or more operations described herein based at least in part on the configuration information. In some aspects, the network node may transmit, and the UE may receive, an indication to activate (or deactivate) skipping during non-active time (e.g., cell DTX and/or DRX may be dynamically activated or deactivated for the UE). The indication may be in DCI and/or a MAC-CE, among other examples.

As shown by reference number 915, the UE may perform or skip transmission of one or more physical uplink channels or signals, or reception of one or more physical downlink channels or signals, during the non-active time according to the one or more conditions. Similarly, the network node may perform or skip transmission of one or more physical downlink channels or signals, or reception of one or more physical uplink channels or signals, during the non-active time according to the one or more conditions. For example, the UE may perform or skip transmission/reception and/or the network node may perform or skip transmission/reception according to whether the one or more conditions are satisfied.

In some aspects, a condition may relate to the duration of the non-active time and/or the periodicity of the non-active time. For example, if the duration satisfies a threshold and/or the periodicity satisfies a threshold, then the UE and/or the network node may skip transmission of a physical channel or signal. In some aspects, a condition may relate to a periodicity of a physical downlink channel or signal (e.g., if periodic) and/or a periodicity of a physical uplink channel or signal (e.g., if periodic). For example, if the periodicity satisfies a threshold, then the UE and/or the network node may skip transmission of a physical channel or signal. In some aspects, a condition may relate to a quantity of repetitions of a physical downlink channel or signal and/or a periodicity of a physical uplink channel or signal. For example, if the quantity of repetitions satisfies a threshold, then the UE and/or the network node may skip transmission of a physical channel or signal.

In some aspects, a condition may relate to a QoS requirement of the UE and/or of traffic associated with SPS, a CG, or a scheduling request. For example, if the QoS is a particular QoS type, then the UE and/or the network node may skip transmission of a physical channel or signal. In some aspects, a condition may relate to a mobility state of the UE (e.g., a high-mobility UE would need more frequency reference signals). For example, if the mobility state is a particular mobility state (e.g., mobile or not mobile, or high mobility, low mobility, or no mobility), then the UE and/or the network node may skip transmission of a physical channel or signal. In some aspects, a condition may relate to a signal quality (or a coverage area) at the UE, which may be based at least in part on an RSRP, an RSRQ, and/or a signal-to-interference-plus-noise ratio (SINR), among other examples (e.g., a cell-edge UE would need more samples and averaging of reference signals). For example, if the signal quality satisfies a threshold, then the UE and/or the network node may skip transmission of a physical channel or signal.

As shown by reference number 920, the UE may monitor a PDCCH in accordance with the non-active time. In some aspects, whether the UE monitors a PDCCH during the non-active time may be according to whether the UE is configured with DRX operation (e.g., C-DRX operation). In some aspects, the UE may skip monitoring the PDCCH (e.g., the UE does not monitor the PDCCH) if the UE is not configured with DRX operation. In some aspects, the UE may monitor or may skip monitoring the PDCCH if the UE is configured with DRX operation. In accordance with monitoring the PDCCH, the UE may receive a PDCCH communication (e.g., DCI) transmitted from the network node.

In some aspects, the UE may monitor a PDCCH during a first duration of a DRX active time of the UE that overlaps in time with the non-active time and/or during a second duration of the DRX active time that is after the non-active time (which can be referred to as a “remaining time”). Here, the network node may transmit a PDCCH communication for the UE during the first duration and/or during the second duration. In some aspects, the UE may skip monitoring a PDCCH during the first duration and/or during the second duration. Here, the network node may skip transmitting a PDCCH communication for the UE during the first duration and/or during the second duration. In some aspects, the UE may skip monitoring a PDCCH during the first duration, and the UE may monitor a PDCCH during the second duration. Here, the network node may skip transmitting a PDCCH communication for the UE during the first duration, and the network node may transmit a PDCCH communication for the UE during the second duration. In some aspects, the UE may monitor the PDCCH during the second duration, and the network node may transmit a PDCCH communication for the UE during the second duration, in accordance with a rule (e.g., the UE may determine whether the UE is to monitor the PDCCH during the second duration in accordance with a rule). For example, the UE may compare the second duration with a threshold to determine whether the UE is to monitor the PDCCH during the second duration. As an example, the UE may monitor the PDCCH during the second duration responsive to the second duration satisfying a threshold (e.g., the UE may skip monitoring the PDCCH if the second duration is less than a quantity X of symbols, and otherwise, the UE may monitor the PDCCH). In some aspects, configuration information may further indicate whether a PDCCH is to be monitored during the first duration and/or during the second duration.

By selectively communicating or skipping particular physical channels or signals during the non-active time, substantial network energy savings may be achieved while maintaining system and UE performance at an acceptable level.

As indicated above, FIG. 9 is provided as an example. Other examples may differ from what is described with respect to FIG. 9.

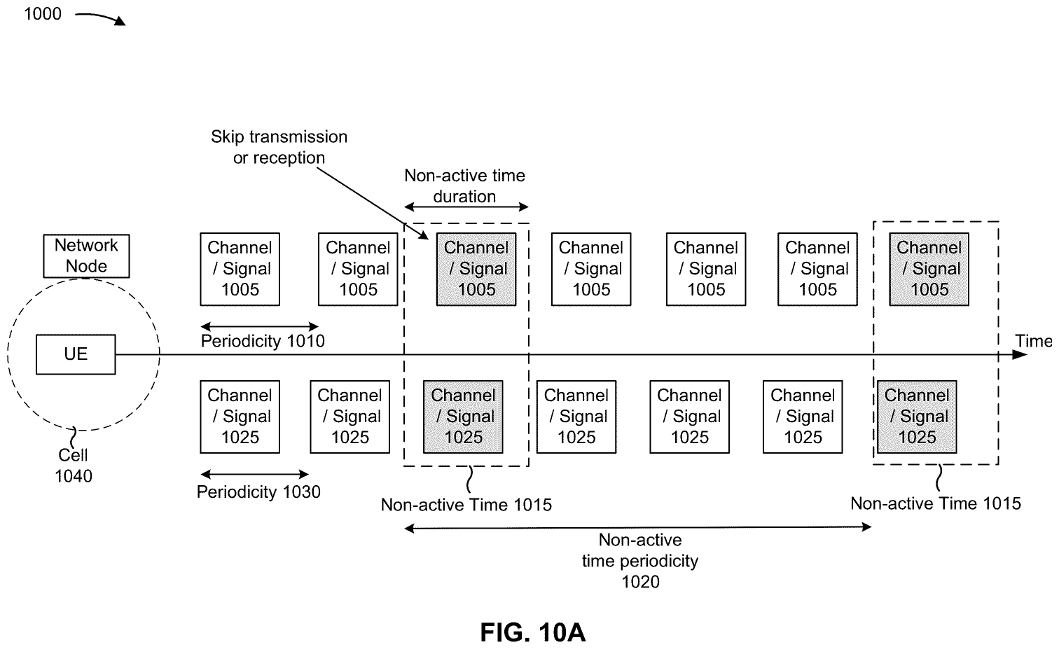

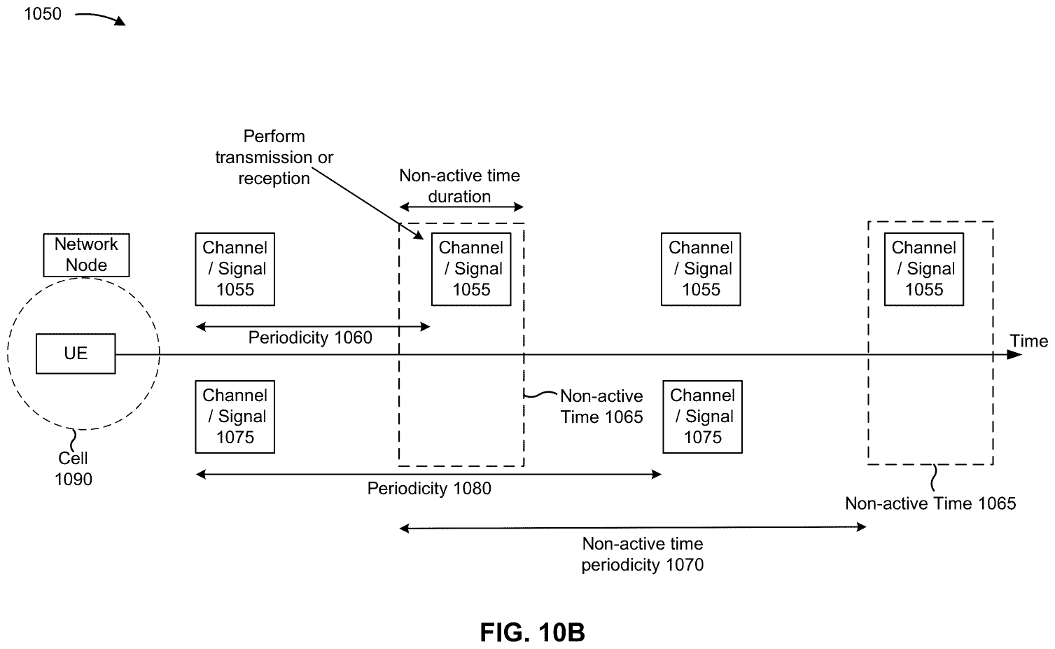

FIG. 10A is a diagram of an example 1000 associated with communication in a non-active time for a cell, in accordance with the present disclosure. Example 1000 includes the network node and the UE described in connection with FIG. 9. For example, the UE may be in a cell 1040 served by the network node. Example 1000 relates to performing or skipping transmission or reception of a physical channel or signal 1005 according to a periodicity 1010 of the physical channel or signal 1005. For example, transmission or reception of the physical channel or signal 1005 may be skipped if the periodicity 1010 is less than a threshold. As an example, the physical channel or signal 1005 may be a TRS or a PRS.

In example 1000, the periodicity 1010 of the physical channel or signal 1005 may be 10 milliseconds (ms), the duration of the non-active time 1015 may be 10 ms, and the periodicity 1020 of the non-active time 1015 may be 40 ms. In this example, the periodicity 1010 of the physical channel or signal 1005 may be less than the threshold, and accordingly, transmission or reception of the physical channel or signal 1005 may be skipped. As further shown, one or more additional physical channels or signals 1025 may be scheduled or configured for the UE, and a periodicity 1030 associated with the one or more additional physical channels or signals 1025 may be the same as, or different from, the periodicity 1010 of the physical channel or signal 1005. Accordingly, the one or more additional physical channels or signals 1025 may be transmitted or skipped during the non-active time 1015 according to a periodicity 1030 of the one or more additional physical channels or signals 1025.

As indicated above, FIG. 10A is provided as an example. Other examples may differ from what is described with respect to FIG. 10A.

FIG. 10B is a diagram of an example 1050 associated with communication in a non-active time for a cell, in accordance with the present disclosure. Example 1050 includes the network node and the UE described in connection with FIG. 9. For example, the UE may be in a cell 1090 served by the network node. Example 1050 relates to performing or skipping transmission or reception of a physical channel or signal 1055 according to a periodicity 1060 of the physical channel or signal 1055. For example, transmission or reception of the physical channel or signal 1055 may be performed if the periodicity 1060 is greater than a threshold. As an example, the physical channel or signal 1055 may be a TRS or a PRS.

In example 1050, the periodicity 1060 of the physical channel or signal 1055 may be 20 ms, the duration of the non-active time 1065 may be 10 ms, and the periodicity 1070 of the non-active time may be 40 ms. In this example, the periodicity 1060 of the physical channel or signal 1055 may be greater than the threshold, and accordingly, transmission or reception of the physical channel or signal 1055 may be performed. As further shown, one or more additional physical channels or signals 1075 may be scheduled or configured for the UE, and a periodicity 1080 associated with the one or more additional physical channels or signals 1075 may be the same as, or different from, the periodicity 1060 of the physical channel or signal 1055. Accordingly, the one or more additional physical channels or signals 1055 may be transmitted or skipped during the non-active time 1065 according to a periodicity 1080 of the one or more additional physical channels or signals 1075.

As indicated above, FIG. 10B is provided as an example. Other examples may differ from what is described with respect to FIG. 10B.

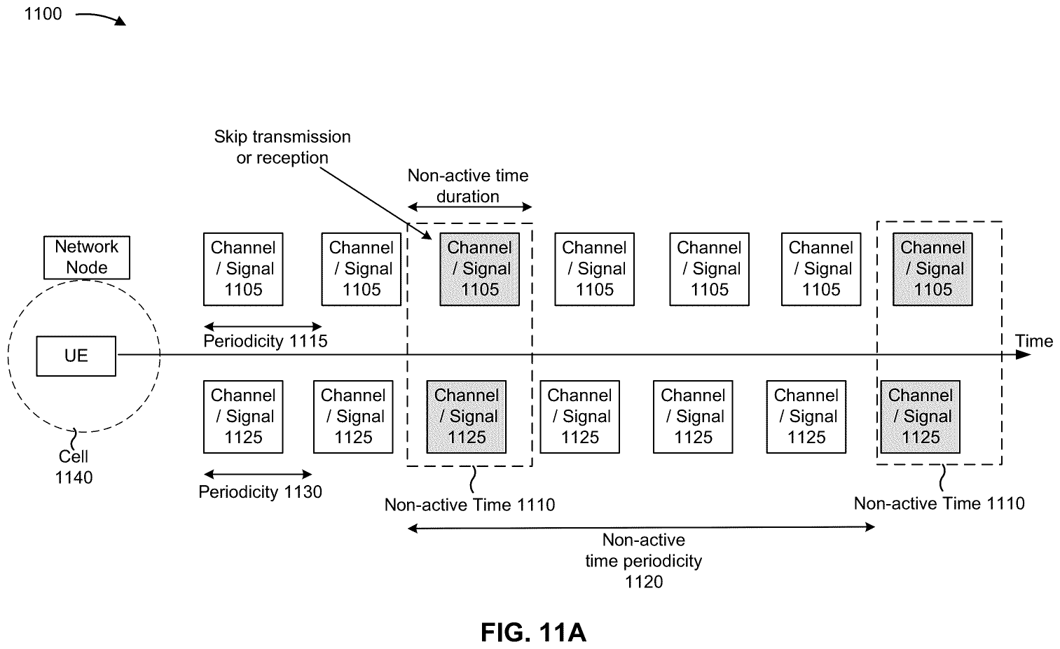

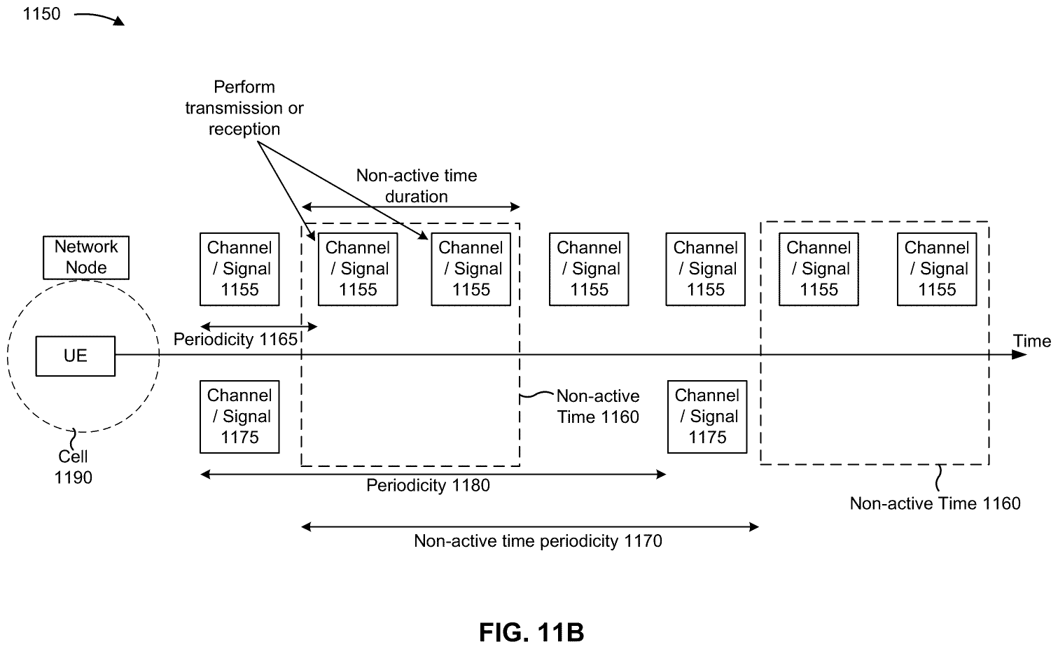

FIG. 11A is a diagram of an example 1100 associated with communication in a non-active time for a cell, in accordance with the present disclosure. Example 1100 includes the network node and the UE described in connection with FIG. 9. For example, the UE may be in a cell 1140 served by the network node. Example 1100 relates to performing or skipping transmission or reception of a physical channel or signal 1105 according to a duration of the non-active time 1110. For example, transmission or reception of the physical channel or signal 1105 may be skipped if the duration is less than a threshold. As an example, the physical channel or signal 1105 may be a TRS or a PRS.

In example 1100, the periodicity 1115 of the physical channel or signal 1105 may be 10 ms, the duration of the non-active time 1110 may be 10 ms, and the periodicity 1120 of the non-active time 1110 may be 40 ms. In this example, the duration of the non-active time 1110 may be less than the threshold, and accordingly, transmission or reception of the physical channel or signal 1105 may be skipped. As further shown, one or more additional physical channels or signals 1125 may be scheduled or configured for the UE, and a periodicity 1130 associated with the one or more additional physical channels or signals 1125 may be the same as, or different from, the periodicity 1115 of the physical channel or signal 1105. Accordingly, the one or more additional physical channels or signals 1105 may be transmitted or skipped during the non-active time 1110 according to the duration of the non-active time 1110.

As indicated above, FIG. 11A is provided as an example. Other examples may differ from what is described with respect to FIG. 11A.

FIG. 11B is a diagram of an example 1150 associated with communication in a non-active time for a cell, in accordance with the present disclosure. Example 1150 includes the network node and the UE described in connection with FIG. 9. For example, the UE may be in a cell 1190 served by the network node. Example 1150 relates to performing or skipping transmission or reception of a physical channel or signal 1155 according to a duration of the non-active time 1160. For example, transmission or reception of the physical channel or signal 1155 may be performed if the duration is greater than a threshold. As an example, the physical channel or signal 1155 may be a TRS or a PRS.

In example 1150, the periodicity 1165 of the physical channel or signal 1155 may be 10 ms, the duration of the non-active time 1160 may be 20 ms, and the periodicity 1170 of the non-active time 1160 may be 40 ms. In this example, the duration of the non-active time 1160 may be greater than the threshold, and accordingly, transmission or reception of the physical channel or signal 1155 may be performed. As further shown, multiple communications associated with the physical channel or signal 1155 may be scheduled or configured during the non-active time 1160. Here, the multiple communications may be dropped, may be communicated, or one or more of the multiple communications may be dropped and one or more of the multiple communications may be communicated (e.g., according to one or more rules). As further shown, one or more additional physical channels or signals 1175 may be scheduled or configured for the UE, and a periodicity 1180 associated with the one or more additional physical channels or signals 1175 may be the same as, or different from, the periodicity 1165 of the physical channel or signal 1155. Accordingly, the one or more additional physical channels or signals 1175 may be transmitted or skipped during the non-active time 1160 according to the duration of the non-active time 1160.

As indicated above, FIG. 11B is provided as an example. Other examples may differ from what is described with respect to FIG. 11B.

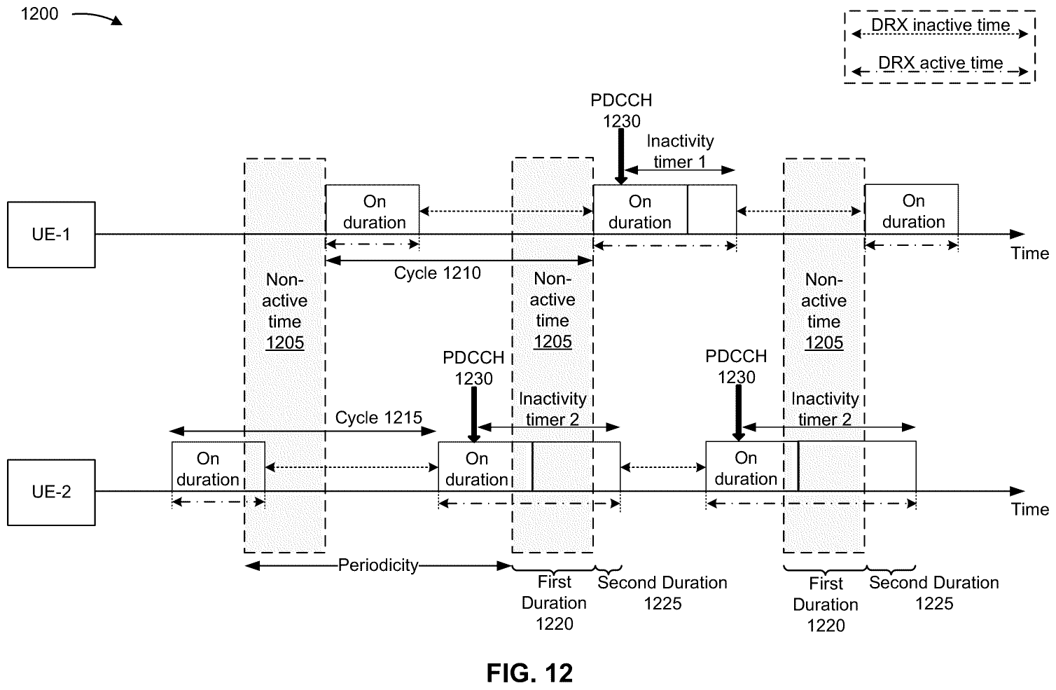

FIG. 12 is a diagram of an example 1200 associated with communication in a non-active time for a cell, in accordance with the present disclosure. Example 1200 includes the network node and multiple UEs (shown as UE-1 and UE-2) described in connection with FIG. 9. Example 1200 relates to monitoring of a PDCCH during a non-active time 1205 for a cell.

The UEs may be in a cell served by the network node. In some examples, the UEs may be in a connected state (e.g., an RRC connected state) with the network node. The UEs may operate in a DRX mode, as described herein. As shown, DRX cycles 1210, 1215 of the UEs may be non-aligned (e.g., the on durations of the UEs may not coincide in time).

As shown, a first duration 1220 of a DRX active time of the UE-2 may overlap in time with the non-active time 1205 and/or a second duration 1225 of the DRX active time of the UE-2 may be after the non-active time 1205. As described herein, during the first duration 1220 and/or the second duration 1225, the UE-2 may monitor a PDCCH 1230. Alternatively, during the first duration 1220 and/or the second duration 1225, the UE-2 may skip monitoring a PDCCH 1230 (e.g., the UE-2 does not monitor a PDCCH 1230). Alternatively, during the first duration 1220 the UE-2 may skip monitoring a PDCCH 1230 (e.g., the UE-2 does not monitor a PDCCH 1230), and during the second duration 1225 the UE-2 may monitor a PDCCH 1230. In some aspects, a configuration of the UE-2 may indicate whether the UE-2 is to monitor a PDCCH 1230 during the first duration 1220 and/or during the second duration 1225.

As indicated above, FIG. 12 is provided as an example. Other examples may differ from what is described with respect to FIG. 12.

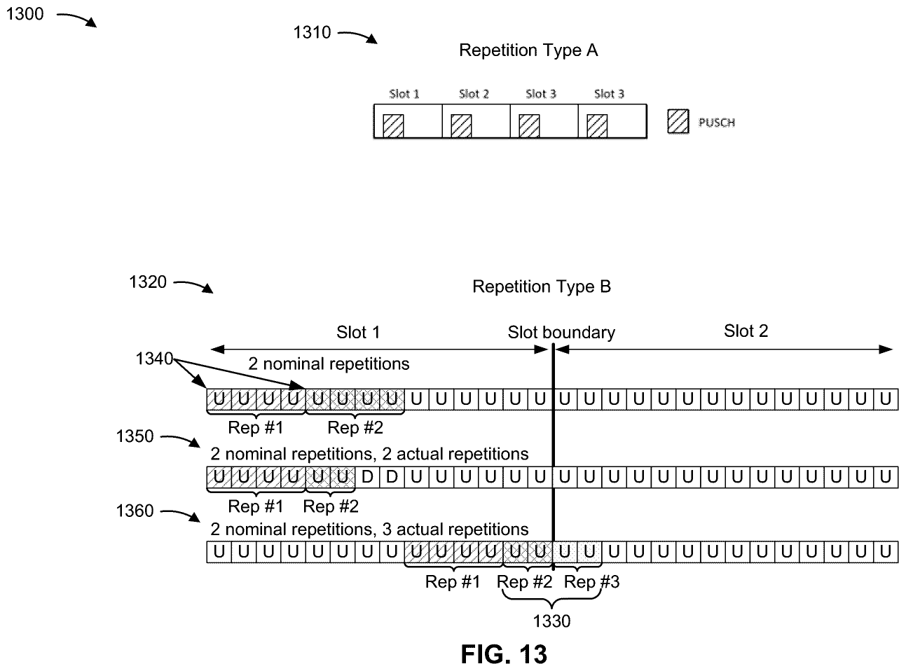

FIG. 13 is a diagram illustrating an example 1300 of uplink repetition, in accordance with the present disclosure. Although techniques are described herein in connection with PUSCH repetitions, these techniques can be applied to various types of uplink repetitions, such as an uplink data repetition, an uplink control repetition (e.g., a PUCCH repetition), or the like.

A repetition, such as an uplink repetition or a downlink repetition, may be used to improve reliability, such as for ultra reliable low latency communication (URLLC) or for UEs located in a geographic area with poor channel conditions (e.g., a cell edge). When repetitions are used, a transmitter repeats transmission of a communication multiple times. For example, a UE may transmit an initial uplink communication and may repeat transmission of (e.g., may retransmit) that uplink communication one or more times. When a UE is configured with repetitions, the UE may retransmit an initial transmission without first receiving feedback (e.g., an ACK or NACK) indicating whether the initial transmission was successfully received. In some aspects, ACK or NACK feedback may be disabled for repetitions, thereby reducing signaling overhead that would otherwise be used for ACK or NACK feedback.

In some aspects, a repeated transmission (sometimes referred to as a retransmission) may include the exact same encoded bits (e.g., information bits and parity bits) as the initial transmission and/or as another repeated transmission (e.g., where a same redundancy version is used across repetitions). Alternatively, a repeated transmission may include different encoded bits (e.g., a different combination of information bits and/or parity bits) than the initial transmission and/or another repeated transmission (e.g., where different redundancy versions are used across repetitions).

As used herein, the term “repetition” is used to refer to the initial communication and is also used to refer to a repeated transmission of the initial communication. For example, if the UE is configured to transmit four repetitions, then the UE may transmit an initial transmission and may transmit three repeated transmissions of that initial transmission. Thus, each transmission (regardless of whether the transmission is an initial transmission or a retransmission) is counted as a repetition. A repetition may be transmitted in a transmission occasion, which is sometimes referred to as a transmission instance.

As shown by reference number 1310, for a first uplink repetition type referred to as PUSCH Repetition Type A, uplink transmission occasions are not permitted to cross a slot boundary, and only one uplink transmission occasion is permitted per slot. Thus, if a UE is configured with PUSCH Repetition Type A, then the UE 120 cannot transmit a repetition in a set of symbols that occurs in more than one slot, and can only transmit the repetition if all symbols of the repetition occur in the same slot. Furthermore, if a UE is configured with PUSCH Repetition Type A, then the UE cannot transmit more than one repetition per slot. Thus, for PUSCH Repetition Type A, a transmission occasion corresponds to a slot. Furthermore, for PUSCH Repetition Type A, the time domain allocation for a repetition within a slot may be the same across all slots for which repetitions are scheduled. In other words, each repetition, associated with the same initial transmission, may start in the same starting symbol (e.g., having the same starting symbol index) in each slot in which a repetition is scheduled and may occupy the same number of symbols.

As shown by reference number 1320, for a second uplink repetition type referred to as PUSCH Repetition Type B, uplink transmission occasions are permitted to cross a slot boundary (as shown by reference number 1330, where a single nominal repetition crosses a slot boundary and is divided into two actual repetitions), and more than one uplink transmission occasion is permitted per slot (as shown by reference number 1340). Thus, if a UE is configured with PUSCH Repetition Type B, then the UE can transmit a repetition (e.g., a nominal repetition) in a set of symbols that occurs in more than one slot, and the UE can transmit the repetition even if all symbols of the repetition do not occur in the same slot. Furthermore, if a UE is configured with PUSCH Repetition Type B, then the UE can transmit more than one repetition per slot. Thus, for PUSCH Repetition Type B, a transmission occasion corresponds to a portion of a slot, such as a mini-slot. Furthermore, for PUSCH Repetition Type B, the time domain allocation for a repetition within a slot may be different for different repetitions. In other words, different repetitions, associated with the same initial transmission, may start in different starting symbols (e.g., having different starting symbol indexes).

In PUSCH Repetition Type B, the term “nominal repetition” refers to a potential PUSCH repetition as indicated by a network node. A nominal repetition signaled or scheduled by the network node may be truncated or divided into one or two “actual repetitions.” A nominal repetition consists of a set of consecutive symbols over which the UE is expected to transmit a PUSCH repetition. However, when this set of consecutive symbols crosses a slot boundary, contains semi-static downlink symbols, or encounters (e.g., is scheduled to occur within) an invalid symbol pattern, among other examples, then the UE is required to split the nominal repetition into one or two parts. Each of these parts is then referred to as an “actual repetition.”

For example, as shown by reference number 1350, a PUSCH transmission may include four symbols, and a network node may configure a UE (e.g., in an RRC message) to transmit two nominal repetitions of the PUSCH transmission. The two nominal repetitions may span a total of eight symbols and may each include four symbols. The two nominal repetitions are scheduled in the first eight symbols of a slot (shown as Slot 1). For example, the first nominal repetition may be scheduled in the first four symbols of a slot (the first, second, third, and fourth symbols), and the second nominal repetition may be scheduled in the next four symbols of the slot (the fifth, sixth, seventh, and eighth symbols). The first nominal repetition is actually transmitted in the first four symbols and is thus treated as a single actual repetition (shown as “Rep #1”). For the second nominal repetition, the UE actually transmits the first two symbols but cannot transmit the last two symbols because the last two symbols are downlink symbols. Thus, the UE drops the last two symbols, and the resulting actual repetition (shown as “Rep #2”) includes only the first two symbols.

As another example, as shown by reference number 1360, a PUSCH transmission may include four symbols, and a network node may configure a UE to transmit two nominal repetitions of the PUSCH transmission. The two nominal repetitions may each include four symbols, shown as the ninth, tenth, eleventh, and twelfth symbols of a first slot (Slot 1) for a first nominal repetition, and shown as the thirteenth and fourteenth symbols of the first slot plus the first and second symbols of a second slot (Slot 2) for a second nominal repetition. The first nominal repetition is transmitted in four consecutive symbols and is thus treated as a single actual repetition (shown as “Rep #1”). The second nominal repetition is transmitted in consecutive symbols that cross a slot boundary (e.g., that occur in more than one slot) and is thus divided into two actual repetitions, with a first actual repetition (shown as “Rep #2”) being transmitted in a first set of consecutive symbols in the first slot (the thirteenth and fourteenth symbols of Slot 1) and a second actual repetition (shown as “Rep #3) being transmitted in a second set of consecutive symbols in the second slot (the first and second symbols of Slot 2).

As indicated above, FIG. 13 is provided as an example. Other examples may differ from what is described with respect to FIG. 13.

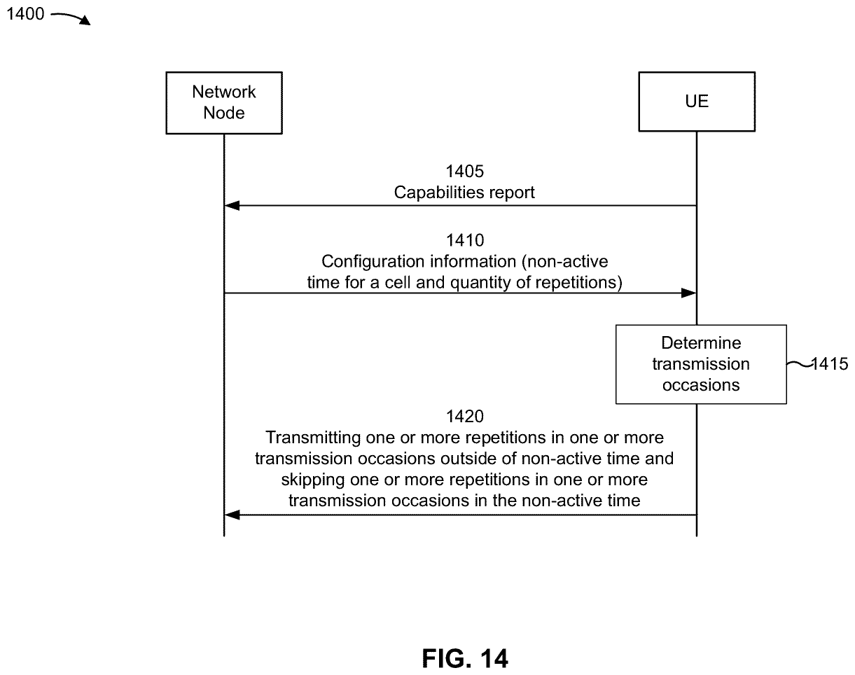

FIG. 14 is a diagram of an example 1400 associated with communication in a non-active time for a cell, in accordance with the present disclosure. As shown in FIG. 14, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 14.

As shown by reference number 1405, the UE may transmit, and the network node may receive, a capabilities report (e.g., UE capability information). In some aspects, the capabilities report may indicate UE support for cell DRX, as described herein.

As shown by reference number 1410, the network node may transmit, and the UE may receive, configuration information. In some aspects, the UE may receive the configuration information via one or more of RRC signaling, one or more MAC-CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples. The UE may receive the configuration information in one or more transmissions from the network node. In some aspects, the configuration information may include any of the indications or information described in connection with FIG. 9 for the configuration information.

In some aspects, the configuration information may indicate a configuration for uplink repetition. For example, the configuration information may indicate a quantity of repetitions (e.g., a total quantity of repetitions) for a physical uplink channel or signal. For example, the physical uplink channel or signal may be a PUCCH, a dynamic grant PUSCH (e.g., a PUSCH scheduled by dynamic grant), a configured grant PUSCH (e.g., a PUSCH scheduled by configured grant), and/or an SRS, among other examples. In some aspects, the configuration information may indicate a non-active time for cell DRX, as described herein. For example, the configuration information may indicate a starting time of the non-active time (e.g., a time offset), a duration of the non-active time, and/or a periodicity of the non-active time, among other examples. During the non-active time, the physical channel or signal may be dropped, as described herein.

The UE may configure itself based at least in part on the configuration information. In some aspects, the UE may be configured to perform one or more operations described herein based at least in part on the configuration information. In some aspects, the network node may transmit, and the UE may receive, an indication to activate (or deactivate) skipping during non-active time, as described herein.

As shown by reference number 1415, the UE may determine transmission occasions (e.g., time resources) for repetitions of the physical uplink channel or signal (e.g., in accordance with the configuration for uplink repetition). In some aspects, the UE may determine the transmission occasions in accordance with the non-active time. For example, if the cell DRX is activated (e.g., by RRC signaling), a determination of available slots for CG PUSCH repetitions may depend on a cell DRX configuration. The network node may also determine reception occasions for repetitions of the physical uplink channel or signal in a similar manner as described above.

As shown by reference number 1420, the UE may transmit, and the network node may receive, one or more repetitions of the physical channel or signal in one or more transmission occasions outside of the non-active time, and skip (e.g., not transmit) one or more repetitions of the physical uplink channel or signal in one or more transmission occasions in the non-active time. In some aspects, the one or more repetitions in the one or more transmission occasions in the non-active time (e.g., the repetition(s) that are skipped) may be counted toward the configured quantity of repetitions. For example, if the configured quantity of repetitions is four repetitions, then the UE may actually transmit less than four repetitions (e.g., if one repetition is dropped, then the UE may actually transmit three repetitions). In some aspects, the one or more repetitions in the one or more transmission occasions in the non-active time (e.g., the repetition(s) that are skipped) may be not counted (e.g., uncounted) toward the configured quantity of repetitions. For example, if the configured quantity of repetitions is four repetitions, then the UE may actually transmit four repetitions. As an example, if the cell DRX is activated (e.g., by layer 1 (L1) and/or layer 2 (L2) signaling), and when a CG PUSCH repetition is dropped in the non-active time of cell DRX, then the dropped CG PUSCH repetition may be counted in the configured number of repetitions, or the dropped CG PUSCH repetition may be not counted in the configured number of repetitions.

As indicated above, FIG. 14 is provided as an example. Other examples may differ from what is described with respect to FIG. 14.

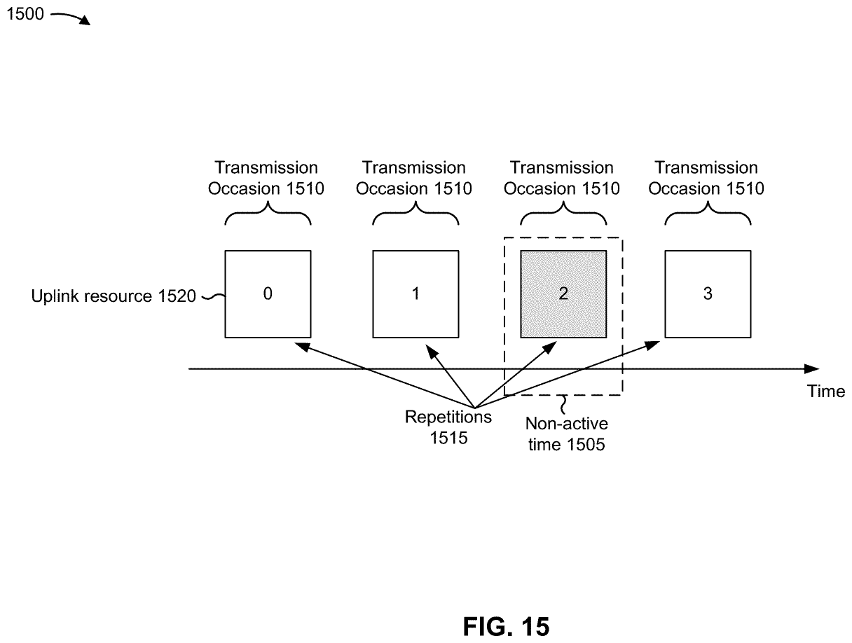

FIG. 15 is a diagram of an example 1500 associated with communication in a non-active time for a cell, in accordance with the present disclosure. Example 1500 includes the network node and the UE described in connection with FIG. 14. Example 1500 relates to skipping a repetition of a physical uplink channel or signal during a non-active time 1505 for cell DRX. The UE may be configured with a quantity of repetitions (e.g., four repetitions) for a physical uplink channel or signal. Transmission occasions 1510 for the repetitions 1515 of the physical uplink channel or signal may be in respective uplink resources 1520.

As shown, the UE may transmit a first repetition 1515 in a first transmission occasion 1510 and a second repetition 1515 in a second transmission occasion 1510 outside of (e.g., before) a non-active time 1505 for cell DRX. The UE may skip a third repetition 1515 in a third transmission occasion 1510 that is in the non-active time 1505. The UE may transmit a fourth repetition 1515 in a fourth transmission occasion 1510 that is outside of (e.g., after) the non-active time 1505. In some aspects, the third repetition 1515 that is skipped may be counted toward a total quantity of repetitions that the UE is to transmit. For example, if the total quantity of repetitions is four repetitions 1515, then the UE may actually transmit only three repetitions 1515. In some aspects, the third repetition 1515 that is skipped may be not counted toward the total quantity of repetitions that the UE is to transmit. For example, if the total quantity of repetitions is four repetitions 1515, then the UE may transmit four repetitions 1515.

As indicated above, FIG. 15 is provided as an example. Other examples may differ from what is described with respect to FIG. 15.

FIG. 16 is a diagram illustrating an example process 1600 performed, for example, by a UE, in accordance with the present disclosure. Example process 1600 is an example where the UE (e.g., UE 120) performs operations associated with communication in a non-active time for a cell.

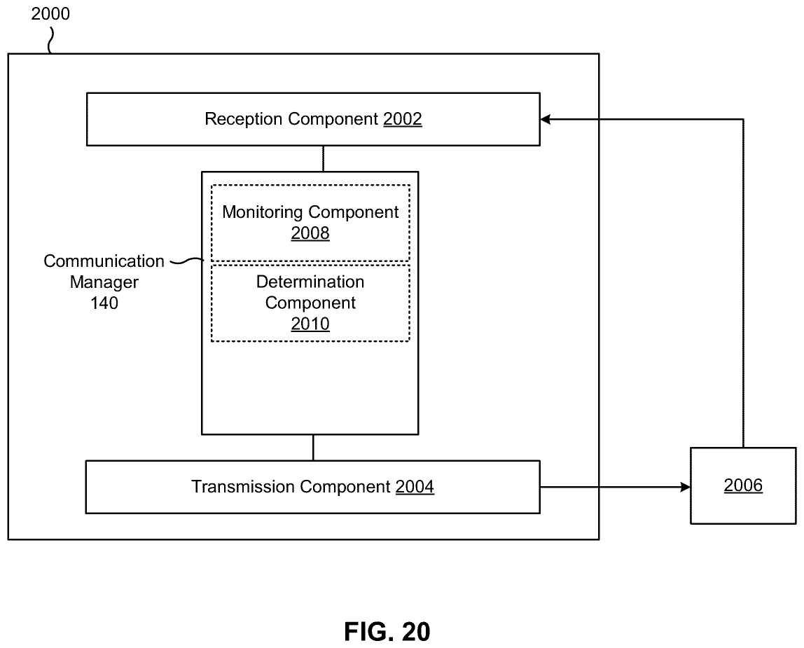

As shown in FIG. 16, in some aspects, process 1600 may include receiving configuration information indicating a non-active time for a cell (block 1610). For example, the UE (e.g., using communication manager 140 and/or reception component 2002, depicted in FIG. 20) may receive configuration information indicating a non-active time for a cell, as described above.

As further shown in FIG. 16, in some aspects, process 1600 may include performing or skipping transmission of one or more physical uplink channels or signals, or reception of one or more physical downlink channels or signals, during the non-active time according to one or more conditions (block 1620). For example, the UE (e.g., using communication manager 140, transmission component 2004, and/or reception component 2002, depicted in FIG. 20) may perform or skip transmission of one or more physical uplink channels or signals, or reception of one or more physical downlink channels or signals, during the non-active time according to one or more conditions, as described above.

Process 1600 may include additional aspects, such as any single aspect or any combination of aspects described below and/or in connection with one or more other processes described elsewhere herein.

In a first aspect, the non-active time is for cell DTX for the physical downlink channels or signals.

In a second aspect, alone or in combination with the first aspect, the non-active time is for cell DRX for the physical uplink channels or signals.

In a third aspect, alone or in combination with one or more of the first and second aspects, the one or more physical downlink channels or signals include a CSI-RS.

In a fourth aspect, alone or in combination with one or more of the first through third aspects, the one or more physical uplink channels or signals include an SRS or a scheduling request.

In a fifth aspect, alone or in combination with one or more of the first through fourth aspects, the one or more conditions relate to at least one of a duration of the non-active time or a periodicity of the non-active time.

In a sixth aspect, alone or in combination with one or more of the first through fifth aspects, the one or more conditions relate to a periodicity of the one or more physical downlink channels or signals or the one or more physical uplink channels or signals.

In a seventh aspect, alone or in combination with one or more of the first through sixth aspects, the one or more conditions relate to a quantity of repetitions of the one or more physical downlink channels or signals or the one or more physical uplink channels or signals.

In an eighth aspect, alone or in combination with one or more of the first through seventh aspects, the one or more conditions relate to a QoS requirement of the UE or of traffic associated with SPS, a configured grant, or a scheduling request.

In a ninth aspect, alone or in combination with one or more of the first through eighth aspects, the one or more conditions relate to a mobility state of the UE.

In a tenth aspect, alone or in combination with one or more of the first through ninth aspects, the one or more conditions relate to a signal quality at the UE.

In an eleventh aspect, alone or in combination with one or more of the first through tenth aspects, the one or more conditions are fixed.

In a twelfth aspect, alone or in combination with one or more of the first through eleventh aspects, the configuration information further indicates the one or more conditions.

In a thirteenth aspect, alone or in combination with one or more of the first through twelfth aspects, the configuration information further indicates at least one physical channel or signal to which the one or more conditions apply.

In a fourteenth aspect, alone or in combination with one or more of the first through thirteenth aspects, the one or more conditions are cell-specific.

In a fifteenth aspect, alone or in combination with one or more of the first through fourteenth aspects, the one or more conditions are common to multiple serving cells.

In a sixteenth aspect, alone or in combination with one or more of the first through fifteenth aspects, the configuration information further indicates one or more additional conditions associated with a neighboring cell.

In a seventeenth aspect, alone or in combination with one or more of the first through sixteenth aspects, process 1600 includes skipping monitoring a PDCCH during a first duration of a DRX active time of the UE that overlaps in time with the non-active time or during a second duration of the DRX active time that is after the non-active time.

In an eighteenth aspect, alone or in combination with one or more of the first through seventeenth aspects, process 1600 includes skipping monitoring a PDCCH during a first duration of a DRX active time of the UE that overlaps in time with the non-active time, and monitoring the PDCCH during a second duration of the DRX active time that is after the non-active time.

In a nineteenth aspect, alone or in combination with one or more of the first through eighteenth aspects, monitoring the PDCCH includes monitoring the PDCCH during the second duration responsive to the second duration satisfying a threshold.

In a twentieth aspect, alone or in combination with one or more of the first through nineteenth aspects, the configuration information further indicates whether a PDCCH is to be monitored during a first duration of a DRX active time of the UE that overlaps in time with the non-active time or during a second duration of the DRX active time that is after the non-active time.

In a twenty-first aspect, alone or in combination with one or more of the first through twentieth aspects, the configuration information further indicates at least one physical channel or signal that is to be dropped during the non-active time.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a UE, in accordance with the present disclosure. Example process 1700 is an example where the UE (e.g., UE 120) performs operations associated with communication in a non-active time for a cell.

As shown in FIG. 17, in some aspects, process 1700 may include receiving configuration information indicating a non-active time for cell DRX and indicating a quantity of repetitions for a physical uplink channel or signal (block 1710). For example, the UE (e.g., using communication manager 140 and/or reception component 2002, depicted in FIG. 20) may receive configuration information indicating a non-active time for cell DRX and indicating a quantity of repetitions for a physical uplink channel or signal, as described above. In some aspects, process 1700 may include determining transmission occasions for the physical uplink channel or signal (block 1712). For example, the UE (e.g., using communication manager 140 and/or determination component 2010, depicted in FIG. 20) may determine transmission occasions for the physical uplink channel or signal, as described above.

As further shown in FIG. 17, in some aspects, process 1700 may include transmitting one or more repetitions of the physical uplink channel or signal in one or more transmission occasions outside of the non-active time, and skipping one or more repetitions of the physical uplink channel or signal in one or more transmission occasions in the non-active time (block 1720). For example, the UE (e.g., using communication manager 140 and/or transmission component 2004, depicted in FIG. 20) may transmit one or more repetitions of the physical uplink channel or signal in one or more transmission occasions outside of the non-active time, and skip one or more repetitions of the physical uplink channel or signal in one or more transmission occasions in the non-active time, as described above.

Process 1700 may include additional aspects, such as any single aspect or any combination of aspects described below and/or in connection with one or more other processes described elsewhere herein.

In a first aspect, the one or more repetitions in the one or more transmission occasions in the non-active time that are skipped are to be counted toward the quantity of repetitions.

In a second aspect, alone or in combination with the first aspect, the one or more repetitions in the one or more transmission occasions in the non-active time that are skipped are to be not counted toward the quantity of repetitions.

In a third aspect, alone or in combination with one or more of the first and second aspects, the physical uplink channel or signal is a PUCCH, a PUSCH scheduled by dynamic grant, a PUSCH scheduled by configured grant, or an SRS.

In a fourth aspect, alone or in combination with one or more of the first through third aspects, process 1700 includes determining transmission occasions for the physical uplink channel or signal in accordance with the non-active time.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a network node, in accordance with the present disclosure. Example process 1800 is an example where the network node (e.g., network node 110) performs operations associated with communication in a non-active time for a cell.

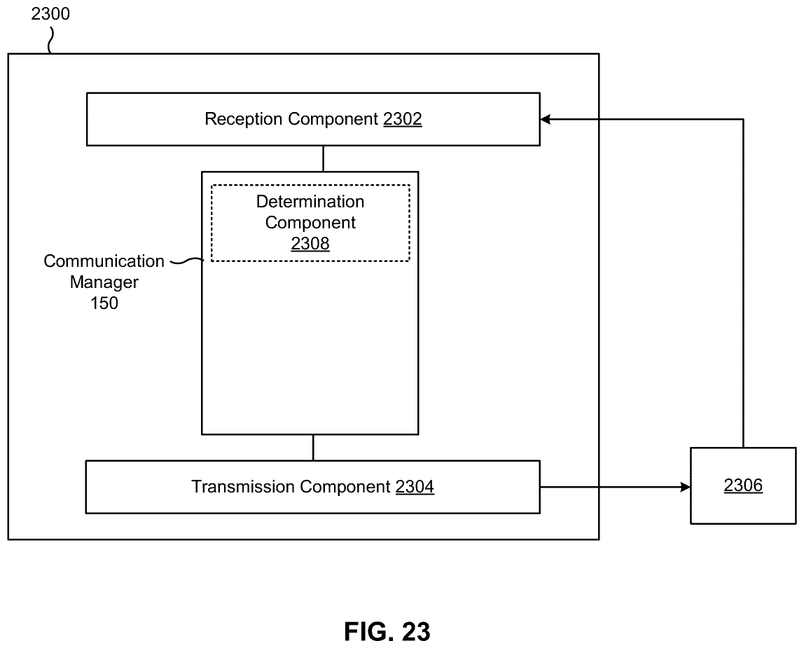

As shown in FIG. 18, in some aspects, process 1800 may include transmitting configuration information indicating a non-active time for a cell (block 1810). For example, the network node (e.g., using communication manager 150 and/or transmission component 2304, depicted in FIG. 23) may transmit configuration information indicating a non-active time for a cell, as described above.

As further shown in FIG. 18, in some aspects, process 1800 may include performing or skipping transmission of one or more physical downlink channels or signals, or reception of one or more physical uplink channels or signals, during the non-active time according to one or more conditions (block 1820). For example, the network node (e.g., using communication manager 150, transmission component 2304, and/or reception component 2302, depicted in FIG. 23) may perform or skip transmission of one or more physical downlink channels or signals, or reception of one or more physical uplink channels or signals, during the non-active time according to one or more conditions, as described above.

Process 1800 may include additional aspects, such as any single aspect or any combination of aspects described below and/or in connection with one or more other processes described elsewhere herein.

In a first aspect, the non-active time is for cell DTX for the physical downlink channels or signals.

In a second aspect, alone or in combination with the first aspect, the non-active time is for cell DRX for the physical uplink channels or signals.

In a third aspect, alone or in combination with one or more of the first and second aspects, the one or more physical downlink channels or signals include a CSI-RS.

In a fourth aspect, alone or in combination with one or more of the first through third aspects, the one or more physical uplink channels or signals include an SRS or a scheduling request.

In a fifth aspect, alone or in combination with one or more of the first through fourth aspects, the one or more conditions relate to at least one of a duration of the non-active time or a periodicity of the non-active time.

In a sixth aspect, alone or in combination with one or more of the first through fifth aspects, the one or more conditions relate to a periodicity of the one or more physical downlink channels or signals or the one or more physical uplink channels or signals.

In a seventh aspect, alone or in combination with one or more of the first through sixth aspects, the one or more conditions relate to a quantity of repetitions of the one or more physical downlink channels or signals or the one or more physical uplink channels or signals.

In an eighth aspect, alone or in combination with one or more of the first through seventh aspects, the one or more conditions relate to a QoS requirement of a UE or of traffic associated with SPS, a configured grant, or a scheduling request.

In a ninth aspect, alone or in combination with one or more of the first through eighth aspects, the one or more conditions relate to a mobility state of a UE.

In a tenth aspect, alone or in combination with one or more of the first through ninth aspects, the one or more conditions relate to a signal quality at a UE.

In an eleventh aspect, alone or in combination with one or more of the first through tenth aspects, the one or more conditions are fixed.

In a twelfth aspect, alone or in combination with one or more of the first through eleventh aspects, the configuration information further indicates the one or more conditions.

In a thirteenth aspect, alone or in combination with one or more of the first through twelfth aspects, the configuration information further indicates at least one physical channel or signal to which the one or more conditions apply.

In a fourteenth aspect, alone or in combination with one or more of the first through thirteenth aspects, the one or more conditions are cell-specific.

In a fifteenth aspect, alone or in combination with one or more of the first through fourteenth aspects, the one or more conditions are common to multiple serving cells.

In a sixteenth aspect, alone or in combination with one or more of the first through fifteenth aspects, the configuration information further indicates one or more additional conditions associated with a neighboring cell.

In a seventeenth aspect, alone or in combination with one or more of the first through sixteenth aspects, process 1800 includes skipping transmitting a PDCCH communication for a UE during a first duration of a DRX active time of the UE that overlaps in time with the non-active time or during a second duration of the DRX active time that is after the non-active time.

In an eighteenth aspect, alone or in combination with one or more of the first through seventeenth aspects, process 1800 includes skipping transmitting a PDCCH communication for a UE during a first duration of a DRX active time of the UE that overlaps in time with the non-active time, and transmitting the PDCCH communication during a second duration of the DRX active time that is after the non-active time.

In a nineteenth aspect, alone or in combination with one or more of the first through eighteenth aspects, transmitting the PDCCH communication includes transmitting the PDCCH communication during the second duration responsive to the second duration satisfying a threshold.

In a twentieth aspect, alone or in combination with one or more of the first through nineteenth aspects, the configuration information further indicates whether a PDCCH is to be monitored by a UE during a first duration of a DRX active time of the UE that overlaps in time with the non-active time or during a second duration of the DRX active time that is after the non-active time.

In a twenty-first aspect, alone or in combination with one or more of the first through twentieth aspects, the configuration information further indicates at least one physical channel or signal that is to be dropped during the non-active time.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a network node, in accordance with the present disclosure. Example process 1900 is an example where the network node (e.g., network node 110) performs operations associated with communication in a non-active time for a cell.

As shown in FIG. 19, in some aspects, process 1900 may include transmitting configuration information indicating a non-active time for cell DRX and indicating a quantity of repetitions for a physical uplink channel or signal (block 1910). For example, the network node (e.g., using communication manager 150 and/or transmission component 2304, depicted in FIG. 23) may transmit configuration information indicating a non-active time for cell DRX and indicating a quantity of repetitions for a physical uplink channel or signal, as described above. In some aspects, process 1900 may include determining occasions for the physical uplink channel or signal (block 1912). For example, the network node (e.g., using communication manager 150 and/or determination component 2308, depicted in FIG. 23) may determine occasions for the physical uplink channel or signal, as described above.

As further shown in FIG. 19, in some aspects, process 1900 may include receiving one or more repetitions of the physical uplink channel or signal in one or more occasions outside of the non-active time, and skipping one or more repetitions of the physical uplink channel or signal in one or more occasions in the non-active time (block 1920). For example, the network node (e.g., using communication manager 150 and/or reception component 2302, depicted in FIG. 23) may receive one or more repetitions of the physical uplink channel or signal in one or more occasions outside of the non-active time, and skip one or more repetitions of the physical uplink channel or signal in one or more occasions in the non-active time, as described above.

Process 1900 may include additional aspects, such as any single aspect or any combination of aspects described below and/or in connection with one or more other processes described elsewhere herein.

In a first aspect, the one or more repetitions in the one or more occasions in the non-active time that are skipped are to be counted toward the quantity of repetitions.

In a second aspect, alone or in combination with the first aspect, the one or more repetitions in the one or more occasions in the non-active time that are skipped are to be not counted toward the quantity of repetitions.

In a third aspect, alone or in combination with one or more of the first and second aspects, the physical uplink channel or signal is a PUCCH, a PUSCH scheduled by dynamic grant, a PUSCH scheduled by configured grant, or an SRS.

In a fourth aspect, alone or in combination with one or more of the first through third aspects, process 1900 includes determining occasions for the physical uplink channel or signal in accordance with the non-active time.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram of an example apparatus 2000 for wireless communication, in accordance with the present disclosure. The apparatus 2000 may be a UE, or a UE may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE, a base station, or another wireless communication device) using the reception component 2002 and the transmission component 2004. As further shown, the apparatus 2000 may include the communication manager 140. The communication manager 140 may include one or more of a monitoring component 2008 or a determination component 2010, among other examples.

In some aspects, the apparatus 2000 may be configured to perform one or more operations described herein in connection with FIGS. 9-15. Additionally, or alternatively, the apparatus 2000 may be configured to perform one or more processes described herein, such as process 1600 of FIG. 16, process 1700 of FIG. 17, process 2600 of FIG. 26, process 2800 of FIG. 28, process 3000 of FIG. 30, process 3100 of FIG. 31, or a combination thereof. In some aspects, the apparatus 2000 and/or one or more components shown in FIG. 20 may include one or more components of the UE described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the UE described in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a modulator, a transmit MIMO processor, a transmit processor, a controller/processor, a memory, or a combination thereof, of the UE described in connection with FIG. 2. In some aspects, the transmission component 2004 may be co-located with the reception component 2002 in a transceiver.

The reception component 2002 may receive configuration information indicating a non-active time for a cell. The reception component 2002 and/or the transmission component 2004 may perform or skip transmission of one or more physical uplink channels or signals, or reception of one or more physical downlink channels or signals, during the non-active time according to one or more conditions.

The monitoring component 2008 may skip monitoring a PDCCH during a duration of a DRX active time of the UE that overlaps in time with the non-active time. The monitoring component 2008 may skip monitoring a PDCCH during a first duration of a DRX active time of the UE that overlaps in time with the non-active time or during a second duration of the DRX active time that is after the non-active time. The monitoring component 2008 may skip monitoring a PDCCH during a first duration of a DRX active time of the UE that overlaps in time with the non-active time, and monitor the PDCCH during a second duration of the DRX active time that is after the non-active time.

The reception component 2002 may receive configuration information indicating a non-active time for cell DRX and indicating a quantity of repetitions for a physical uplink channel or signal. The transmission component 2004 may transmit one or more repetitions of the physical uplink channel or signal in one or more transmission occasions outside of the non-active time. The transmission component 2004 may drop transmission of one or more repetitions of the physical uplink channel or signal in one or more transmission occasions in the non-active time. The determination component 2010 may determine transmission occasions for the physical uplink channel or signal (e.g., in accordance with the non-active time).

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

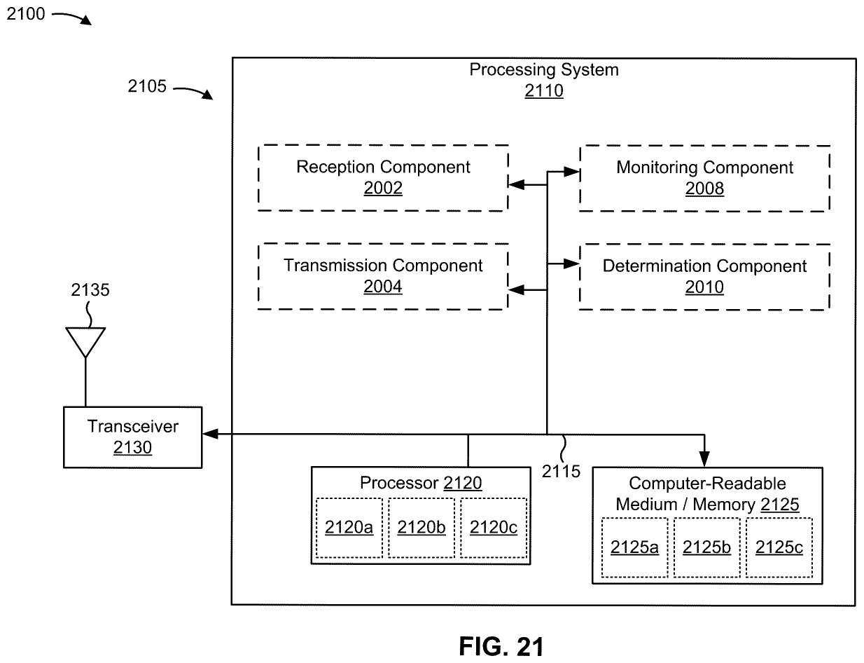

FIG. 21 is a diagram illustrating an example 2100 of a hardware implementation for an apparatus 2105 employing a processing system 2110, in accordance with the present disclosure. The apparatus 2105 may be a UE.

The processing system 2110 may be implemented with a bus architecture, represented generally by the bus 2115. The bus 2115 may include any number of interconnecting buses and bridges depending on the specific application of the processing system 2110 and the overall design constraints. The bus 2115 links together various circuits including one or more processors and/or hardware components, represented by the processor (or processing circuitry) 2120, the illustrated components, and the computer-readable medium/memory (or memory circuitry) 2125. The processor 2120 may include multiple processors, such as processor 2120a, processor 2120b, and processor 2120c. The memory 2125 may include multiple memories, such as memory 2125a, memory 2125b, and memory 2125c. The bus 2115 may also link various other circuits, such as timing sources, peripherals, voltage regulators, and/or power management circuits.

The processing system 2110 may be coupled to a transceiver 2130. The transceiver 2130 is coupled to one or more antennas 2135. The transceiver 2130 provides a means for communicating with various other apparatuses over a transmission medium. The transceiver 2130 receives a signal from the one or more antennas 2135, extracts information from the received signal, and provides the extracted information to the processing system 2110, specifically the reception component 2002. In addition, the transceiver 2130 receives information from the processing system 2110, specifically the transmission component 2004, and generates a signal to be applied to the one or more antennas 2135 based at least in part on the received information.

The processing system 2110 includes a processor 2120 coupled to a computer-readable medium/memory 2125. The processor 2120 is responsible for general processing, including the execution of software stored on the computer-readable medium/memory 2125. The software, when executed by the processor 2120, causes the processing system 2110 to perform the various functions described herein for any particular apparatus. The computer-readable medium/memory 2125 may also be used for storing data that is manipulated by the processor 2120 when executing software. The processing system further includes at least one of the illustrated components. The components may be software modules running in the processor 2120, resident/stored in the computer readable medium/memory 2125, one or more hardware modules coupled to the processor 2120, or some combination thereof.

In some aspects, the processing system 2110 may be a component of the UE 120 and may include the memory 282 and/or at least one of the TX MIMO processor 266, the receive processor 258, and/or the controller/processor 280. In some aspects, the apparatus 2105 for wireless communication includes means for receiving configuration information indicating a non-active time for a cell; means for skipping monitoring a PDCCH during a duration of a DRX active time of a UE that overlaps in time with the non-active time; means for performing or skipping transmission of one or more physical uplink channels or signals, or reception of one or more physical downlink channels or signals, during the non-active time according to one or more conditions; means for receiving configuration information indicating a non-active time for cell DRX and indicating a quantity of repetitions for a physical uplink channel or signal; means for transmitting one or more repetitions of the physical uplink channel or signal in one or more transmission occasions outside of the non-active time; and/or means for dropping transmission of one or more repetitions of the physical uplink channel or signal in one or more transmission occasions in the non-active time. The aforementioned means may be one or more of the aforementioned components of the apparatus 2000 and/or the processing system 2110 of the apparatus 2105 configured to perform the functions recited by the aforementioned means. As described elsewhere herein, the processing system 2110 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 21 is provided as an example. Other examples may differ from what is described in connection with FIG. 21.

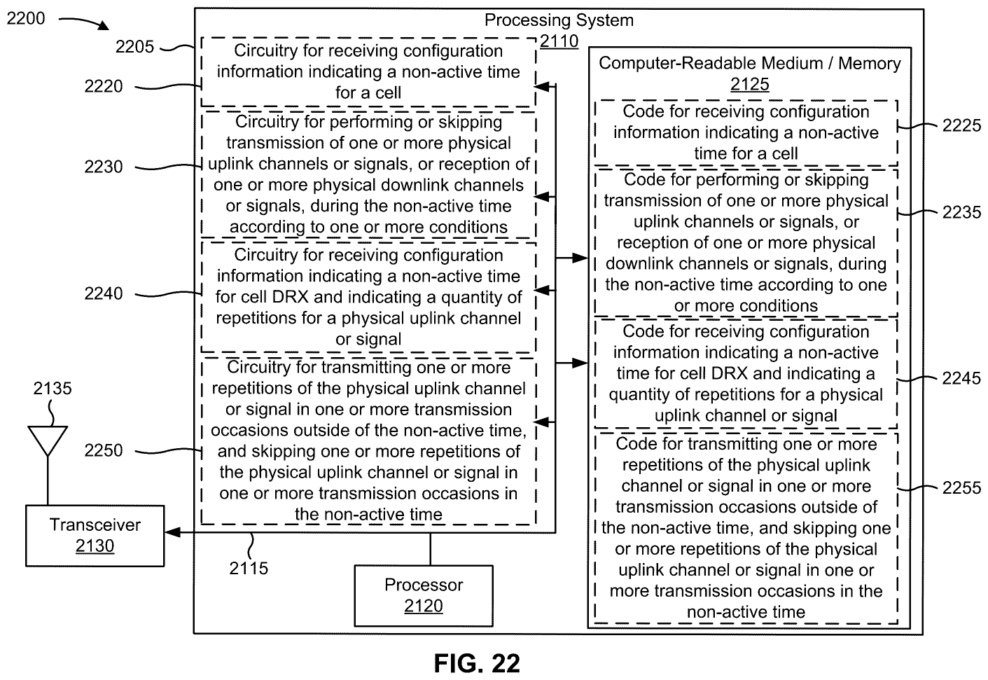

FIG. 22 is a diagram illustrating an example 2200 of an implementation of code and circuitry for an apparatus 2205, in accordance with the present disclosure. The circuitry may include processing circuitry and memory circuitry. The apparatus 2205 may be a UE, or a UE may include the apparatus 2205.

As shown in FIG. 22, the apparatus 2205 may include circuitry for receiving configuration information indicating a non-active time for a cell (circuitry 2220). For example, the circuitry 2220 may enable the apparatus 2205 to receive configuration information indicating a non-active time for a cell.

As shown in FIG. 22, the apparatus 2205 may include, stored in computer-readable medium 2125, code for receiving configuration information indicating a non-active time for a cell (code 2225). For example, the code 2225, when executed by processor 2120, may cause processor 2120 to cause transceiver 2130 to receive configuration information indicating a non-active time for a cell.

As shown in FIG. 22, the apparatus 2205 may include circuitry for performing or skipping transmission of one or more physical uplink channels or signals, or reception of one or more physical downlink channels or signals, during the non-active time according to one or more conditions (circuitry 2230). For example, the circuitry 2230 may enable the apparatus 2205 to perform or skip transmission of one or more physical uplink channels or signals, or reception of one or more physical downlink channels or signals, during the non-active time according to one or more conditions.

As shown in FIG. 22, the apparatus 2205 may include, stored in computer-readable medium 2125, code for performing or skipping transmission of one or more physical uplink channels or signals, or reception of one or more physical downlink channels or signals, during the non-active time according to one or more conditions (code 2235). For example, the code 2235, when executed by processor 2120, may cause processor 2120 to cause transceiver 2130 to perform or skip transmission of one or more physical uplink channels or signals, or reception of one or more physical downlink channels or signals, during the non-active time according to one or more conditions.

As shown in FIG. 22, the apparatus 2205 may include circuitry for receiving configuration information indicating a non-active time for cell DRX and indicating a quantity of repetitions for a physical uplink channel or signal (circuitry 2240). For example, the circuitry 2240 may enable the apparatus 2205 to receive configuration information indicating a non-active time for cell DRX and indicating a quantity of repetitions for a physical uplink channel or signal.

As shown in FIG. 22, the apparatus 2205 may include, stored in computer-readable medium 2125, code for receiving configuration information indicating a non-active time for cell DRX and indicating a quantity of repetitions for a physical uplink channel or signal (code 2245). For example, the code 2245, when executed by processor 2120, may cause processor 2120 to cause transceiver 2130 to receive configuration information indicating a non-active time for cell DRX and indicating a quantity of repetitions for a physical uplink channel or signal.

As shown in FIG. 22, the apparatus 2205 may include circuitry for transmitting one or more repetitions of the physical uplink channel or signal in one or more transmission occasions outside of the non-active time, and skipping one or more repetitions of the physical uplink channel or signal in one or more transmission occasions in the non-active time (circuitry 2250). For example, the circuitry 2250 may enable the apparatus 2205 to transmit one or more repetitions of the physical uplink channel or signal in one or more transmission occasions outside of the non-active time, and skip one or more repetitions of the physical uplink channel or signal in one or more transmission occasions in the non-active time.

As shown in FIG. 22, the apparatus 2205 may include, stored in computer-readable medium 2125, code for transmitting one or more repetitions of the physical uplink channel or signal in one or more transmission occasions outside of the non-active time, and skipping one or more repetitions of the physical uplink channel or signal in one or more transmission occasions in the non-active time (code 2255). For example, the code 2255, when executed by processor 2120, may cause processor 2120 to cause transceiver 2130 to transmit one or more repetitions of the physical uplink channel or signal in one or more transmission occasions outside of the non-active time, and skip one or more repetitions of the physical uplink channel or signal in one or more transmission occasions in the non-active time.

FIG. 22 is provided as an example. Other examples may differ from what is described in connection with FIG. 22.

FIG. 23 is a diagram of an example apparatus 2300 for wireless communication, in accordance with the present disclosure. The apparatus 2300 may be a network node, or a network node may include the apparatus 2300. In some aspects, the apparatus 2300 includes a reception component 2302 and a transmission component 2304, which may be in communication with one another (for example, via one or more buses and/or one or more other components). As shown, the apparatus 2300 may communicate with another apparatus 2306 (such as a UE, a base station, or another wireless communication device) using the reception component 2302 and the transmission component 2304. As further shown, the apparatus 2300 may include the communication manager 150. The communication manager 150 may include a determination component 2308, among other examples.

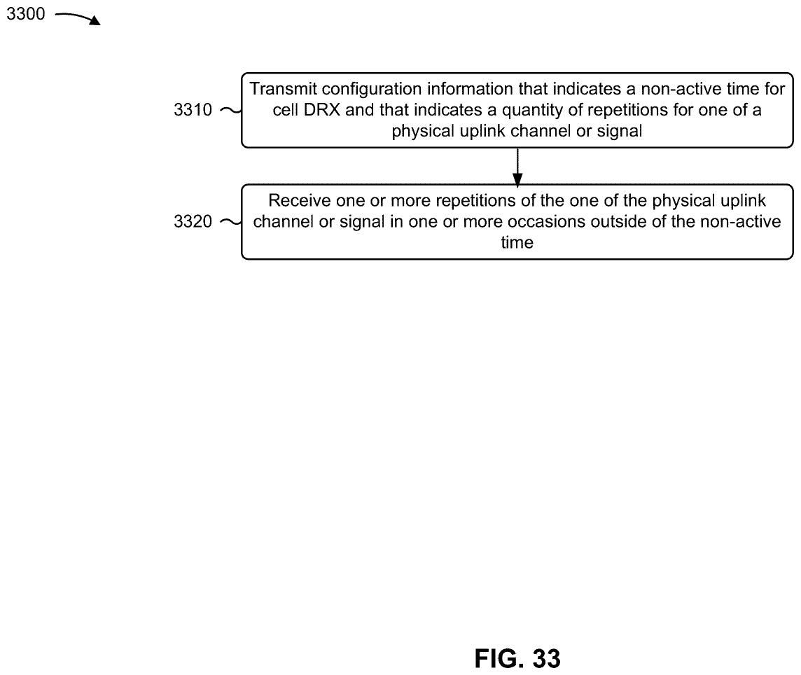

In some aspects, the apparatus 2300 may be configured to perform one or more operations described herein in connection with FIGS. 9-15. Additionally, or alternatively, the apparatus 2300 may be configured to perform one or more processes described herein, such as process 1800 of FIG. 18, process 1900 of FIG. 19, process 2700 of FIG. 27, process 2900 of FIG. 29, process 3200 of FIG. 32, process 3300 of FIG. 33, or a combination thereof. In some aspects, the apparatus 2300 and/or one or more components shown in FIG. 23 may include one or more components of the network node described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2306. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the network node described in connection with FIG. 2.

The transmission component 2304 may transmit communications, such as reference signals, control information, data communications, or a combination thereof, to the apparatus 2306. In some aspects, one or more other components of the apparatus 2300 may generate communications and may provide the generated communications to the transmission component 2304 for transmission to the apparatus 2306. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2306. In some aspects, the transmission component 2304 may include one or more antennas, a modem, a modulator, a transmit MIMO processor, a transmit processor, a controller/processor, a memory, or a combination thereof, of the network node described in connection with FIG. 2. In some aspects, the transmission component 2304 may be co-located with the reception component 2302 in a transceiver.

The transmission component 2304 may transmit configuration information indicating a non-active time for a cell. The reception component 2302 and/or the transmission component 2304 may perform or skip transmission of one or more physical downlink channels or signals, or reception of one or more physical uplink channels or signals, during the non-active time according to one or more conditions.

The transmission component 2304 may skip transmitting a PDCCH communication for a UE during a duration of a DRX active time of the UE that overlaps in time with the non-active time. The transmission component 2304 may skip transmitting a PDCCH communication for a UE during a first duration of a DRX active time of the UE that overlaps in time with the non-active time or during a second duration of the DRX active time that is after the non-active time. The transmission component 2304 may skip transmitting a PDCCH communication for a UE during a first duration of a DRX active time of the UE that overlaps in time with the non-active time, and transmit the PDCCH communication during a second duration of the DRX active time that is after the non-active time.

The transmission component 2304 may transmit configuration information indicating a non-active time for cell DRX and indicating a quantity of repetitions for a physical uplink channel or signal. The reception component 2302 may receive one or more repetitions of the physical uplink channel or signal in one or more occasions outside of the non-active time. The reception component 2302 may drop reception of one or more repetitions of the physical uplink channel or signal in one or more occasions in the non-active time. The determination component 2308 may determine occasions for the physical uplink channel or signal (e.g., in accordance with the non-active time).

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

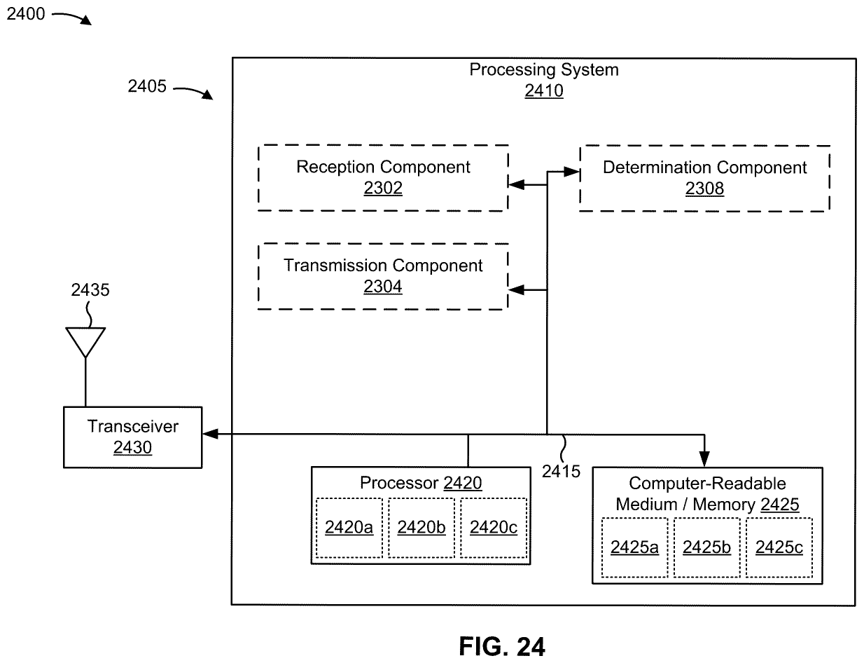

FIG. 24 is a diagram illustrating an example 2400 of a hardware implementation for an apparatus 2405 employing a processing system 2410, in accordance with the present disclosure. The apparatus 2405 may be a network node.

The processing system 2410 may be implemented with a bus architecture, represented generally by the bus 2415. The bus 2415 may include any number of interconnecting buses and bridges depending on the specific application of the processing system 2410 and the overall design constraints. The bus 2415 links together various circuits including one or more processors and/or hardware components, represented by the processor (or processing circuitry) 2420, the illustrated components, and the computer-readable medium/memory (or memory circuitry) 2425. The processor 2420 may include multiple processors, such as processor 2420a, processor 2420b, and processor 2420c. The memory 2425 may include multiple memories, such as memory 2425a, memory 2425b, and memory 2425c. The bus 2415 may also link various other circuits, such as timing sources, peripherals, voltage regulators, and/or power management circuits.

The processing system 2410 may be coupled to a transceiver 2430. The transceiver 2430 is coupled to one or more antennas 2435. The transceiver 2430 provides a means for communicating with various other apparatuses over a transmission medium. The transceiver 2430 receives a signal from the one or more antennas 2435, extracts information from the received signal, and provides the extracted information to the processing system 2410, specifically the reception component 2302. In addition, the transceiver 2430 receives information from the processing system 2410, specifically the transmission component 2304, and generates a signal to be applied to the one or more antennas 2435 based at least in part on the received information.

The processing system 2410 includes a processor 2420 coupled to a computer-readable medium/memory 2425. The processor 2420 is responsible for general processing, including the execution of software stored on the computer-readable medium/memory 2425. The software, when executed by the processor 2420, causes the processing system 2410 to perform the various functions described herein for any particular apparatus. The computer-readable medium/memory 2425 may also be used for storing data that is manipulated by the processor 2420 when executing software. The processing system further includes at least one of the illustrated components. The components may be software modules running in the processor 2420, resident/stored in the computer readable medium/memory 2425, one or more hardware modules coupled to the processor 2420, or some combination thereof.

In some aspects, the processing system 2410 may be a component of the network node 110 and may include the memory 242 and/or at least one of the TX MIMO processor 230, the receive processor 238, and/or the controller/processor 240. In some aspects, the apparatus 2405 for wireless communication includes means for transmitting configuration information indicating a non-active time for a cell; means for skipping transmitting a PDCCH communication for a UE during a duration of a DRX active time of the UE that overlaps in time with the non-active time; means for performing or skipping transmission of one or more physical downlink channels or signals, or reception of one or more physical uplink channels or signals, during the non-active time according to one or more conditions; means for transmitting configuration information indicating a non-active time for cell DRX and indicating a quantity of repetitions for a physical uplink channel or signal; means for receiving one or more repetitions of the physical uplink channel or signal in one or more occasions outside of the non-active time; and/or means for dropping reception of one or more repetitions of the physical uplink channel or signal in one or more occasions in the non-active time. The aforementioned means may be one or more of the aforementioned components of the apparatus 2300 and/or the processing system 2410 of the apparatus 2405 configured to perform the functions recited by the aforementioned means. As described elsewhere herein, the processing system 2410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 24 is provided as an example. Other examples may differ from what is described in connection with FIG. 24.

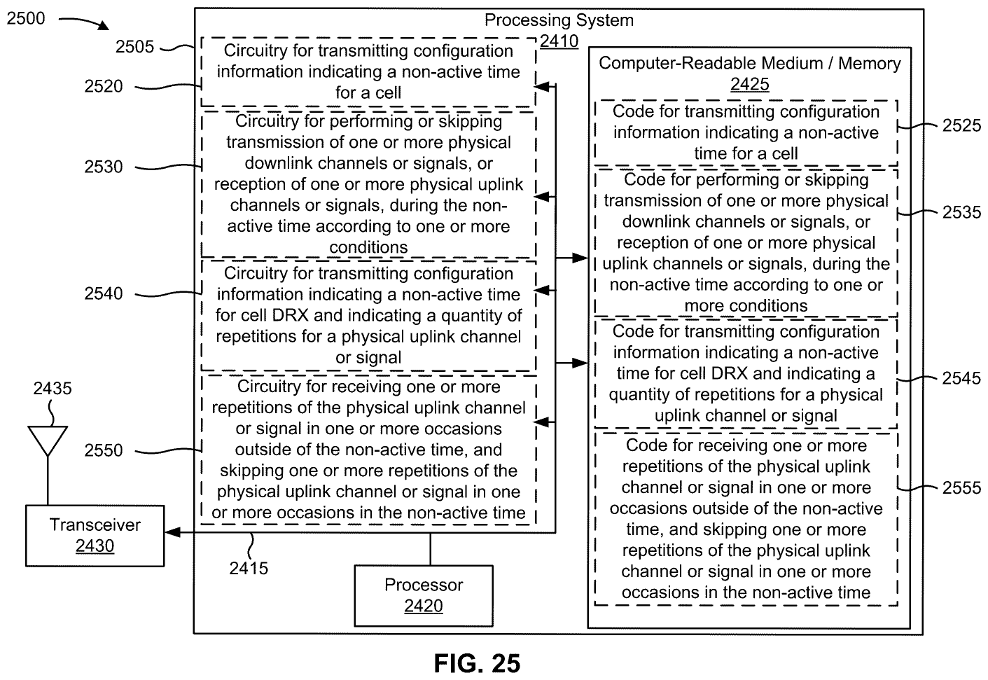

FIG. 25 is a diagram illustrating an example 2500 of an implementation of code and circuitry for an apparatus 2505, in accordance with the present disclosure. The circuitry may include processing circuitry and memory circuitry. The apparatus 2505 may be a network node, or a network node may include the apparatus 2505.

As shown in FIG. 25, the apparatus 2505 may include circuitry for transmitting configuration information indicating a non-active time for a cell (circuitry 2520). For example, the circuitry 2520 may enable the apparatus 2505 to transmit configuration information indicating a non-active time for a cell.

As shown in FIG. 25, the apparatus 2505 may include, stored in computer-readable medium 2425, code for transmitting configuration information indicating a non-active time for a cell (code 2525). For example, the code 2525, when executed by processor 2420, may cause processor 2420 to cause transceiver 2430 to transmit configuration information indicating a non-active time for a cell.

As shown in FIG. 25, the apparatus 2505 may include circuitry for performing or skipping transmission of one or more physical downlink channels or signals, or reception of one or more physical uplink channels or signals, during the non-active time according to one or more conditions (circuitry 2530). For example, the circuitry 2530 may enable the apparatus 2505 to perform or skip transmission of one or more physical downlink channels or signals, or reception of one or more physical uplink channels or signals, during the non-active time according to one or more conditions.

As shown in FIG. 25, the apparatus 2505 may include, stored in computer-readable medium 2425, code for performing or skipping transmission of one or more physical downlink channels or signals, or reception of one or more physical uplink channels or signals, during the non-active time according to one or more conditions (code 2535). For example, the code 2535, when executed by processor 2420, may cause processor 2420 to cause transceiver 2430 to perform or skip transmission of one or more physical downlink channels or signals, or reception of one or more physical uplink channels or signals, during the non-active time according to one or more conditions.

As shown in FIG. 25, the apparatus 2505 may include circuitry for transmitting configuration information indicating a non-active time for cell DRX and indicating a quantity of repetitions for a physical uplink channel or signal (circuitry 2540). For example, the circuitry 2540 may enable the apparatus 2505 to transmit configuration information indicating a non-active time for cell DRX and indicating a quantity of repetitions for a physical uplink channel or signal.

As shown in FIG. 25, the apparatus 2505 may include, stored in computer-readable medium 2425, code for transmitting configuration information indicating a non-active time for cell DRX and indicating a quantity of repetitions for a physical uplink channel or signal (code 2545). For example, the code 2545, when executed by processor 2420, may cause processor 2420 to cause transceiver 2430 to transmit configuration information indicating a non-active time for cell DRX and indicating a quantity of repetitions for a physical uplink channel or signal.

As shown in FIG. 25, the apparatus 2505 may include circuitry for receiving one or more repetitions of the physical uplink channel or signal in one or more occasions outside of the non-active time, and skipping one or more repetitions of the physical uplink channel or signal in one or more occasions in the non-active time (circuitry 2550). For example, the circuitry 2550 may enable the apparatus 2505 to receive one or more repetitions of the physical uplink channel or signal in one or more occasions outside of the non-active time, and skip one or more repetitions of the physical uplink channel or signal in one or more occasions in the non-active time.

As shown in FIG. 25, the apparatus 2505 may include, stored in computer-readable medium 2425, code for receiving one or more repetitions of the physical uplink channel or signal in one or more occasions outside of the non-active time, and skipping one or more repetitions of the physical uplink channel or signal in one or more occasions in the non-active time (code 2555). For example, the code 2555, when executed by processor 2420, may cause processor 2420 to cause transceiver 2430 to receive one or more repetitions of the physical uplink channel or signal in one or more occasions outside of the non-active time, and skip one or more repetitions of the physical uplink channel or signal in one or more occasions in the non-active time.

FIG. 25 is provided as an example. Other examples may differ from what is described in connection with FIG. 25.

FIG. 26 is a diagram illustrating an example process 2600 performed, for example, by a UE, in accordance with the present disclosure. Example process 2600 is an example where the UE (e.g., UE 120) performs operations associated with communication in a non-active time for a cell.

As shown in FIG. 26, in some aspects, process 2600 may include receiving configuration information that indicates a non-active time for a cell, where the non-active time is for cell DTX (block 2610). For example, the UE (e.g., using communication manager 140 and/or reception component 2002, depicted in FIG. 20) may receive configuration information that indicates a non-active time for a cell, as described above.

As further shown in FIG. 26, in some aspects, process 2600 may include skipping monitoring a PDCCH during a duration of a DRX active time that overlaps in time with the non-active time (block 2620). For example, the UE (e.g., using communication manager 140, depicted in FIG. 20) may skip monitoring a PDCCH during a duration of a DRX active time of the UE that overlaps in time with the non-active time, as described above.

Process 2600 may include additional aspects, such as any single aspect or any combination of aspects described below and/or in connection with one or more other processes described elsewhere herein.

In a first aspect, process 2600 includes performing or skipping transmission of one or more physical uplink channels or signals, or reception of one or more physical downlink channels or signals, during the non-active time according to one or more conditions

In a second aspect, alone or in combination with the first aspect, the non-active time is for cell DRX or cell DTX for the physical uplink channels or signals.

In a third aspect, alone or in combination with one or more of the first and second aspects, the one or more physical downlink channels or signals include a CSI-RS.

In a fourth aspect, alone or in combination with one or more of the first through third aspects, the one or more physical uplink channels or signals include an SRS or a scheduling request.

In a fifth aspect, alone or in combination with one or more of the first through fourth aspects, the one or more conditions relate to at least one of a duration of the non-active time or a periodicity of the non-active time.

In a sixth aspect, alone or in combination with one or more of the first through fifth aspects, the one or more conditions relate to a periodicity of the one or more physical downlink channels or signals or the one or more physical uplink channels or signals.

In a seventh aspect, alone or in combination with one or more of the first through sixth aspects, the one or more conditions relate to a quantity of repetitions of the one or more physical downlink channels or signals or the one or more physical uplink channels or signals.

In an eighth aspect, alone or in combination with one or more of the first through seventh aspects, the one or more conditions relate to a QoS requirement of the UE or of traffic associated with SPS, a configured grant, or a scheduling request.

In a ninth aspect, alone or in combination with one or more of the first through eighth aspects, the one or more conditions relate to a mobility state of the UE.

In a tenth aspect, alone or in combination with one or more of the first through ninth aspects, the one or more conditions relate to a signal quality at the UE.

In an eleventh aspect, alone or in combination with one or more of the first through tenth aspects, the one or more conditions are fixed.

In a twelfth aspect, alone or in combination with one or more of the first through eleventh aspects, the configuration information further indicates the one or more conditions.

In a thirteenth aspect, alone or in combination with one or more of the first through twelfth aspects, the configuration information further indicates at least one physical channel or signal to which the one or more conditions apply.

In a fourteenth aspect, alone or in combination with one or more of the first through thirteenth aspects, the one or more conditions are cell-specific.

In a fifteenth aspect, alone or in combination with one or more of the first through fourteenth aspects, the one or more conditions are common to multiple serving cells.

In a sixteenth aspect, alone or in combination with one or more of the first through fifteenth aspects, the configuration information further indicates one or more additional conditions associated with a neighboring cell.

In a seventeenth aspect, alone or in combination with one or more of the first through sixteenth aspects, skipping monitoring the PDCCH includes skipping monitoring the PDCCH during a first duration of the DRX active time of the UE that overlaps in time with the non-active time or during a second duration of the DRX active time that is after the non-active time.

In an eighteenth aspect, alone or in combination with one or more of the first through seventeenth aspects, skipping monitoring the PDCCH includes skipping monitoring the PDCCH during a first duration of the DRX active time of the UE that overlaps in time with the non-active time, and monitoring the PDCCH during a second duration of the DRX active time that is after the non-active time.

In a nineteenth aspect, alone or in combination with one or more of the first through eighteenth aspects, monitoring the PDCCH includes monitoring the PDCCH during the second duration responsive to the second duration satisfying a threshold.

In a twentieth aspect, alone or in combination with one or more of the first through nineteenth aspects, the configuration information further indicates whether the PDCCH is to be monitored during a first duration of the DRX active time of the UE that overlaps in time with the non-active time or during a second duration of the DRX active time that is after the non-active time.

In a twenty-first aspect, alone or in combination with one or more of the first through twentieth aspects, the configuration information further indicates at least one physical channel or signal that is to be dropped during the non-active time.

Although FIG. 26 shows example blocks of process 2600, in some aspects, process 2600 may include additional blocks, fewer blocks, different blocks, or differently arranged blocks than those depicted in FIG. 26. Additionally, or alternatively, two or more of the blocks of process 2600 may be performed in parallel.

FIG. 27 is a diagram illustrating an example process 2700 performed, for example, by a network node, in accordance with the present disclosure. Example process 2700 is an example where the network node (e.g., network node 110) performs operations associated with communication in a non-active time for a cell.

As shown in FIG. 27, in some aspects, process 2700 may include transmitting configuration information that indicates a non-active time for a cell, where the non-active time is for cell DTX (block 2710). For example, the network node (e.g., using communication manager 150 and/or transmission component 2304, depicted in FIG. 23) may transmit configuration information that indicates a non-active time for a cell, as described above.

As further shown in FIG. 27, in some aspects, process 2700 may include skipping transmitting a PDCCH communication for a UE during a duration of a DRX active time of the UE that overlaps in time with the non-active time (block 2720). For example, the network node (e.g., using communication manager 150, depicted in FIG. 23) may skip transmitting a PDCCH communication for a UE during a duration of a DRX active time of the UE that overlaps in time with the non-active time, as described above.

Process 2700 may include additional aspects, such as any single aspect or any combination of aspects described below and/or in connection with one or more other processes described elsewhere herein.

In a first aspect, process 2700 includes performing or skipping transmission of one or more physical uplink channels or signals, or reception of one or more physical uplink channels or signals, during the non-active time according to one or more conditions.

In a second aspect, alone or in combination with the first aspect, the non-active time is for cell DRX or cell DTX for the physical uplink channels or signals.

In a third aspect, alone or in combination with one or more of the first and second aspects, the one or more physical downlink channels or signals include a CSI-RS.

In a fourth aspect, alone or in combination with one or more of the first through third aspects, the one or more physical uplink channels or signals include an SRS or a scheduling request.

In a fifth aspect, alone or in combination with one or more of the first through fourth aspects, the one or more conditions relate to at least one of a duration of the non-active time or a periodicity of the non-active time.

In a sixth aspect, alone or in combination with one or more of the first through fifth aspects, the one or more conditions relate to a periodicity of the one or more physical downlink channels or signals or the one or more physical uplink channels or signals.

In a seventh aspect, alone or in combination with one or more of the first through sixth aspects, the one or more conditions relate to a quantity of repetitions of the one or more physical downlink channels or signals or the one or more physical uplink channels or signals.

In an eighth aspect, alone or in combination with one or more of the first through seventh aspects, the one or more conditions relate to a QoS requirement of a UE or of traffic associated with SPS, a configured grant, or a scheduling request.

In a ninth aspect, alone or in combination with one or more of the first through eighth aspects, the one or more conditions relate to a mobility state of a UE.

In a tenth aspect, alone or in combination with one or more of the first through ninth aspects, the one or more conditions relate to a signal quality at a UE.

In an eleventh aspect, alone or in combination with one or more of the first through tenth aspects, the one or more conditions are fixed.

In a twelfth aspect, alone or in combination with one or more of the first through eleventh aspects, the configuration information further indicates the one or more conditions.

In a thirteenth aspect, alone or in combination with one or more of the first through twelfth aspects, the configuration information further indicates at least one physical channel or signal to which the one or more conditions apply.

In a fourteenth aspect, alone or in combination with one or more of the first through thirteenth aspects, the one or more conditions are cell-specific.

In a fifteenth aspect, alone or in combination with one or more of the first through fourteenth aspects, the one or more conditions are common to multiple serving cells.

In a sixteenth aspect, alone or in combination with one or more of the first through fifteenth aspects, the configuration information further indicates one or more additional conditions associated with a neighboring cell.

In a seventeenth aspect, alone or in combination with one or more of the first through sixteenth aspects, skipping transmitting the PDCCH communication includes skipping transmitting the PDCCH communication for the UE during a first duration of the DRX active time of the UE that overlaps in time with the non-active time or during a second duration of the DRX active time that is after the non-active time.

In an eighteenth aspect, alone or in combination with one or more of the first through seventeenth aspects, skipping transmitting the PDCCH communication includes skipping transmitting the PDCCH communication for the UE during a first duration of the DRX active time of the UE that overlaps in time with the non-active time, and transmitting the PDCCH communication during a second duration of the DRX active time that is after the non-active time.

In a nineteenth aspect, alone or in combination with one or more of the first through eighteenth aspects, transmitting the PDCCH communication includes transmitting the PDCCH communication during the second duration responsive to the second duration satisfying a threshold.

In a twentieth aspect, alone or in combination with one or more of the first through nineteenth aspects, the configuration information further indicates whether a PDCCH is to be monitored by the UE during a first duration of the DRX active time of the UE that overlaps in time with the non-active time or during a second duration of the DRX active time that is after the non-active time.

In a twenty-first aspect, alone or in combination with one or more of the first through twentieth aspects, the configuration information further indicates at least one physical channel or signal that is to be dropped during the non-active time.

Although FIG. 27 shows example blocks of process 2700, in some aspects, process 2700 may include additional blocks, fewer blocks, different blocks, or differently arranged blocks than those depicted in FIG. 27. Additionally, or alternatively, two or more of the blocks of process 2700 may be performed in parallel.

FIG. 28 is a diagram illustrating an example process 2800 performed, for example, by a UE, in accordance with the present disclosure. Example process 2800 is an example where the UE (e.g., UE 120) performs operations associated with communication in a non-active time for a cell.

As shown in FIG. 28, in some aspects, process 2800 may include receiving configuration information that indicates a non-active time for cell DRX and that indicates a quantity of repetitions for one of a physical uplink channel or signal (block 2810). For example, the UE (e.g., using communication manager 140 and/or reception component 2002, depicted in FIG. 20) may receive configuration information that indicates a non-active time for cell DRX and that indicates a quantity of repetitions for one of a physical uplink channel or signal, as described above.

As further shown in FIG. 28, in some aspects, process 2800 may include transmitting one or more repetitions of the one of the physical uplink channel or signal in one or more transmission occasions outside of the non-active time (block 2820). For example, the UE (e.g., using communication manager 140 and/or transmission component 2004, depicted in FIG. 20) may transmit one or more repetitions of the one of the physical uplink channel or signal in one or more transmission occasions outside of the non-active time, as described above.

As further shown in FIG. 28, in some aspects, process 2800 may include dropping transmission of one or more repetitions of the one of the physical uplink channel or signal in one or more transmission occasions in the non-active time (block 2830). For example, the UE (e.g., using communication manager 140, depicted in FIG. 20) may drop transmission of one or more repetitions of the one of the physical uplink channel or signal in one or more transmission occasions in the non-active time, as described above.

Process 2800 may include additional aspects, such as any single aspect or any combination of aspects described below and/or in connection with one or more other processes described elsewhere herein.

In a first aspect, the one or more repetitions in the one or more transmission occasions in the non-active time that are dropped are counted toward the quantity of repetitions.

In a second aspect, alone or in combination with the first aspect, the one or more repetitions in the one or more transmission occasions in the non-active time that are dropped are not counted toward the quantity of repetitions.

In a third aspect, alone or in combination with one or more of the first and second aspects, the one of the physical uplink channel or signal is a PUCCH, a PUSCH scheduled by dynamic grant, a PUSCH scheduled by configured grant, or an SRS.

In a fourth aspect, alone or in combination with one or more of the first through third aspects, process 2800 includes determining transmission occasions for the physical uplink channel or signal in accordance with the non-active time.

Although FIG. 28 shows example blocks of process 2800, in some aspects, process 2800 may include additional blocks, fewer blocks, different blocks, or differently arranged blocks than those depicted in FIG. 28. Additionally, or alternatively, two or more of the blocks of process 2800 may be performed in parallel.

FIG. 29 is a diagram illustrating an example process 2900 performed, for example, by a network node, in accordance with the present disclosure. Example process 2900 is an example where the network node (e.g., network node 110) performs operations associated with communication in a non-active time for a cell.

As shown in FIG. 29, in some aspects, process 2900 may include transmitting configuration information that indicates a non-active time for cell DRX and that indicates a quantity of repetitions for one of a physical uplink channel or signal (block 2910). For example, the network node (e.g., using communication manager 150 and/or transmission component 2304, depicted in FIG. 23) may transmit configuration information that indicates a non-active time for cell DRX and that indicates a quantity of repetitions for one of a physical uplink channel or signal, as described above.

As further shown in FIG. 29, in some aspects, process 2900 may include receiving one or more repetitions of the one of the physical uplink channel or signal in one or more occasions outside of the non-active time (block 2920). For example, the network node (e.g., using communication manager 150 and/or reception component 2302, depicted in FIG. 23) may receive one or more repetitions of the one of the physical uplink channel or signal in one or more occasions outside of the non-active time, as described above.

As further shown in FIG. 29, in some aspects, process 2900 may include dropping reception of one or more repetitions of the one of the physical uplink channel or signal in one or more occasions in the non-active time (block 2930). For example, the network node (e.g., using communication manager 150, depicted in FIG. 23) may drop reception of one or more repetitions of the one of the physical uplink channel or signal in one or more occasions in the non-active time, as described above.

Process 2900 may include additional aspects, such as any single aspect or any combination of aspects described below and/or in connection with one or more other processes described elsewhere herein.

In a first aspect, the one or more repetitions in the one or more occasions in the non-active time that are dropped are counted toward the quantity of repetitions.

In a second aspect, alone or in combination with the first aspect, the one or more repetitions in the one or more occasions in the non-active time that are dropped are not counted toward the quantity of repetitions.

In a third aspect, alone or in combination with one or more of the first and second aspects, the one of the physical uplink channel or signal is a PUCCH, a PUSCH scheduled by dynamic grant, a PUSCH scheduled by configured grant, or an SRS.

In a fourth aspect, alone or in combination with one or more of the first through third aspects, process 2900 includes determining occasions for the one of the physical uplink channel or signal in accordance with the non-active time.

Although FIG. 29 shows example blocks of process 2900, in some aspects, process 2900 may include additional blocks, fewer blocks, different blocks, or differently arranged blocks than those depicted in FIG. 29. Additionally, or alternatively, two or more of the blocks of process 2900 may be performed in parallel.

FIG. 30 is a diagram illustrating an example process 3000 performed, for example, by a UE, in accordance with the present disclosure. Example process 3000 is an example where the UE (e.g., UE 120) performs operations associated with communication in a non-active time for a cell.

As shown in FIG. 30, in some aspects, process 3000 may include receiving configuration information that indicates a non-active time for cell DRX and that indicates a quantity of repetitions for one of a physical uplink channel or signal (block 3010). For example, the UE (e.g., using communication manager 140 and/or reception component 2002, depicted in FIG. 20) may receive configuration information that indicates a non-active time for cell DRX and that indicates a quantity of repetitions for one of a physical uplink channel or signal, as described above.

As further shown in FIG. 30, in some aspects, process 3000 may include dropping transmission of one or more repetitions of the one of the physical uplink channel or signal in one or more transmission occasions in the non-active time (block 3020). For example, the UE (e.g., using communication manager 140, depicted in FIG. 20) may drop transmission of one or more repetitions of the one of the physical uplink channel or signal in one or more transmission occasions in the non-active time, as described above.

Process 3000 may include additional aspects, such as any single aspect or any combination of aspects described below and/or in connection with one or more other processes described elsewhere herein.

In a first aspect, process 3000 includes transmitting one or more repetitions of the one of the physical uplink channel or signal in one or more transmission occasions outside of the non-active time.

In a second aspect, alone or in combination with the first aspect, the one or more repetitions in the one or more transmission occasions in the non-active time that are dropped are counted toward the quantity of repetitions.

In a third aspect, alone or in combination with the first aspect, the one or more repetitions in the one or more transmission occasions in the non-active time that are dropped are not counted toward the quantity of repetitions.

In a fourth aspect, alone or in combination with one or more of the first through third aspects, the one of the physical uplink channel or signal is a PUCCH, a PUSCH scheduled by dynamic grant, a PUSCH scheduled by configured grant, or an SRS.

In a fifth aspect, alone or in combination with one or more of the first through fourth aspects, process 3000 includes determining transmission occasions for the physical uplink channel or signal in accordance with the non-active time.

Although FIG. 30 shows example blocks of process 3000, in some aspects, process 3000 may include additional blocks, fewer blocks, different blocks, or differently arranged blocks than those depicted in FIG. 30. Additionally, or alternatively, two or more of the blocks of process 3000 may be performed in parallel.

FIG. 31 is a diagram illustrating an example process 3100 performed, for example, by a UE, in accordance with the present disclosure. Example process 3100 is an example where the UE (e.g., UE 120) performs operations associated with communication in a non-active time for a cell.

As shown in FIG. 31, in some aspects, process 3100 may include receiving configuration information that indicates a non-active time for cell DRX and that indicates a quantity of repetitions for one of a physical uplink channel or signal (block 3110). For example, the UE (e.g., using communication manager 140 and/or reception component 2002, depicted in FIG. 20) may receive configuration information that indicates a non-active time for cell DRX and that indicates a quantity of repetitions for one of a physical uplink channel or signal, as described above.

As further shown in FIG. 31, in some aspects, process 3100 may include transmitting one or more repetitions of the one of the physical uplink channel or signal in one or more transmission occasions outside of the non-active time (block 3120). For example, the UE (e.g., using communication manager 140 and/or transmission component 2004, depicted in FIG. 20) may transmit one or more repetitions of the one of the physical uplink channel or signal in one or more transmission occasions outside of the non-active time, as described above.

Process 3100 may include additional aspects, such as any single aspect or any combination of aspects described below and/or in connection with one or more other processes described elsewhere herein.

In a first aspect, process 3100 includes dropping transmission of one or more repetitions of the one of the physical uplink channel or signal in one or more transmission occasions in the non-active time.

In a second aspect, alone or in combination with the first aspect, the one of the physical uplink channel or signal is a PUCCH, a PUSCH scheduled by dynamic grant, a PUSCH scheduled by configured grant, or an SRS.

In a third aspect, alone or in combination with one or more of the first and second aspects, process 3100 includes determining transmission occasions for the physical uplink channel or signal in accordance with the non-active time.

Although FIG. 31 shows example blocks of process 3100, in some aspects, process 3100 may include additional blocks, fewer blocks, different blocks, or differently arranged blocks than those depicted in FIG. 31. Additionally, or alternatively, two or more of the blocks of process 3100 may be performed in parallel.

FIG. 32 is a diagram illustrating an example process 3200 performed, for example, by a network node, in accordance with the present disclosure. Example process 3200 is an example where the network node (e.g., network node 110) performs operations associated with communication in a non-active time for a cell.

As shown in FIG. 32, in some aspects, process 3200 may include transmitting configuration information that indicates a non-active time for cell DRX and that indicates a quantity of repetitions for one of a physical uplink channel or signal (block 3210). For example, the network node (e.g., using communication manager 150 and/or transmission component 2304, depicted in FIG. 23) may transmit configuration information that indicates a non-active time for cell DRX and that indicates a quantity of repetitions for one of a physical uplink channel or signal, as described above.

As further shown in FIG. 32, in some aspects, process 3200 may include dropping reception of one or more repetitions of the one of the physical uplink channel or signal in one or more occasions in the non-active time (block 3220). For example, the network node (e.g., using communication manager 150, depicted in FIG. 23) may drop reception of one or more repetitions of the one of the physical uplink channel or signal in one or more occasions in the non-active time, as described above.

Process 3200 may include additional aspects, such as any single aspect or any combination of aspects described below and/or in connection with one or more other processes described elsewhere herein.

In a first aspect, process 3200 may include receiving one or more repetitions of the one of the physical uplink channel or signal in one or more occasions outside of the non-active time.

In a second aspect, alone or in combination with the first aspect, the one or more repetitions in the one or more occasions in the non-active time that are dropped are counted toward the quantity of repetitions.

In a third aspect, alone or in combination with the first aspect, the one or more repetitions in the one or more occasions in the non-active time that are dropped are not counted toward the quantity of repetitions.

In a fourth aspect, alone or in combination with one or more of the first through third aspects, the one of the physical uplink channel or signal is a PUCCH, a PUSCH scheduled by dynamic grant, a PUSCH scheduled by configured grant, or an SRS.

In a fifth aspect, alone or in combination with one or more of the first through fourth aspects, process 3200 includes determining occasions for the one of the physical uplink channel or signal in accordance with the non-active time.

Although FIG. 32 shows example blocks of process 3200, in some aspects, process 3200 may include additional blocks, fewer blocks, different blocks, or differently arranged blocks than those depicted in FIG. 32. Additionally, or alternatively, two or more of the blocks of process 3200 may be performed in parallel.

FIG. 33 is a diagram illustrating an example process 3300 performed, for example, by a network node, in accordance with the present disclosure. Example process 3300 is an example where the network node (e.g., network node 110) performs operations associated with communication in a non-active time for a cell.

As shown in FIG. 33, in some aspects, process 3300 may include transmitting configuration information that indicates a non-active time for cell DRX and that indicates a quantity of repetitions for one of a physical uplink channel or signal (block 3310). For example, the network node (e.g., using communication manager 150 and/or transmission component 2304, depicted in FIG. 23) may transmit configuration information that indicates a non-active time for cell DRX and that indicates a quantity of repetitions for one of a physical uplink channel or signal, as described above.

As further shown in FIG. 33, in some aspects, process 3300 may include receiving one or more repetitions of the one of the physical uplink channel or signal in one or more occasions outside of the non-active time (block 3320). For example, the network node (e.g., using communication manager 150 and/or reception component 2302, depicted in FIG. 23) may receive one or more repetitions of the one of the physical uplink channel or signal in one or more occasions outside of the non-active time, as described above.

Process 3300 may include additional aspects, such as any single aspect or any combination of aspects described below and/or in connection with one or more other processes described elsewhere herein.

In a first aspect, process 3300 includes dropping reception of one or more repetitions of the one of the physical uplink channel or signal in one or more occasions in the non-active time

In a second aspect, alone or in combination with the first aspect, the one of the physical uplink channel or signal is a PUCCH, a PUSCH scheduled by dynamic grant, a PUSCH scheduled by configured grant, or an SRS.

In a third aspect, alone or in combination with one or more of the first and second aspects, process 3300 includes determining occasions for the one of the physical uplink channel or signal in accordance with the non-active time.

Although FIG. 33 shows example blocks of process 3300, in some aspects, process 3300 may include additional blocks, fewer blocks, different blocks, or differently arranged blocks than those depicted in FIG. 33. Additionally, or alternatively, two or more of the blocks of process 3300 may be performed in parallel.

The following provides an overview of some Aspects of the present disclosure:

Aspect 1: A method of wireless communication performed at an apparatus of a user equipment (UE), comprising: receiving configuration information that indicates a non-active time for cell discontinuous reception (DRX) and that indicates a quantity of repetitions for one of a physical uplink channel or signal; and dropping transmission of one or more repetitions of the one of the physical uplink channel or signal in one or more transmission occasions in the non-active time.

Aspect 2: The method of Aspect 1, further comprising: transmitting one or more repetitions of the one of the physical uplink channel or signal in one or more transmission occasions outside of the non-active time.

Aspect 3: The method of any of Aspects 1-2, wherein the one or more repetitions in the one or more transmission occasions in the non-active time that are dropped are counted toward the quantity of repetitions.

Aspect 4: The method of any of Aspects 1-2, wherein the one or more repetitions in the one or more transmission occasions in the non-active time that are dropped are not counted toward the quantity of repetitions.

Aspect 5: The method of any of Aspects 1-4, wherein the one of the physical uplink channel or signal is a physical uplink control channel, a physical uplink shared channel scheduled by dynamic grant, a physical uplink shared channel scheduled by configured grant, or a sounding reference signal.

Aspect 6: The method of any of Aspects 1-5, further comprising: determining transmission occasions for the one of the physical uplink channel or signal in accordance with the non-active time.

Aspect 7: A method of wireless communication performed at an apparatus of a network node, comprising: transmitting configuration information that indicates a non-active time for cell discontinuous reception (DRX) and that indicates a quantity of repetitions for one of a physical uplink channel or signal; and dropping reception of one or more repetitions of the one of the physical uplink channel or signal in one or more occasions in the non-active time.

Aspect 8: The method of Aspect 7, further comprising: receiving one or more repetitions of the one of the physical uplink channel or signal in one or more transmission occasions outside of the non-active time

Aspect 9: The method of any of Aspects 7-8, wherein the one or more repetitions in the one or more occasions in the non-active time that are dropped are counted toward the quantity of repetitions.

Aspect 10: The method of any of Aspects 7-8, wherein the one or more repetitions in the one or more occasions in the non-active time that are dropped are not counted toward the quantity of repetitions.

Aspect 11: The method of any of Aspects 7-10, wherein the one of the physical uplink channel or signal is a physical uplink control channel, a physical uplink shared channel scheduled by dynamic grant, a physical uplink shared channel scheduled by configured grant, or a sounding reference signal.

Aspect 12: The method of any of Aspects 7-11, further comprising: determining occasions for the one of the physical uplink channel or signal in accordance with the non-active time.

Aspect 13: A method of wireless communication performed at an apparatus of a user equipment (UE), comprising: receiving configuration information that indicates a non-active time for cell discontinuous reception (DRX) and that indicates a quantity of repetitions for one of a physical uplink channel or signal; and transmitting one or more repetitions of the one of the physical uplink channel or signal in one or more transmission occasions outside of the non-active time.

Aspect 14: The method of Aspect 13, further comprising: dropping transmission of one or more repetitions of the one of the physical uplink channel or signal in one or more transmission occasions in the non-active time.

Aspect 15: The method of any of Aspects 13-14, wherein the one of the physical uplink channel or signal is a physical uplink control channel, a physical uplink shared channel scheduled by dynamic grant, a physical uplink shared channel scheduled by configured grant, or a sounding reference signal.

Aspect 16: The method of any of Aspects 13-15, further comprising: determining transmission occasions for the one of the physical uplink channel or signal in accordance with the non-active time.

Aspect 17: A method of wireless communication performed at an apparatus of a network node, comprising: transmitting configuration information that indicates a non-active time for cell discontinuous reception (DRX) and that indicates a quantity of repetitions for one of a physical uplink channel or signal; and receiving one or more repetitions of the one of the physical uplink channel or signal in one or more occasions outside of the non-active time.

Aspect 18: The method of Aspect 17, further comprising: dropping reception of one or more repetitions of the one of the physical uplink channel or signal in one or more transmission occasions in the non-active time.

Aspect 19: The method of any of Aspects 17-18, wherein the one of the physical uplink channel or signal is a physical uplink control channel, a physical uplink shared channel scheduled by dynamic grant, a physical uplink shared channel scheduled by configured grant, or a sounding reference signal.

Aspect 20: The method of any of Aspects 17-19, further comprising: determining occasions for the one of the physical uplink channel or signal in accordance with the non-active time.

Aspect 21: A method of wireless communication performed at an apparatus of a user equipment (UE), comprising: receiving configuration information that indicates a non-active time for cell discontinuous reception (DRX) and that indicates a quantity of repetitions for one of a physical uplink channel or signal; transmitting one or more repetitions of the one of the physical uplink channel or signal in one or more transmission occasions outside of the non-active time; and dropping transmission of one or more repetitions of the one of the physical uplink channel or signal in one or more transmission occasions in the non-active time.

Aspect 22: The method of Aspect 21, wherein the one or more repetitions in the one or more transmission occasions in the non-active time that are dropped are counted toward the quantity of repetitions.

Aspect 23: The method of Aspect 21, wherein the one or more repetitions in the one or more transmission occasions in the non-active time that are dropped are not counted toward the quantity of repetitions.

Aspect 24: The method of any of Aspects 21-23, wherein the one of the physical uplink channel or signal is a physical uplink control channel, a physical uplink shared channel scheduled by dynamic grant, a physical uplink shared channel scheduled by configured grant, or a sounding reference signal.

Aspect 25: The method of any of Aspects 21-24, further comprising: determining transmission occasions for the one of the physical uplink channel or signal in accordance with the non-active time.

Aspect 26: A method of wireless communication performed at an apparatus of a network node, comprising: transmitting configuration information that indicates a non-active time for cell discontinuous reception (DRX) and that indicates a quantity of repetitions for one of a physical uplink channel or signal; receiving one or more repetitions of the one of the physical uplink channel or signal in one or more occasions outside of the non-active time; and dropping reception of one or more repetitions of the one of the physical uplink channel or signal in one or more occasions in the non-active time.

Aspect 27: The method of Aspect 26, wherein the one or more repetitions in the one or more occasions in the non-active time that are dropped are counted toward the quantity of repetitions.

Aspect 28: The method of Aspect 26, wherein the one or more repetitions in the one or more occasions in the non-active time that are dropped are not counted toward the quantity of repetitions.

Aspect 29: The method of any of Aspects 26-28, wherein the one of the physical uplink channel or signal is a physical uplink control channel, a physical uplink shared channel scheduled by dynamic grant, a physical uplink shared channel scheduled by configured grant, or a sounding reference signal.

Aspect 30: The method of any of Aspects 26-29, further comprising: determining occasions for the one of the physical uplink channel or signal in accordance with the non-active time.

Aspect 31: A method of wireless communication performed at an apparatus of a user equipment (UE), comprising: receiving configuration information that indicates a non-active time for a cell, where the non-active time is for cell discontinuous transmission; and skipping monitoring a physical downlink control channel (PDCCH) during a duration of a discontinuous reception (DRX) active time of the UE that overlaps in time with the non-active time.

Aspect 32: The method of Aspect 31, further comprising: performing or skipping transmission of one or more physical uplink channels or signals, or reception of one or more physical downlink channels or signals, during the non-active time according to one or more conditions.

Aspect 33: The method of Aspect 32, wherein the non-active time is for cell discontinuous transmission for the physical downlink channels or signals.

Aspect 34: The method of any of Aspects 32-33, wherein the non-active time is for cell discontinuous reception for the physical uplink channels or signals.

Aspect 35: The method of any of Aspects 32-34, wherein the one or more physical downlink channels or signals include a channel state information (CSI) reference signal (CSI-RS).

Aspect 36: The method of any of Aspects 32-35, wherein the one or more physical uplink channels or signals include a sounding reference signal or a scheduling request.

Aspect 37: The method of any of Aspects 32-36, wherein the one or more conditions relate to at least one of a duration of the non-active time or a periodicity of the non-active time.

Aspect 38: The method of any of Aspects 32-37, wherein the one or more conditions relate to a periodicity of the one or more physical downlink channels or signals or the one or more physical uplink channels or signals.

Aspect 39: The method of any of Aspects 32-38, wherein the one or more conditions relate to a quantity of repetitions of the one or more physical downlink channels or signals or the one or more physical uplink channels or signals.

Aspect 40: The method of any of Aspects 32-39, wherein the one or more conditions relate to a quality of service requirement of the UE or of traffic associated with semi-persistent scheduling, a configured grant, or a scheduling request.

Aspect 41: The method of any of Aspects 32-40, wherein the one or more conditions relate to a mobility state of the UE.

Aspect 42: The method of any of Aspects 32-41, wherein the one or more conditions relate to a signal quality at the UE.

Aspect 43: The method of any of Aspects 32-42, wherein the one or more conditions are fixed.

Aspect 44: The method of any of Aspects 32-43, wherein the configuration information further indicates the one or more conditions.

Aspect 45: The method of Aspect 44, wherein the configuration information further indicates at least one physical channel or signal to which the one or more conditions apply.

Aspect 46: The method of any of Aspects 44-45, wherein the one or more conditions are cell-specific.

Aspect 47: The method of any of Aspects 44-45, wherein the one or more conditions are common to multiple serving cells.

Aspect 48: The method of any of Aspects 44-47, wherein the configuration information further indicates one or more additional conditions associated with a neighboring cell.

Aspect 49: The method of any of Aspects 31-48, wherein skipping monitoring the PDCCH comprises: skipping monitoring the PDCCH during a first duration of the DRX active time of the UE that overlaps in time with the non-active time or during a second duration of the DRX active time that is after the non-active time.

Aspect 50: The method of any of Aspects 31-48, wherein skipping monitoring the PDCCH comprises: skipping monitoring the PDCCH during a first duration of the DRX active time of the UE that overlaps in time with the non-active time; and monitoring the PDCCH during a second duration of the DRX active time that is after the non-active time.

Aspect 51: The method of Aspect 50, wherein monitoring the PDCCH comprises: monitoring the PDCCH during the second duration that satisfies a threshold.

Aspect 52: The method of any of Aspects 31-51, wherein the configuration information further indicates whether the PDCCH is to be monitored during a first duration of the DRX active time of the UE that overlaps in time with the non-active time or during a second duration of the DRX active time that is after the non-active time.

Aspect 53: The method of any of Aspects 31-52, wherein the configuration information further indicates at least one physical channel or signal that is to be dropped during the non-active time.

Aspect 54: A method of wireless communication performed at an apparatus of a network node, comprising: transmitting configuration information that indicates a non-active time for a cell, where the non-active time is for cell discontinuous transmission; and skipping transmitting a physical downlink control channel (PDCCH) communication for a user equipment (UE) during a duration of a discontinuous reception (DRX) active time of the UE that overlaps in time with the non-active time.

Aspect 55: The method of Aspect 54, further comprising: performing or skipping transmission of one or more physical downlink channels or signals, or reception of one or more physical uplink channels or signals, during the non-active time according to one or more conditions.

Aspect 56: The method of Aspect 55, wherein the non-active time is for cell discontinuous transmission for the physical downlink channels or signals.

Aspect 57: The method of any of Aspects 55-56, wherein the non-active time is for cell discontinuous reception for the physical uplink channels or signals.

Aspect 58: The method of any of Aspects 55-57, wherein the one or more physical downlink channels or signals include a channel state information (CSI) reference signal (CSI-RS).

Aspect 59: The method of any of Aspects 55-58, wherein the one or more physical uplink channels or signals include a sounding reference signal or a scheduling request.

Aspect 60: The method of any of Aspects 55-59, wherein the one or more conditions relate to at least one of a duration of the non-active time or a periodicity of the non-active time.

Aspect 61: The method of any of Aspects 55-60, wherein the one or more conditions relate to a periodicity of the one or more physical downlink channels or signals or the one or more physical uplink channels or signals.

Aspect 62: The method of any of Aspects 55-61, wherein the one or more conditions relate to a quantity of repetitions of the one or more physical downlink channels or signals or the one or more physical uplink channels or signals.

Aspect 63: The method of any of Aspects 55-62, wherein the one or more conditions relate to a quality of service requirement of a user equipment or of traffic associated with semi-persistent scheduling, a configured grant, or a scheduling request.

Aspect 64: The method of any of Aspects 55-63, wherein the one or more conditions relate to a mobility state of a user equipment.

Aspect 65: The method of any of Aspects 55-64, wherein the one or more conditions relate to a signal quality at a user equipment.

Aspect 66: The method of any of Aspects 55-65, wherein the one or more conditions are fixed.

Aspect 67: The method of any of Aspects 55-65, wherein the configuration information further indicates the one or more conditions.

Aspect 68: The method of Aspect 67, wherein the configuration information further indicates at least one physical channel or signal to which the one or more conditions apply.

Aspect 69: The method of any of Aspects 67-68, wherein the one or more conditions are cell-specific.

Aspect 70: The method of any of Aspects 67-68, wherein the one or more conditions are common to multiple serving cells.

Aspect 71: The method of any of Aspects 67-70, wherein the configuration information further indicates one or more additional conditions associated with a neighboring cell.

Aspect 72: The method of any of Aspects 54-71, wherein skipping transmitting the PDCCH communication comprises: skipping transmitting the PDCCH communication for the UE during a first duration of the DRX active time of the UE that overlaps in time with the non-active time or during a second duration of the DRX active time that is after the non-active time.

Aspect 73: The method of any of Aspects 54-71, wherein skipping transmitting the PDCCH communication comprises skipping transmitting the PDCCH communication for the UE during a first duration of the DRX active time of the UE that overlaps in time with the non-active time; and transmitting the PDCCH communication during a second duration of the DRX active time that is after the non-active time.

Aspect 74: The method of Aspect 73, wherein transmitting the PDCCH communication comprises: transmitting the PDCCH communication during the second duration that satisfies a threshold.

Aspect 75: The method of any of Aspects 54-74, wherein the configuration information further indicates whether a PDCCH is to be monitored by the UE during a first duration of the DRX active time of the UE that overlaps in time with the non-active time or during a second duration of the DRX active time that is after the non-active time.

Aspect 76: The method of any of Aspects 54-75, wherein the configuration information further indicates at least one physical channel or signal that is to be dropped during the non-active time.

Aspect 77: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-76.

Aspect 78: An apparatus for wireless communication at a device, the apparatus comprising one or more memories and one or more processors coupled to the one or more memories, the one or more processors configured to cause the device to perform the method of one or more of Aspects 1-76.

Aspect 79: An apparatus for wireless communication, the apparatus comprising at least one means for performing the method of one or more of Aspects 1-76.

Aspect 80: A non-transitory computer-readable medium storing code for wireless communication, the code comprising instructions executable by one or more processors to perform the method of one or more of Aspects 1-76.

Aspect 81: A non-transitory computer-readable medium storing a set of instructions for wireless communication, the set of instructions comprising one or more instructions that, when executed by one or more processors of a device, cause the device to perform the method of one or more of Aspects 1-76.

Aspect 82: A device for wireless communication, the device comprising a processing system that includes one or more processors and one or more memories coupled with the one or more processors, the processing system configured to cause the device to perform the method of one or more of Aspects 1-76.

Aspect 83: An apparatus for wireless communication at a device, the apparatus comprising one or more memories and one or more processors coupled to the one or more memories, the one or more processors individually or collectively configured to cause the device to perform the method of one or more of Aspects 1-76.

Aspect 84: A method of wireless communication performed by a user equipment (UE), comprising: receiving configuration information indicating a non-active time for a cell; and performing or skipping transmission of one or more physical uplink channels or signals, or reception of one or more physical downlink channels or signals, during the non-active time according to one or more conditions.

Aspect 85: The method of Aspect 84, wherein the non-active time is for cell discontinuous transmission for the physical downlink channels or signals.

Aspect 86: The method of any of Aspects 84-85, wherein the non-active time is for cell discontinuous reception for the physical uplink channels or signals.

Aspect 87: The method of any of Aspects 84-86, wherein the one or more physical downlink channels or signals include a channel state information (CSI) reference signal (CSI-RS).

Aspect 88: The method of any of Aspects 84-87, wherein the one or more physical uplink channels or signals include a sounding reference signal or a scheduling request.

Aspect 89: The method of any of Aspects 84-88, wherein the one or more conditions relate to at least one of a duration of the non-active time or a periodicity of the non-active time.

Aspect 90: The method of any of Aspects 84-89, wherein the one or more conditions relate to a periodicity of the one or more physical downlink channels or signals or the one or more physical uplink channels or signals.

Aspect 91: The method of any of Aspects 84-90, wherein the one or more conditions relate to a quantity of repetitions of the one or more physical downlink channels or signals or the one or more physical uplink channels or signals.

Aspect 92: The method of any of Aspects 84-91, wherein the one or more conditions relate to a quality of service requirement of the UE or of traffic associated with semi-persistent scheduling, a configured grant, or a scheduling request.

Aspect 93: The method of any of Aspects 84-92, wherein the one or more conditions relate to a mobility state of the UE.

Aspect 94: The method of any of Aspects 84-93, wherein the one or more conditions relate to a signal quality at the UE.

Aspect 95: The method of any of Aspects 84-94, wherein the one or more conditions are fixed.

Aspect 96: The method of any of Aspects 84-94, wherein the configuration information further indicates the one or more conditions.

Aspect 97: The method of Aspect 96, wherein the configuration information further indicates at least one physical channel or signal to which the one or more conditions apply.

Aspect 98: The method of any of Aspects 96-97, wherein the one or more conditions are cell-specific.

Aspect 99: The method of any of Aspects 96-97, wherein the one or more conditions are common to multiple serving cells.

Aspect 100: The method of any of Aspects 96-99, wherein the configuration information further indicates one or more additional conditions associated with a neighboring cell.

Aspect 101: The method of any of Aspects 84-100, further comprising:
skipping monitoring a physical downlink control channel (PDCCH) during a first duration of a discontinuous reception (DRX) active time of the UE that overlaps in time with the non-active time or during a second duration of the DRX active time that is after the non-active time.

Aspect 102: The method of any of Aspects 84-100, further comprising: skipping monitoring a physical downlink control channel (PDCCH) during a first duration of a discontinuous reception (DRX) active time of the UE that overlaps in time with the non-active time, and monitoring the PDCCH during a second duration of the DRX active time that is after the non-active time.

Aspect 103: The method of Aspect 102, wherein monitoring the PDCCH comprises: monitoring the PDCCH during the second duration responsive to the second duration satisfying a threshold.

Aspect 104: The method of any of Aspects 84-103, wherein the configuration information further indicates whether a physical downlink control channel is to be monitored during a first duration of a discontinuous reception (DRX) active time of the UE that overlaps in time with the non-active time or during a second duration of the DRX active time that is after the non-active time.

Aspect 105: The method of any of Aspects 84-104, wherein the configuration information further indicates at least one physical channel or signal that is to be dropped during the non-active time.

Aspect 106: A method of wireless communication performed by a user equipment (UE), comprising: receiving configuration information indicating a non-active time for cell discontinuous reception (DRX) and indicating a quantity of repetitions for a physical uplink channel or signal; and transmitting one or more repetitions of the physical uplink channel or signal in one or more transmission occasions outside of the non-active time, and skipping one or more repetitions of the physical uplink channel or signal in one or more transmission occasions in the non-active time.

Aspect 107: The method of Aspect 106, wherein the one or more repetitions in the one or more transmission occasions in the non-active time that are skipped are to be counted toward the quantity of repetitions.

Aspect 108: The method of Aspect 106, wherein the one or more repetitions in the one or more transmission occasions in the non-active time that are skipped are to be not counted toward the quantity of repetitions.

Aspect 109: The method of any of Aspects 106-108, wherein the physical uplink channel or signal is a physical uplink control channel, a physical uplink shared channel scheduled by dynamic grant, a physical uplink shared channel scheduled by configured grant, or a sounding reference signal.

Aspect 110: The method of any of Aspects 106-109, further comprising: determining transmission occasions for the physical uplink channel or signal in accordance with the non-active time.

Aspect 111: A method of wireless communication performed by a network node, comprising: transmitting configuration information indicating a non-active time for a cell; and performing or skipping transmission of one or more physical downlink channels or signals, or reception of one or more physical uplink channels or signals, during the non-active time according to one or more conditions.

Aspect 112: The method of Aspect 111, wherein the non-active time is for cell discontinuous transmission for the physical downlink channels or signals.

Aspect 113: The method of any of Aspects 111-112, wherein the non-active time is for cell discontinuous reception for the physical uplink channels or signals.

Aspect 114: The method of any of Aspects 111-113, wherein the one or more physical downlink channels or signals include a channel state information (CSI) reference signal (CSI-RS).

Aspect 115: The method of any of Aspects 111-114, wherein the one or more physical uplink channels or signals include a sounding reference signal or a scheduling request.

Aspect 116: The method of any of Aspects 111-115, wherein the one or more conditions relate to at least one of a duration of the non-active time or a periodicity of the non-active time.

Aspect 117: The method of any of Aspects 111-116, wherein the one or more conditions relate to a periodicity of the one or more physical downlink channels or signals or the one or more physical uplink channels or signals.

Aspect 118: The method of any of Aspects 111-117, wherein the one or more conditions relate to a quantity of repetitions of the one or more physical downlink channels or signals or the one or more physical uplink channels or signals.

Aspect 119: The method of any of Aspects 111-118, wherein the one or more conditions relate to a quality of service requirement of a user equipment or of traffic associated with semi-persistent scheduling, a configured grant, or a scheduling request.

Aspect 120: The method of any of Aspects 111-119, wherein the one or more conditions relate to a mobility state of a user equipment.

Aspect 121: The method of any of Aspects 111-120, wherein the one or more conditions relate to a signal quality at a user equipment.

Aspect 122: The method of any of Aspects 111-121, wherein the one or more conditions are fixed.

Aspect 123: The method of any of Aspects 111-121, wherein the configuration information further indicates the one or more conditions.

Aspect 124: The method of Aspect 123, wherein the configuration information further indicates at least one physical channel or signal to which the one or more conditions apply.

Aspect 125: The method of any of Aspects 123-124, wherein the one or more conditions are cell-specific.

Aspect 126: The method of any of Aspects 123-124, wherein the one or more conditions are common to multiple serving cells.

Aspect 127: The method of any of Aspects 123-126, wherein the configuration information further indicates one or more additional conditions associated with a neighboring cell.

Aspect 128: The method of any of Aspects 111-127, further comprising: skipping transmitting a physical downlink control channel (PDCCH) communication for a user equipment (UE) during a first duration of a discontinuous reception (DRX) active time of the UE that overlaps in time with the non-active time or during a second duration of the DRX active time that is after the non-active time.

Aspect 129: The method of any of Aspects 111-127, further comprising: skipping transmitting a physical downlink control channel (PDCCH) communication for a user equipment (UE) during a first duration of a discontinuous reception (DRX) active time of the UE that overlaps in time with the non-active time, and transmitting the PDCCH communication during a second duration of the DRX active time that is after the non-active time.

Aspect 130: The method of Aspect 129, wherein transmitting the PDCCH communication comprises: transmitting the PDCCH communication during the second duration responsive to the second duration satisfying a threshold.

Aspect 131: The method of any of Aspects 111-130, wherein the configuration information further indicates whether a physical downlink control channel is to be monitored by a user equipment (UE) during a first duration of a discontinuous reception (DRX) active time of the UE that overlaps in time with the non-active time or during a second duration of the DRX active time that is after the non-active time.

Aspect 132: The method of any of Aspects 111-131, wherein the configuration information further indicates at least one physical channel or signal that is to be dropped during the non-active time.

Aspect 133: A method of wireless communication performed by a network node, comprising: transmitting configuration information indicating a non-active time for cell discontinuous reception (DRX) and indicating a quantity of repetitions for a physical uplink channel or signal; and receiving one or more repetitions of the physical uplink channel or signal in one or more occasions outside of the non-active time, and skipping one or more repetitions of the physical uplink channel or signal in one or more occasions in the non-active time.

Aspect 134: The method of Aspect 133, wherein the one or more repetitions in the one or more occasions in the non-active time that are skipped are to be counted toward the quantity of repetitions.

Aspect 135: The method of Aspect 133, wherein the one or more repetitions in the one or more occasions in the non-active time that are skipped are to be not counted toward the quantity of repetitions.

Aspect 136: The method of any of Aspects 133-135, wherein the physical uplink channel or signal is a physical uplink control channel, a physical uplink shared channel scheduled by dynamic grant, a physical uplink shared channel scheduled by configured grant, or a sounding reference signal.

Aspect 137: The method of any of Aspects 133-136, further comprising: determining occasions for the physical uplink channel or signal in accordance with the non-active time.

Aspect 138: An apparatus for wireless communication at a device, comprising a processor; memory coupled with the processor; and instructions stored in the memory and executable by the processor to cause the apparatus to perform the method of one or more of Aspects 84-137.

Aspect 139: A device for wireless communication, comprising a memory and one or more processors coupled to the memory, the one or more processors configured to perform the method of one or more of Aspects 84-137.

Aspect 140: An apparatus for wireless communication, comprising at least one means for performing the method of one or more of Aspects 84-137.

Aspect 141: A non-transitory computer-readable medium storing code for wireless communication, the code comprising instructions executable by a processor to perform the method of one or more of Aspects 84-137.

Aspect 142: A non-transitory computer-readable medium storing a set of instructions for wireless communication, the set of instructions comprising one or more instructions that, when executed by one or more processors of a device, cause the device to perform the method of one or more of Aspects 84-137.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

When “a processor” or “one or more processors” is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor individually performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

What is claimed is:

1. An apparatus for wireless communication at a user equipment (UE), comprising:
one or more memories; and
one or more processors, coupled to the one or more memories, configured to cause the UE to:
receive configuration information that indicates a non-active time for cell discontinuous reception (DRX) and that indicates a quantity of repetitions for one of a physical uplink channel or signal; and
drop transmission of one or more repetitions of the one of the physical uplink channel or signal in one or more transmission occasions in the non-active time.

2. The apparatus of claim 1, wherein the one or more processors are further configured to cause the UE to:
transmit one or more repetitions of the one of the physical uplink channel or signal in one or more transmission occasions outside of the non-active time.

3. The apparatus of claim 1, wherein the one or more repetitions in the one or more transmission occasions in the non-active time that are dropped are counted toward the quantity of repetitions.

4. The apparatus of claim 1, wherein the one or more repetitions in the one or more transmission occasions in the non-active time that are dropped are not counted toward the quantity of repetitions.

5. The apparatus of claim 1, wherein the one of the physical uplink channel or signal is a physical uplink control channel, a physical uplink shared channel scheduled by dynamic grant, a physical uplink shared channel scheduled by configured grant, or a sounding reference signal.

6. The apparatus of claim 1, wherein the one or more processors are further configured to cause the UE to:
determine transmission occasions for the one of the physical uplink channel or signal in accordance with the non-active time.

7. An apparatus for wireless communication at a network node, comprising:
one or more memories; and
one or more processors, coupled to the one or more memories, configured to cause the network node to:
transmit configuration information that indicates a non-active time for cell discontinuous reception (DRX) and that indicates a quantity of repetitions for one of a physical uplink channel or signal; and
drop reception of one or more repetitions of the one of the physical uplink channel or signal in one or more occasions in the non-active time.

8. The apparatus of claim 7, wherein the one or more processors are further configured to cause the network node to:
receive one or more repetitions of the one of the physical uplink channel or signal in one or more occasions outside of the non-active time.

9. The apparatus of claim 7, wherein the one or more repetitions in the one or more occasions in the non-active time that are dropped are counted toward the quantity of repetitions.

10. The apparatus of claim 7, wherein the one or more repetitions in the one or more occasions in the non-active time that are dropped are not counted toward the quantity of repetitions.

11. The apparatus of claim 7, wherein the one of the physical uplink channel or signal is a physical uplink control channel, a physical uplink shared channel scheduled by dynamic grant, a physical uplink shared channel scheduled by configured grant, or a sounding reference signal.

12. The apparatus of claim 7, wherein the one or more processors are further configured to cause the network node to:
determine occasions for the one of the physical uplink channel or signal in accordance with the non-active time.

13. An apparatus for wireless communication at a user equipment (UE), comprising:
one or more memories; and
one or more processors, coupled to the one or more memories, configured to cause the UE to:
receive configuration information that indicates a non-active time for cell discontinuous reception (DRX) and that indicates a quantity of repetitions for one of a physical uplink channel or signal; and
transmit one or more repetitions of the one of the physical uplink channel or signal in one or more transmission occasions outside of the non-active time.

14. The apparatus of claim 13, wherein the one or more processors are further configured to cause the UE to:
drop transmission of one or more repetitions of the one of the physical uplink channel or signal in one or more transmission occasions in the non-active time.

15. The apparatus of claim 13, wherein the one of the physical uplink channel or signal is a physical uplink control channel, a physical uplink shared channel scheduled by dynamic grant, a physical uplink shared channel scheduled by configured grant, or a sounding reference signal.

16. The apparatus of claim 13, wherein the one or more processors are further configured to cause the UE to:
determine transmission occasions for the one of the physical uplink channel or signal in accordance with the non-active time.

17. An apparatus for wireless communication at a network node, comprising:
one or more memories; and
one or more processors, coupled to the one or more memories, configured to cause the network node to:
transmit configuration information that indicates a non-active time for cell discontinuous reception (DRX) and that indicates a quantity of repetitions for one of a physical uplink channel or signal; and
receive one or more repetitions of the one of the physical uplink channel or signal in one or more occasions outside of the non-active time.

18. The apparatus of claim 17, wherein the one or more processors are further configured to cause the network node to:
drop reception of one or more repetitions of the one of the physical uplink channel or signal in one or more occasions in the non-active time.

19. The apparatus of claim 17, wherein the one of the physical uplink channel or signal is a physical uplink control channel, a physical uplink shared channel scheduled by dynamic grant, a physical uplink shared channel scheduled by configured grant, or a sounding reference signal.

20. The apparatus of claim 17, wherein the one or more processors are further configured to cause the network node to:
determine occasions for the one of the physical uplink channel or signal in accordance with the non-active time.

21. An apparatus for wireless communication at a user equipment (UE), comprising:
one or more memories; and
one or more processors, coupled to the one or more memories, configured to cause the UE to:
receive configuration information that indicates a non-active time for a cell, where the non-active time is for cell discontinuous transmission; and
skip monitoring a physical downlink control channel (PDCCH) during a duration of a discontinuous reception (DRX) active time of the UE that overlaps in time with the non-active time.

22. The apparatus of claim 21, wherein the one or more processors are further configured to cause the UE to:
perform or skip transmission of one or more physical uplink channels or signals, or reception of one or more physical downlink channels or signals, during the non-active time according to one or more conditions.

23. The apparatus of claim 22, wherein the one or more conditions relate to at least one of a duration of the non-active time or a periodicity of the non-active time.

24. The apparatus of claim 22, wherein the one or more conditions relate to a periodicity of the one or more physical downlink channels or signals or the one or more physical uplink channels or signals.

25. The apparatus of claim 22, wherein the one or more conditions relate to a quantity of repetitions of the one or more physical downlink channels or signals or the one or more physical uplink channels or signals.

26. The apparatus of claim 21, wherein the one or more processors, to cause the UE to skip monitoring the PDCCH, are configured to cause the UE to:
skip monitoring the PDCCH during a first duration of the DRX active time of the UE that overlaps in time with the non-active time or during a second duration of the DRX active time that is after the non-active time.

27. The apparatus of claim 21, wherein the one or more processors, to cause the UE to skip monitoring the PDCCH, are configured to cause the UE to:
skip monitoring the PDCCH during a first duration of the DRX active time of the UE that overlaps in time with the non-active time; and
monitor the PDCCH during a second duration of the DRX active time that is after the non-active time.

28. The apparatus of claim 27, wherein the one or more processors, to cause the UE to monitor the PDCCH, are configured to cause the UE to:
monitor the PDCCH during the second duration that satisfies a threshold.

29. The apparatus of claim 21, wherein the configuration information further indicates whether the PDCCH is to be monitored during a first duration of the DRX active time of the UE that overlaps in time with the non-active time or during a second duration of the DRX active time that is after the non-active time.

30. The apparatus of claim 21, wherein the configuration information further indicates at least one physical channel or signal that is to be dropped during the non-active time.
